(19) United States
(12) Patent Application Publication
(10) Pub. No.: US 2003/0191629 A1
(43) Pub. Date: Oct. 9, 2003

(54) Interface apparatus and task control method for assisting in the operation of a device using recognition technology

(76) Inventor: Shinichi Yoshizawa, Osaka (JP)

Correspondence Address: HARNESS, DICKEY & PIERCE, P.L.C., P.O. BOX 828, BLOOMFIELD HILLS, MI, 48303, US

(21) Appl. No.: 10/357,000

(22) Filed: Feb. 3, 2003

(30) Foreign Application Priority Data
Feb. 4, 2002 (JP) 2002-026282

(51) Int. Cl. G06F 17/21

(52) U.S. Cl. 704/10

(57) ABSTRACT

A recognition portion obtains a recognition result based on a degree of similarity between a recognition object and lexicon entries included in a recognition lexicon. A task control portion instructs execution of a first task associated with the recognition result. A presentation control portion instructs presentation of one or a plurality of candidates associated with the recognition result and instructs a stop of the presentation of the candidate(s) when a time for which the candidate(s) has/have been presented has reached a predetermined time.

### BACKGROUND OF THE INVENTION

The invention relates to the operation of household appliances and information terminal devices, such as television sets, car navigation systems and mobile phones.

One method by which a user can operate household appliances and information terminal devices, such as television sets, car navigation systems and mobile phones, is speech recognition. With this method, a predetermined task is executed by giving an instruction for this predetermined task by speech.

In order to execute a task by speech, speech recognition is necessary. However, due to noise, variations between the voices of different speakers, and utterances of words or phrases that are not registered in the recognition lexicon, a 100% error-free speech recognition is still not possible.

Problems with regard to recognition precision apply in the context of all recognition or authentication technologies, such as character recognition, image recognition, fingerprint authentication and iris authentication. Therefore, methods dealing with erroneous recognition results have been proposed, for example in JP H4-16043A, JP H2-278297A, JP 2000-250587, JP H4-1065697 and JP H2-117252.

As devices become more sophisticated and multifunctional, there is also a need for intuitive interfaces using recognition functions that are highly compatible with humans, such as speech.

### SUMMARY OF THE INVENTION

It is an object of the present invention to provide an interface apparatus with which the convenience of operating a device by recognition technology can be improved.

In accordance with one aspect of the present invention, an interface apparatus includes a recognition portion, a task control portion and a presentation control portion. The recognition portion obtains a recognition result based on a degree of similarity between a recognition object and lexicon entries included in a recognition lexicon. The task control portion instructs execution of a first task associated with the recognition result obtained by the recognition portion. The presentation control portion instructs presentation of one or a plurality of candidates associated with the recognition result obtained by the recognition portion, and instructs a stop of the presentation of the candidate(s) when a time for which the candidate(s) has/have been presented has reached a predetermined time.

It is preferable that the presentation control portion displays the candidate(s) on a display, and stops the display of the candidate(s) on the display when a time for which the candidate(s) has/have been displayed on the display has reached the predetermined time.

With this interface apparatus, the display of candidates is stopped if the user has not expressed the intention to select a task candidate after the predetermined time has passed, so that if the executed task is the task that was intended by the user, the user does not need to stop the display of the presented task candidates.

When candidates are displayed on the screen, the usable region of the display screen (that is, the region of the display screen that is not used to display candidates) tends to become small as the number of presented candidates increases. For example, when presenting candidates on the display of a television or a computer monitor, then it occurs that a portion of the program that is currently being broadcast cannot be seen anymore. Moreover, as the screen size becomes smaller, the proportion that is occupied by the region for displaying the candidates tends to become large. For example, when a plurality of candidates are shown on a compact display, such as the display of a mobile phone, then the original screen may become completely hidden. With the above interface apparatus, however, the candidates are automatically deleted from the screen after a predetermined time has passed, so that the display screen can be utilized effectively.

It is preferable that when selection information is given that indicates one of the candidates that are presented, then the task control portion instructs execution of a second task that is associated with the candidate indicated by that selection information. In this case, the execution state of the first task remains unchanged.

With the above interface apparatus, a first task and a second task can be executed simultaneously. For example, it is possible to first select the program of a first screen and then select the program of a second from the candidates and display them simultaneously on a split screen display.

In accordance with another aspect of the present invention, an interface apparatus includes a recognition portion, a task control portion, a candidate creation portion, and a presentation control portion. The recognition portion obtains a recognition result based on a degree of similarity between a recognition object and lexicon entries included in a recognition lexicon. The task control portion instructs execution of a first task associated with the recognition result obtained by the recognition portion. The candidate creation portion obtains one or a plurality of candidates based on semantic closeness to the recognition result obtained by the recognition portion. The presentation control portion instructs presentation of the candidate(s) obtained by the candidate creation portion.

Conventionally, candidates were created by selecting them from recognition candidates, so that only tasks that are close in the recognition sense (for example acoustically close, such as “sigh,” “site” or “sign” when “sight” has been input by speech) can be executed. However, with the above interface apparatus, the candidates are obtained based on their semantic closeness to the recognition result, so that when searching an electronic television program guide and entering “soccer,” it is possible to select tasks relating to “baseball” or “basketball” or the like, which are in the same genre “sports” as “soccer.”

It should be noted that “semantically close” includes the following possibilities (1) to (4) among others:

(1) same genre

for example “tennis,” “baseball” and “golf” for the recognition result “soccer”

(2) associated keywords

for example “Nakata” and “World Cup” for the recognition result “soccer”

for example “color,” “black” and “apple” for the recognition result “red”

(3) keywords taking into account the user's preferences

for example “soccer,” “sports digest” and “today's news” for the recognition result “my favorite programs”

for example “e-mail” and “prepare bath” for the recognition result “things to do now”

(4) keywords related to the device operation

for example “stop,” “skip” and “rewind” for the recognition result “play” in the operation of a video player

In accordance with yet another aspect of the present invention, an interface apparatus includes a first recognition lexicon, a recognition portion, and a presentation control portion. The first recognition lexicon includes one or a plurality of lexicon entries. The recognition portion obtains a recognition result based on a degree of similarity between a recognition object and the lexicon entry or entries included in the first recognition lexicon. The presentation control portion instructs presentation of one or a plurality of candidates associated with the recognition result, and instructs presentation whether a lexicon entry or entries corresponding to the candidate(s) is/are included in the first recognition lexicon.

With this interface apparatus, the words that are registered in the first recognition lexicon can be automatically presented to the user. Furthermore, the user can see the entries that can be recognized, which improves the recognition ratio. Consequently, usage becomes more convenient for the user.

In accordance with yet another aspect of the invention, a task control method includes steps (a) to (c). In step (a), a recognition result is obtained based on a degree of similarity between a recognition object and lexicon entries included in a recognition lexicon. In step (b), a first task associated with the recognition result is executed. In step (c), one or a plurality of candidates associated with the recognition result are presented, and presentation of the candidate(s) is stopped when a time for which the candidate(s) has/have been presented has reached a predetermined time.

It is preferable that the task control method further includes a step (e) of presenting the time that is left until execution of the first task is started.

It is preferable that the recognition object includes speech and/or voice data.

It is preferable that the recognition object includes information for authenticating individuals.

In accordance with yet another aspect of the invention, a task control method includes steps (a) to (d). In step (a), a recognition result is obtained based on a degree of similarity between a recognition object and lexicon entries included in a recognition lexicon. In step (b), a first task associated with the recognition result is executed. In step (c), one or a plurality of candidates based on semantic closeness to the recognition result is/are obtained. In step (d), the candidate(s) obtained in step (c) is/are presented.

It is preferable that the one or plurality of candidates belong to a genre that corresponds to the recognition result.

It is preferable that the one or plurality of candidates each includes a keyword that is associated with the recognition result.

It is preferable that the one or plurality of candidates each include a keyword that takes into account personal preferences and/or behavioral patterns of a user.

It is preferable that the one or plurality of candidates indicate a task that is related to the first task.

In accordance with yet another aspect of the present invention, a screen display method includes steps (a) and (b). In step (a), one or a plurality of candidates obtained from a recognition result is/are displayed on a screen. In step (b), the candidate(s) is/are deleted from the screen when a time for which the candidate(s) has/have been displayed on the screen has reached a predetermined time.

It is preferable that the first task is to display information related to the recognition result.

It is preferable that the first task is to operate a device associated with the recognition result.

It is preferable that the first task is to retrieve information related to the recognition result and to present the retrieved results.

It is preferable that the second task is to display information related to the candidate indicated by the selection information.

It is preferable that the second task is to operate a device associated with the candidate indicated by the selection information.

It is preferable that the second task is to retrieve information related to the candidate indicated by the selection information and to present the retrieved results.

It is preferable that the third task is to enter a recognition object.

It is preferable that the third task is to display a predetermined screen.

It is preferable that the third task is to present an execution result of the first task by voice.

### BRIEF DESCRIPTION OF THE DRAWINGS

FIG. 1 is a block diagram showing the overall configuration of a digital television system in accordance with a first embodiment.

FIG. 2 is a flowchart illustrating the operation flow of the system shown in FIG. 1.

FIGS. 3 to 4B show screens that are shown on a display.

FIGS. 5 and 6 show other examples of screens that are displayed on a display.

FIG. 7A is a block diagram showing the overall configuration of a digital television system in accordance with a second embodiment.

FIG. 7B illustrates the content of the database stored in the candidate DB.

FIG. 7C illustrates recognition lexicon entries as well as glossary entries stored in the candidate DB.

FIG. 8 is a flowchart illustrating the operation flow of the system shown in FIG. 7.

FIGS. 9A to 9E show screens that are shown on the display.

FIG. 10 is a block diagram showing the overall configuration of a digital television system in accordance with a third embodiment.

FIG. 11 is a flowchart illustrating the operation flow of the system shown in FIG. 10.

FIGS. 12A and 12B show screens that are shown on the display.

FIG. 13 is a block diagram showing the overall configuration of a video system in accordance with a fourth embodiment.

FIG. 14 is a flowchart illustrating the operation flow of the system shown in FIG. 13.

FIGS. 15A and 15B show screens that are shown on the display.

FIG. 15C shows the content of a database.

FIG. 16 is a block diagram showing the overall configuration of a car navigation system in accordance with a fifth embodiment.

FIG. 17 is a flowchart illustrating the operation flow of the system shown in FIG. 16.

FIG. 18 shows screens that are shown on the display.

FIG. 19 is a block diagram showing the overall configuration of a mobile phone in accordance with a sixth embodiment.

FIG. 20 is a flowchart illustrating the operation flow of the mobile phone shown in FIG. 19.

FIGS. 21A and 21B show screens that are shown on the display.

FIG. 22 is a block diagram showing the overall configuration of a translation apparatus in accordance with a seventh embodiment.

FIG. 23 is a flowchart illustrating the operation flow of the translation apparatus shown in FIG. 22.

FIG. 24 shows screens that are shown on the display.

FIG. 25 is a block diagram showing the overall configuration of a monitoring system in accordance with an eighth embodiment.

FIG. 26 is a flowchart illustrating the operation flow of the monitoring system shown in FIG. 25.

FIGS. 27A to 27D show screens that are shown on the display.

FIG. 27E shows the content of a database.

FIG. 28 is a block diagram showing the overall configuration of a control system in accordance with a ninth embodiment.

FIG. 29 is a flowchart illustrating the operation flow of the system shown in FIG. 28.

FIGS. 30A and 30B show screens that are shown on the display.

FIG. 30C shows the content of a database.

FIGS. 30D and 30E show screens that are shown on the display.

### DETAILED DESCRIPTION OF THE INVENTION

The following is a detailed explanation of embodiments of the present invention with reference to the accompanying drawings. It should be noted that identical or corresponding elements in the drawings have been assigned the same numerals and their explanation is not repeated.

First Embodiment

Configuration of Digital Television System

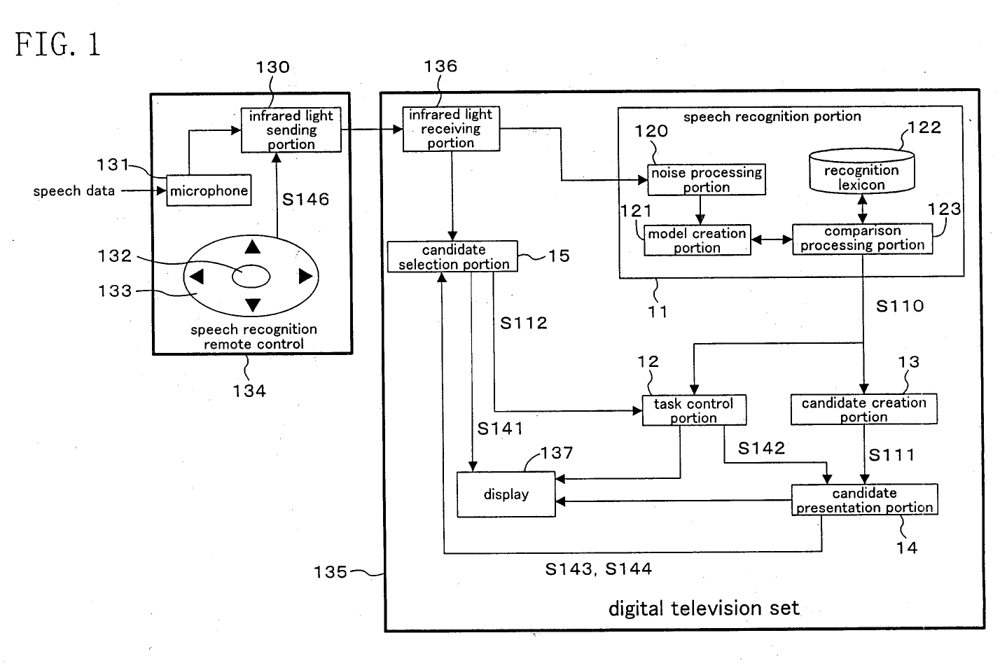

FIG. 1 shows the overall configuration of a digital television system in accordance with a first embodiment of the present invention. This system is provided with a digital television set 135 and a speech recognition remote control 134.

The digital television set 135 includes a speech recognition portion 11, a task control portion 12, a candidate creation portion 13, a candidate presentation portion 14, a candidate selection portion 15, an infrared light receiving portion 136, and a display 137. The speech recognition portion 11 includes a noise processing portion 120, a model creation portion 121, a recognition lexicon 122, and a comparison processing portion 123.

The speech recognition remote control 134 includes an infrared light sending portion 130, a microphone 131, an enter key 132, and a cursor key 133. The microphone 131 receives speech data from a user and sends them to the infrared light sending portion 130. The infrared light sending portion 130 sends the speech data from the microphone 131 to the infrared light receiving portion 136.

The infrared light receiving portion 136 sends the speech data from the infrared light sending portion 130 to the noise processing portion 120.

The noise processing portion 120 subjects the speech data from the infrared light receiving portion 136 to a noise reduction process and sends the resulting data to the model creation portion 121.

The model creation portion 121 converts the data from the noise processing portion 120 into characteristic quantities, such as the cepstrum coefficients, and stores these characteristic quantities as a model.

The comparison processing portion 123 compares the lexicon entries (acoustic model) included in the recognition lexicon (word lexicon) 122 with the model stored by the model creation portion 121, and creates a recognition result S110. The recognition result S110 obtained by the comparison processing portion 123 is sent to the task control portion 12 and the candidate creation portion 13.

The task control portion 12 switches the screen displayed by the display 137 based on the recognition result S110 produced by the speech recognition portion 11.

The candidate creation portion 13 creates task candidates S111 based on the recognition result S111 produced by the speech recognition portion 11. The task candidate S111 created by the candidate creation portion 13 is sent to the candidate presentation portion 14.

The candidate presentation portion 14 presents the task candidates S111 created by the candidate creation portion 13 on the display 137, and sends presentation position information S144 to the candidate selection portion 15. If a first time has elapsed after the candidate presentation portion 14 has presented the task candidates S111 and no presentation-stop signal S142 from the task control portion 12 has been received, then the candidate presentation portion 14 stops the presentation of the task candidate S111 presented on the display 137 and sends a trigger signal 143 to the candidate selection portion 15.

The infrared light sending portion 130 sends to the infrared light receiving portion 136 operation signals S146 entered with the cursor key 133 and/or the enter key 132.

The infrared light receiving portion 136 sends the operation signals S146 from the infrared light sending portion 130 to the candidate selection portion 15.

If the candidate selection portion 15 has received an operation signal S146 produced with the cursor key 133 during the time after receiving the presentation position information S144 from the candidate presentation portion 14 and before receiving the trigger signal S143, then the candidate selection portion 15 produces preliminary candidate position information S141 based on the operation signal S146 and the presentation position information S144, and changes the display on the display 137 based on the preliminary candidate position information S141. If the candidate selection portion 15 has received the operation signal S146 produced with the cursor key 133 before receiving the trigger signal S143 from the candidate presentation portion 14, then the candidate selection portion 15 produces selection information S112 based on the operation signal 146 and the presentation position information S144, and sends this selection information S112 to the task control portion 12.

The task control portion 12 sends a presentation-stop signal 142 to the candidate presentation portion 14 in response to the selection information S112 from the candidate selection portion 15. Furthermore, the task control portion 12 switches the screen of the display 137 based on the selection information S112 from the candidate selection portion 15.

The candidate presentation portion 14 stops the presentation of the task candidates S111 on the display 137 in response to the presentation-stop signal 142 from the task control portion 12.

Operation of Digital Television System

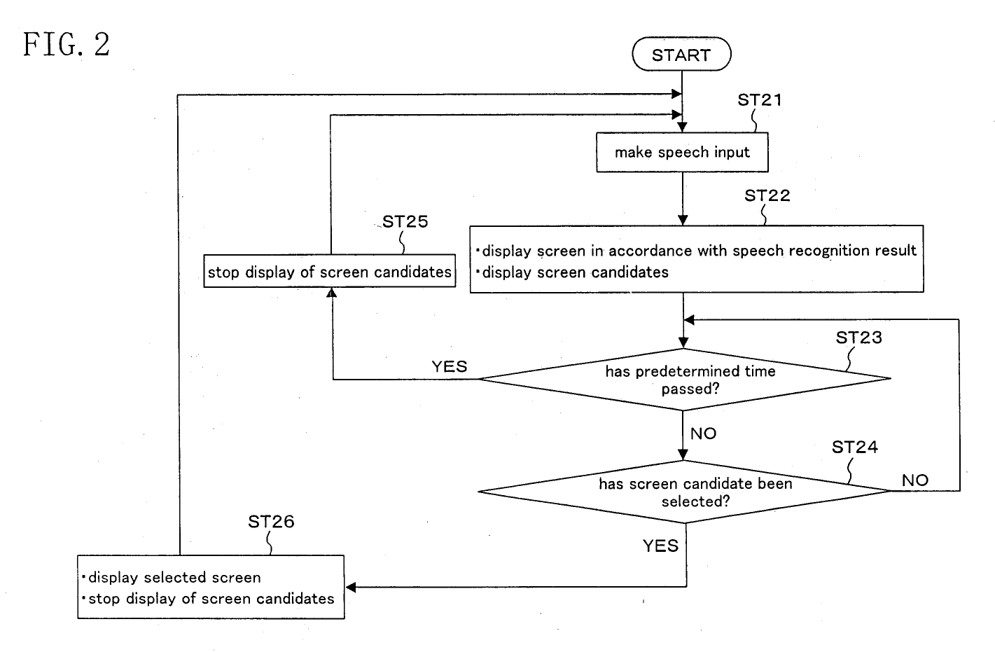

The following is an explanation of the operation of the digital television system configured as described above. Referring to FIGS. 2 to 4B, the following describes an example, in which an electronic television program guide is operated by speech and key operation.

(1) Case in Which the Screen Intended by the User is Displayed

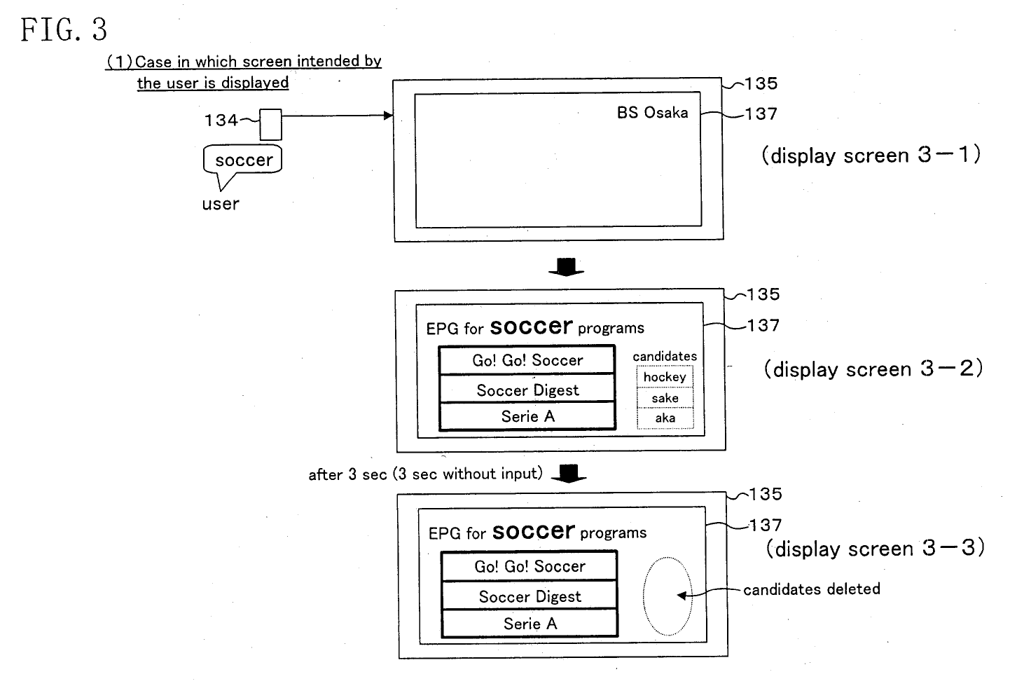

First, the program of the television station “BS Osaka” is shown on the display 137 (see display screen 3-1 in FIG. 3).

[Step ST21]

Facing the microphone 131 of the remote control 134, the user utters the word “soccer” in order to view the electronic program guide (EPG) for soccer programs (see display screen FIG. 3-1 in FIG. 3). The entered speech data are sent by the infrared light sending portion 130 to the infrared light receiving portion 136 of the television set 135. The infrared light receiving portion 136 sends the received speech data to the speech recognition portion 11. The speech recognition portion 11 outputs, as recognition results S110, “soccer,” which is the best match between the information concerning the speech data and the lexicon entries included in the recognition lexicon 122, and the second to fourth best matches “hockey,” “sake” and “aka” (which is the Japanese word for “red”). The recognition result S110 “soccer,” is sent to the task control portion 12, and the recognition results S110 “hockey,” “sake,” and “aka” are sent to the candidate creation portion 13. The candidate creation portion 13 creates the task candidates S111 “hockey,” “sake” and “aka” and sends them to the candidate presentation portion 14.

[Step ST22]

The task control portion 12 shows on the display 137 the electronic program guide (first screen) based on the recognition result S110 “soccer” (first task). The candidate presentation portion 14 presents on the display 137 “hockey,” “sake” and “aka,” which are the screen candidates for screens different from the first screen (see display screen 3-2 in FIG. 3). As shown in the display screen 3-2, by displaying “EPG for soccer programs” the user will know that what is shown on the screen at that time is the electronic program guide for soccer programs. Furthermore, in the displayed text “EPG for soccer program” the word “soccer,” that is, the recognition result, is displayed with emphasis. The region where the EPG for soccer programs is shown is emphasized by a bold frame. On the other hand, the screen candidates are shown in smaller type to the side of the screen. And by marking them as “candidates,” the user will know that what is shown are candidates. The region showing the “candidates” is shown in a thin dotted frame with small type.

It should be noted that it is also possible to let the user know that the screen that is displayed at that time is the electronic program guide for soccer programs by displaying “soccer” among the screen candidates in addition to displaying “EPG for soccer programs” or instead of displaying “EPG for soccer programs.”

The candidate presentation portion 14 sends the presentation position information S144, which is the information about the position at which the screen candidates “hockey,” “sake” and “aka” are shown on the display 137, to the candidate selection portion 15.

[Steps ST23 and ST24]

If the user has not operated the cursor key 133 for three seconds (a predetermined time) after the screen candidates have been displayed and has thus shown no intention of selecting a screen candidate (that is, if the candidate presentation portion 14 has received no presentation-stop signal S142), then the candidate presentation portion 14 sends a trigger signal S143 to the candidate selection portion 15 at three seconds (the predetermined time) after displaying the screen candidates, and prevents the candidate selection portion 15 from creating a selection signal S112 until the next speech data have been input. Then, the procedure advances to ST25.

[Step ST25]

As shown in the display screen 3-3 in FIG. 3, the candidate presentation portion 14 deletes (stops the display of) the screen candidates on the display 137.

(2) Case in Which the Screen Intended by the User is Not Displayed

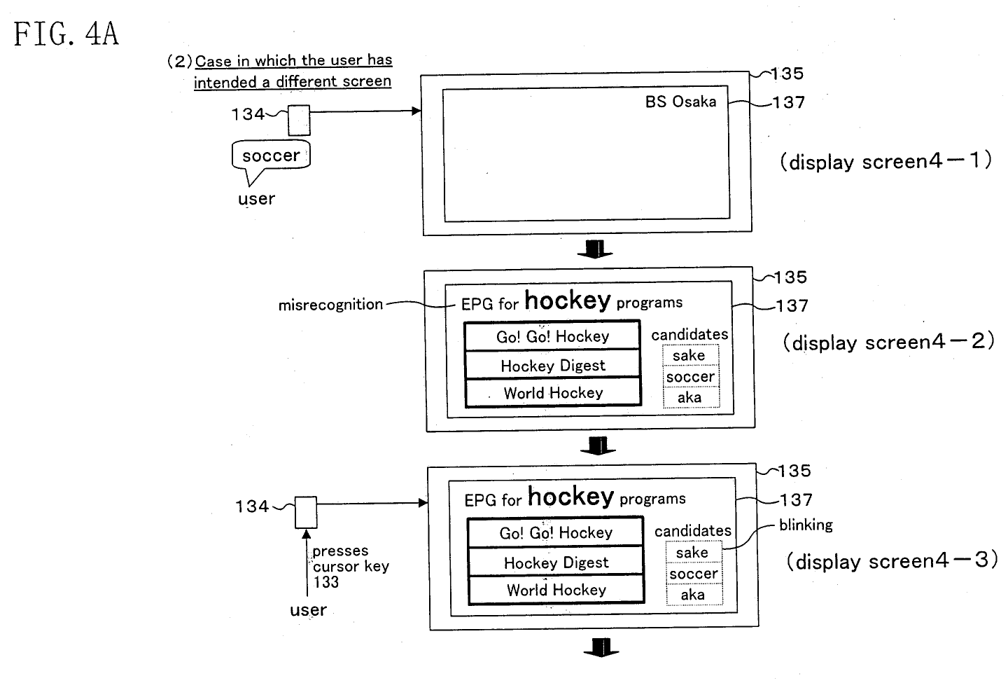

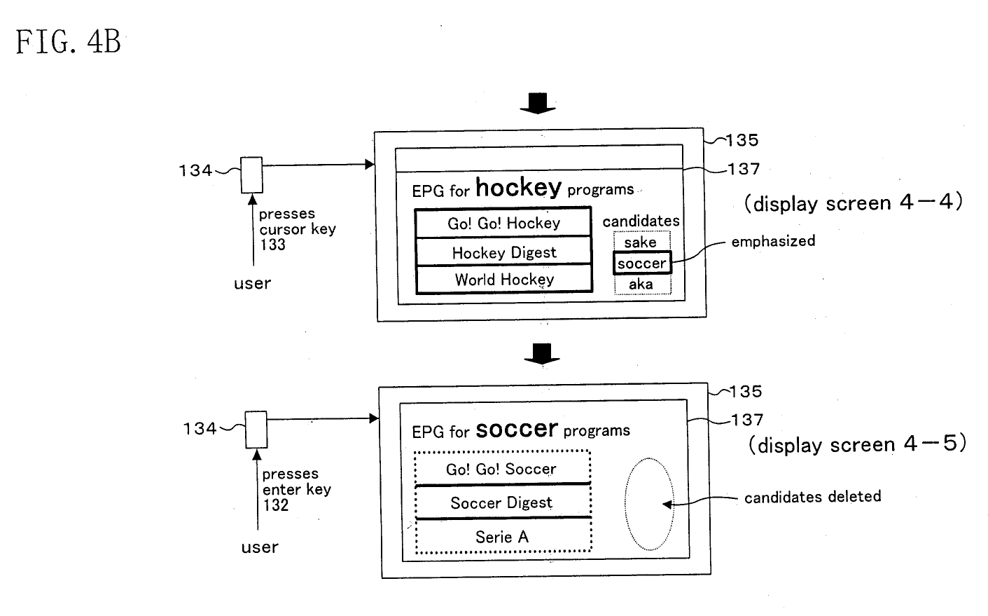

First, the program of the television station “BS Osaka” is shown on the display 137 (see display screen 4-1 in FIG. 4).

[Step ST21]

Facing the microphone 131 of the remote control 134, the user utters the word “soccer” in order to view the electronic program guide (EPG) for soccer programs (see display screen FIG. 4-1 in FIG. 4). The entered speech data are sent by the infrared light sending portion 130 to the infrared light receiving portion 136 of the television set 135. The infrared light receiving portion 136 sends the received speech data to the speech recognition portion 11. The speech recognition portion 11 outputs, as recognition results S110, “hockey,” (a misrecognition) which is the best match between the information concerning the speech data and the lexicon entries included in the recognition lexicon 122, and the second to fourth best matches “soccer,” “sake,” “aka”. The recognition result S110 “hockey” is sent to the task control portion 12, and the recognition results S110 “soccer,” “sake,” and “aka” are sent to the candidate creation portion 13. The candidate creation portion 13 creates the task candidates S111 “soccer,” “sake” and “aka” and sends them to the candidate presentation portion 14.

[Step ST22]

The task control portion 12 shows on the display 137 the electronic program guide (first screen) based on the recognition result S110 “hockey” (first task). The candidate presentation portion 14 presents on the display 137 “sake,” “soccer” and “aka,” which are the screen candidates for screens different from the first screen (see display screen 4-2 in FIG. 4). As shown in the display screen 4-2, by displaying “EPG for hockey programs” the user will know that what is shown on the screen at that time is the electronic program guide for hockey programs. Furthermore, in the displayed text “EPG for hockey program” the word “hockey,” that is, the recognition result, is displayed with emphasis. The region where the EPG for hockey programs is shown is emphasized by a bold frame. On the other hand, the screen candidates are shown in smaller type to the side of the screen. And by marking them as “candidates,” the user will know that what is shown are candidates. The region showing the “candidates” is shown in a thin dotted frame with small type.

It should be noted that it is also possible to let the user know that the screen that is displayed at that time is the electronic program guide for hockey programs by displaying “hockey” among the screen candidates in addition to displaying “EPG for hockey programs” or instead of displaying “EPG for hockey programs.”

The candidate presentation portion 14 sends the presentation position information S144, which is the information about the position at which the screen candidates “sake,” “soccer” and “aka” are shown on the display 137, to the candidate selection portion 15.

[Steps ST23 and ST24]

Since the screen that is wished by the user is the electronic program guide for soccer programs, the user operates the cursor key 133 of the remote control 134 within three seconds (a predetermined time) after the screen candidates are displayed, and thus expresses his wish to select a screen candidate (see display screen 4-3 in FIG. 4A). Based on the operation signal S146 produced in response to the operation of the cursor key 133, the candidate selection portion 15 produces preliminary candidate position information S141, and lets the frame of the candidates shown on the display 137 blink (see display screen 4-3 in FIG. 4A). Furthermore, as shown in display screen 4-4 in FIG. 4B, the screen candidate selected in accordance with the operation of the cursor key 133 is enclosed by a bold frame. It should be noted that it is also possible to change or invert the color of the selected candidate, or to display it in a larger font. Due to the operation signal S146 produced with the enter key 132, the candidate selection portion 15 determines “soccer” as the selection information S112 (see display screen 4-4 in FIG. 4B). The candidate selection portion 15 sends the selection information S112 “soccer” to the task control portion 12.

[Step ST26]

Based on the selection information S112, the task control portion 12 displays the electronic program guide for the soccer program on the display 137. In this situation, the electronic program guide for the soccer program is emphasized by displaying it large or changing its color, so that it is apparent that it has been corrected, Moreover, after receiving the selection information S112, the task control portion 12 sends the presentation-stop signal 142 to the candidate presentation portion 14. In response to the presentation-stop signal 142, the candidate presentation portion 14 stops the display of the task candidates shown on the display 137 (see display screen 4-5 in FIG. 4B).

Other Examples of Screen Displays

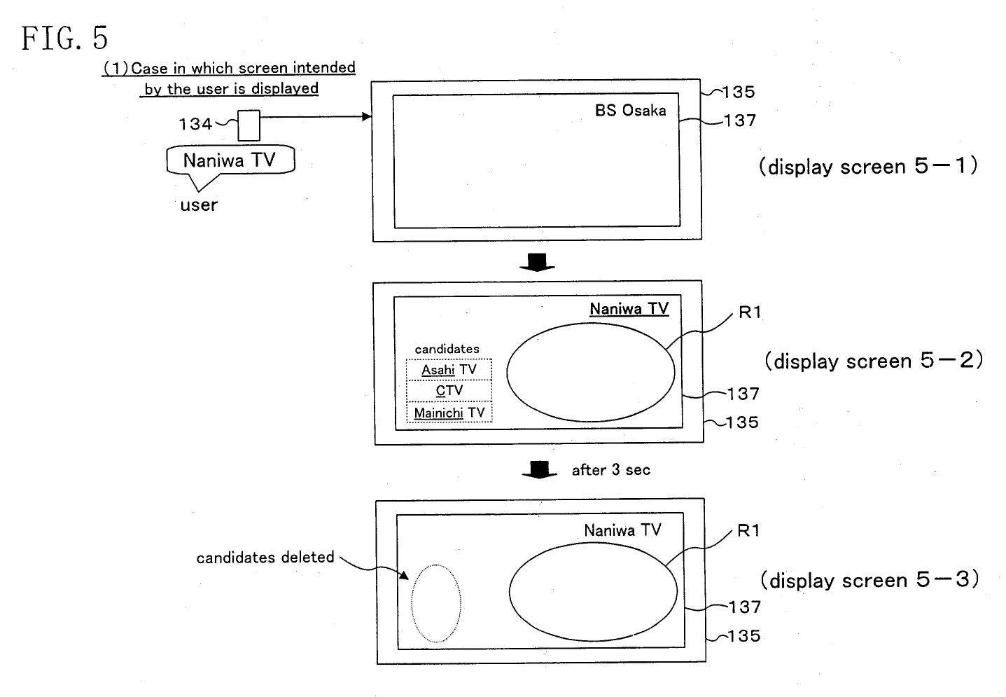

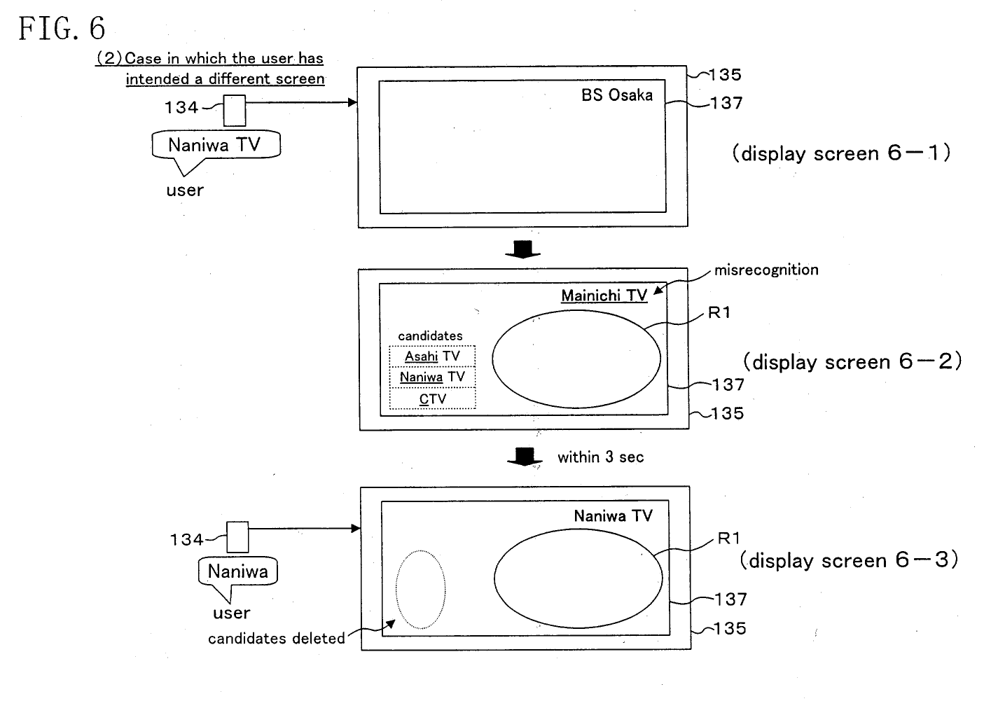

The following is a description of other examples of screen displays, with reference to FIGS. 5 and 6.

(1) Case in Which the Screen Intended by the User is Displayed

First, the program of the television station “BS Osaka” is shown on the display 137 (see display screen 5-1 in FIG. 5).

[Step ST21]

Facing the microphone 131 of the remote control 134, the user utters the word “Naniwa TV” in order to view the television station “Naniwa TV” (see display screen FIG. 5-1 in FIG. 5). The entered speech data are sent via the infrared light sending portion 130 and the infrared light receiving portion 136 to the speech recognition portion 11. The speech recognition portion 11 outputs, as a recognition result S110, “Naniwa TV,” which is the best match between the information concerning the speech data and the lexicon entries included in the recognition lexicon 122. The speech recognition portion 11 further outputs, as recognition results S110, “Asahi TV,” “CTV,” and “Mainichi TV,” which are those lexicon entries in the recognition lexicon 122 that are associated with “Naniwa TV.” Since “Naniwa TV,” “Asahi TV,” “CTV,” and “Mainichi TV” are those lexicon entries in the recognition lexicon 122 that are words that stand for a broadcasting station (a channel), these lexicon entries are associated with each other, with broadcasting station (channel) serving as the keyword. The recognition result S110 “Naniwa TV,” is sent to the task control portion 12, and the recognition results S110 “Asahi TV,” “CTV,” and “Mainichi TV” are sent to the candidate creation portion 13. The candidate creation portion 13 creates the task candidates S111 “Asahi TV” “CTV” and “Mainichi TV” and sends them to the candidate presentation portion 14.

[Step ST22]

As shown in the display screen 5-2 in FIG. 5, the task control portion 12 displays in a region R1 of the display 137 the screen of the recognition result S111 “Naniwa TV” (first task). In this situation, the text for the recognition result “Naniwa TV” is emphasized by underlining it. The candidate presentation portion 14 displays the screen candidates “Asahi TV,” “CTV” and “Mainichi TV” in a region of the display 137 outside the region R1 (see display screen 5-2 in FIG. 5). In this situation, the portions “Asahi,” “C” and “Mainichi,” which are the words to be uttered by the user (that is, the words that should be uttered for a selection), are emphasized by underlining them. Since the word “TV” is included in all words (candidates), this portion does not have to be uttered and is therefore not emphasized on the display.

[Steps ST23 and ST24]

If the user has shown no intention of selecting a screen candidate (i.e. made no utterance) for three seconds (a predetermined time) after the screen candidates are displayed (that is, if the candidate presentation portion 14 has received no presentation-stop signal S142), then the candidate presentation portion 14 sends at three seconds (a predetermined time) after the screen candidates have been displayed a trigger signal S143 to the candidate selection portion 15, and prevents the candidate selection portion 15 from creating a selection signal S112 until the next speech data have been input. Then, the procedure advances to ST25.

[Step ST25]

As shown in the display screen 5-3 in FIG. 5, the candidate presentation portion 14 deletes (stops the display of) the screen candidates on the display 137. Furthermore, the emphasis of the recognition result “Naniwa TV” is stopped.

(2) Case in Which the Screen Intended by the User is Not Displayed

First, the program of the television station “BS Osaka” is shown on the display 137 (see display screen 6-1 in FIG. 6).

[Step ST21]

Facing the microphone 131 of the remote control 134, the user utters the word “Naniwa TV” in order to view the television station “Naniwa TV” (see display screen FIG. 6-1 in FIG. 6). The entered speech data are sent via the infrared light sending portion 130 and the infrared light receiving portion 136 to the speech recognition portion 11. The speech recognition portion 11 outputs, as the recognition result S110, “Mainichi TV” (a misrecognition), which is the best match between the information concerning the speech data and the lexicon entries included in the recognition lexicon 122. The speech recognition portion 11 further outputs, as recognition results S110, “Asahi TV,” “Naniwa TV,” and “Mainichi TV,” which are those lexicon entries in the recognition lexicon 122 that are associated with “Mainichi TV” The recognition result S110 “Mainichi TV” is sent to the task control portion 12, and the recognition results S110 “Asahi TV,” “Naniwa TV,” and “CTV” are sent to the candidate creation portion 13. The candidate creation portion 13 creates the task candidates S111 “Asahi TV,” “Naniwa TV” and “CTV” and sends them to the candidate presentation portion 14.

[Step ST22]

As shown in the display screen 6-2 in FIG. 6, the task control portion 12 displays in a region R1 of the display 137 the screen of the recognition result S111 “Mainichi TV” (first task). In this situation, the text for the recognition result “Mainichi TV” is emphasized by underlining it. The candidate presentation portion 14 displays the screen candidates “Asahi TV,” “Naniwa TV” and “CTV” in a region of the display 137 outside the region R1 (see display screen 6-2 in FIG. 6). In this situation, the portions “Asahi,” “Naniwa” and “C,” which are the words to be uttered by the user (that is, the words that should be uttered for a selection), are emphasized by underlining them.

[Steps ST23, ST24 and ST26]

Since the screen that is wished by the user is “Naniwa TV,” the user utters the word “Naniwa” into the microphone 131 of the remote control 134 within three seconds (a predetermined time) after the screen candidates are displayed (see display screen 6-3 in FIG. 6). The entered speech data are sent via the infrared light sending portion 130 and the infrared light receiving portion 136 to the speech recognition portion 11. The speech recognition portion 11 outputs, as the recognition result S110, “Naniwa TV” , which is the best match between the information concerning the received speech data and the lexicon entries included in the recognition lexicon 122. The recognition result S110 “Naniwa TV” is sent to the task control portion 12. As shown in display screen 6-3 in FIG. 6, the task control portion 12 displays the screen of the recognition result S110 “Naniwa TV” in the region R1 of the display 137. Furthermore, the task control portion 12 sends a presentation-stop signal S142 to the candidate presentation portion 14. In response to this presentation-stop signal S142, the candidate presentation portion 14 stops the display of the task candidates that are shown on the display 137 (see display screen 6-3 in FIG. 6).

Effects

With the first embodiment as explained above, the task candidates created by the candidate creation portion 13 are displayed and the task intended by the user is selected and executed at whichever is the faster timing of a first timing with which the second task is executed and a second timing at which a first predetermined time after displaying task candidates has elapsed, so that the user does not need to perform again from the beginning the procedure for executing the task intended by the user. Consequently, usage becomes more convenient and less troublesome for the user.

Moreover, the candidate presentation portion 14 automatically stops the presentation of the task candidates if the user shows no intent of selecting a task candidate even after the first predetermined time has passed, so that if the first task that has been executed is the task intended by the user, the user does not need to stop the presentation of the task candidates. Consequently, usage becomes more convenient and less troublesome for the user. Furthermore, the screen display region can be utilized effectively. For example, it is possible to display other information in the region in which the candidates were displayed. In the case of a sports program, it is possible to display data about the players, for example. It is also possible to display news or weather information.

Furthermore, the task control portion 12 automatically executes the first task based on the recognition result S110 that has been output by the recognition portion 11, so that if the first task that is executed is the task that was intended by the user, the user does not have to select a task candidate. Consequently, usage becomes more convenient and less troublesome for the user.

Furthermore, the candidate presentation portion 14 automatically presents the task candidates, so that if the first task that is executed is not the task intended by the user, the user does not have to perform an operation in order to have the task candidates presented. Consequently, usage becomes more convenient and less troublesome for the user.

Moreover, the task candidates created by the candidate creation portion 13 include tasks related to the recognition data that are good matches when comparing information reflecting the entered task content to be recognized with the recognition lexicon entries, so that even when a misrecognition has occurred, it is possible to include the correct recognition among the task candidates and to correct the misrecognition with the user's selection. Consequently, usage becomes more convenient for the user.

It should be noted that the present embodiment is not limited to the above description, and the various adaptations listed below are also possible, for example.

a) The present embodiment may be further provided with a cancel function.

b) The speech recognition portion 11 may perform the recognition using linguistic knowledge, grammatical knowledge or semantic knowledge, and it may perform such processes as keyword extraction.

c) The recognition lexicon entries are not limited to words and may also be phrases or sentences.

d) The selection of the task candidates may also be performed by speech.

e) One task or one task candidate may be determined using a plurality of recognition results

f) There may be only one task candidate.

g) A task of realizing the cancel function may be included as one task candidate.

h) The communication between remote control and television set is not limited to infrared light, and it is also possible to apply wireless data communication (transmission) technology such as the Bluetooth standard.

i) The presentation of the task candidates is not limited to screen displays and may be accomplished by speech.

j) The number of task candidates that are presented does not have to be fixed.

k) The task candidates may be presented such that they scroll over the display.

l) Some of the task candidates may be displayed even after the first predetermined time has elapsed.

Second Embodiment

Configuration of Digital Television System

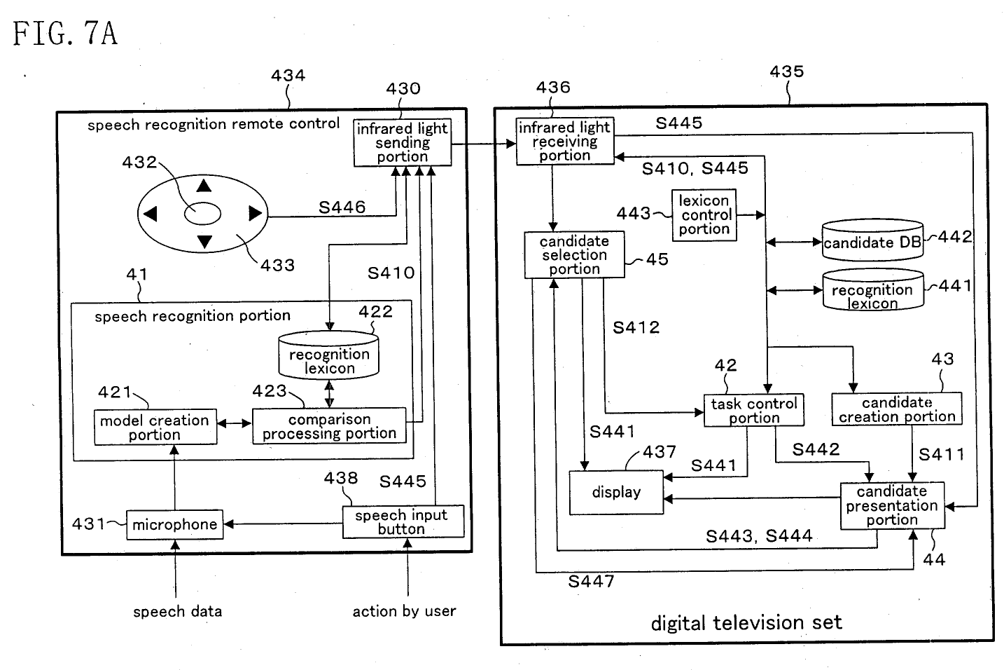

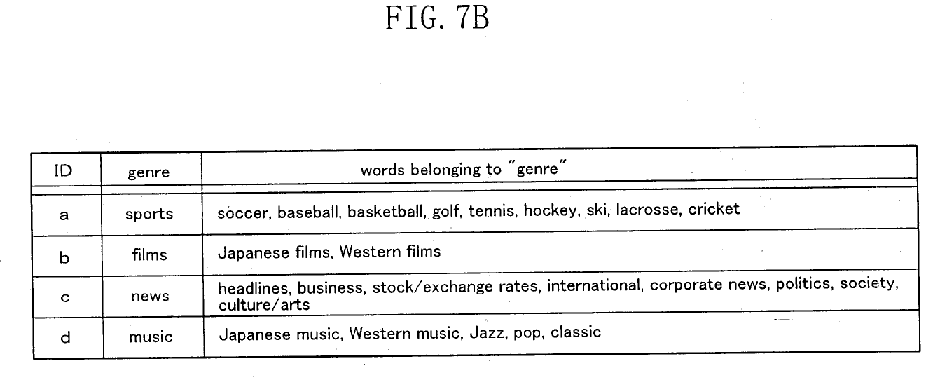

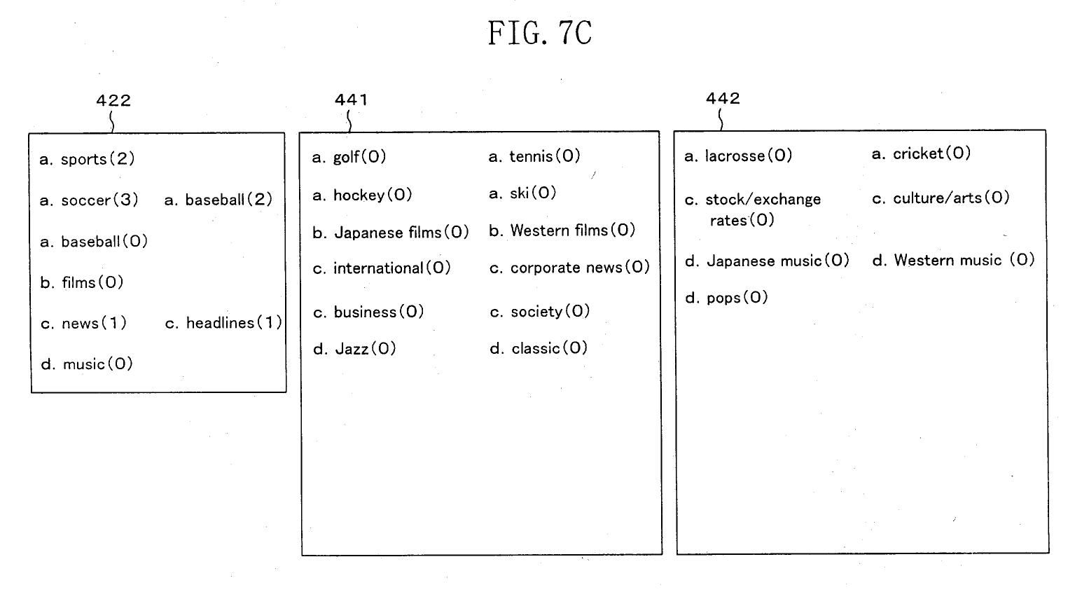

FIG. 7A shows the overall configuration of a digital television system in accordance with a second embodiment. This system is provided with a digital television set 435 and a remote control 434. The digital television set 435 includes an infrared light receiving portion 436, a task control portion 42, a candidate creation portion 43, a candidate presentation portion 44, an candidate selection portion 45, a display 437, a recognition lexicon 441, a lexicon control portion 443, and a candidate database (DB) 442. The remote control 434 includes a microphone 431, a speech entry button 438, a recognition portion 41, a cursor key 433, an enter key 432, and an infrared light sending portion 430. The recognition portion 41 includes a model creation portion 421, a recognition lexicon 422, and a comparison processing portion 423.

The microphone 431 receives speech data from the user while the speech entry button 438 is pressed, and sends them to the model creation portion 421.

The model creation portion 421 converts the speech data that have been sent by the microphone 431 into characteristic quantities and stores them as a model.

The comparison processing portion 423 compares the lexicon entries included in the recognition lexicon 422 with the model stored by the model creation portion 421, and produces a recognition result S410, which it sends to the infrared light sending portion 430.

The infrared light sending portion 430 sends the recognition result S410 to the infrared light receiving portion 436.

The infrared light receiving portion 436 sends the recognition result S410 sent by the infrared light sending portion 430 to the task control portion 42 and the candidate creation portion 43.

Based on the recognition result S410 sent by the infrared receiving portion 436, the task control portion 42 switches the screen of the display 437 (first task).

Based on the recognition result S410 that has been sent by the infrared light receiving portion 436, the candidate creation portion 43 creates task candidates S411 and sends those task candidates S411 to the candidate presentation portion 44.

The candidate presentation portion 44 presents the task candidates S411 created by the candidate creation portion 43 on the display 437, and sends a trigger signal S443 and presentation position information S444 to the candidate selection portion 45.

If the candidate selection portion 45 has not received an operation signal S446 produced by the cursor key 433 after the trigger signal S443 has been received and before a first predetermined time has elapsed, then a presentation-stop signal S447 is sent to the candidate presentation portion 44.

In response to the presentation-stop signal S447, the candidate presentation portion 44 stops the presentation of the task candidates S411 that are presented on the display 437 (second timing).

The infrared light sending portion 430 sends operation signals S446 entered with the cursor key 433 and/or the enter key 432 to the infrared light receiving portion 436.

The infrared light receiving portion 436 sends the operation signals S446 to the candidate selection portion 45.

If the candidate selection portion 45 receives an operation signal S446 produced with the cursor key 433 after the trigger signal S443 sent by the candidate presentation portion 44 has been received and before a first predetermined time has elapsed, then preliminary candidate position information S441 is produced based on the operation signal S446 produced with the cursor key 433 and the presentation position information S444 sent by the candidate presentation portion 44, and what is shown on the display 137 is changed based on this preliminary candidate position information S441. If the candidate selection portion 45 receives the operation signal S446 produced with the cursor key 433 in the time after the trigger signal S443 has been received and before the first predetermined time has elapsed) then selection information S412 based on the operation signal S446 produced with the cursor key 433 and/or the enter key 432 and the presentation position information S444 is produced, and this selection information S412 is sent to the task control portion 412.

The task control portion 42 receives the selection information S412 produced by the candidate selection portion 45 and sends a presentation-stop signal S442 to the candidate presentation portion 44. Furthermore, the task control portion 42 switches the screen of the display 137 based on the selection information S412 that has been sent by the candidate selection portion 45 (second task).

The candidate presentation portion 44 receives the presentation-stop signal S442 sent by the task control portion 42, and stops the presentation of the task candidates S411 on the display 437 (first timing).

The infrared light sending portion 430 sends an action signal S445 from the user, which is general information that has been prepared with the speech entry button 438 and reflects a task that is different from the first task, to the infrared receiving portion 436.

The infrared receiving portion 436 sends the action signal S445 to the candidate selection portion 45 and the candidate presentation portion 44.

The candidate selection portion 45 receives the action signal S445 and does not produce any selection information S412 until it receives the next presentation position information S444.

The candidate presentation portion 44 receives the action signal S445 and stops the presentation of the task candidates S411 on the display 437 (third timing).

The table shown in FIG. 7B is stored in the candidate DB 442. In the table shown in FIG. 7B, four association regions (groups) based on genres have been set. Here, “association region” corresponds to “semantic closeness.” That is to say, words belonging to the same association region (group) can be said to be semantically close to one another. In the table shown in FIG. 7B, the four groups are associated with information (group IDs) a to d for identifying those groups. The groups are grouped together taking the genre as the keyword. The groups include a word indicating the genre of the group and words belonging to the genre indicated by that word. The group corresponding to ID a (group a) includes the word “sports” indicating the genre of group a and the words “soccer,” “baseball,” . . . , “cricket” belonging to the genre “sports.” Group b includes the word “films” indicating the genre of group b and the words “Japanese films” and “Western films” belonging to the genre “films.” Group c includes the word “news” indicating the genre of group c and the words “headlines,” “business,” . . . , “culture” belonging to the genre “news.” Group d includes the word “music” indicating the genre of group d and the words “Japanese music,” “Western music,” . . . , “classic” belonging to the genre “music.”

As shown in FIG. 7C, the data indicating the words included in each group (glossary entries) are stored in the recognition lexicons 422 and 441 or the candidate DB 442. The glossary entries stored in the recognition lexicons 422 and 441 are stored in the form of lexicon entries for speech recognition. The candidate DB 442 stores glossary entries for which lexicon entries for speech recognition have not been prepared so far. The various glossary entries are associated with respective IDs indicating the group to which the glossary entries belong and data indicating the number of times they have been selected by the user by speech using the speech recognition remote control 434 or by key input. In FIG. 7C, the IDs indicating the groups are “a.” (for group a), “b.” (for group b), etc., and the data indicating the number of times they have been selected are given as (0) (meaning they have been selected zero times) (1), (meaning they have been selected once), etc.

In order to reduce misrecognitions in the speech recognition portion 41, the number of glossary entries (lexicon entries) sets stored in the recognition lexicon 422 is limited. The glossary entries stored in the recognition lexicon 422 are determined based on predetermined criteria. Here, the glossary entries indicating the genres, namely “sports,” “films,” “news” and “music,” as well as the glossary data that are selected relatively often (i.e. that are used frequently), namely “soccer,” “baseball” and “headlines,” are stored in the recognition lexicon 422. Moreover, for the groups with the highest usage frequency of all groups (group a in this example), the number of glossary entries stored in the recognition lexicon 422 is made larger than for the other groups. Therefore, the glossary entry “basketball” is stored in the recognition lexicon 422.

Operation Of Digital Television System

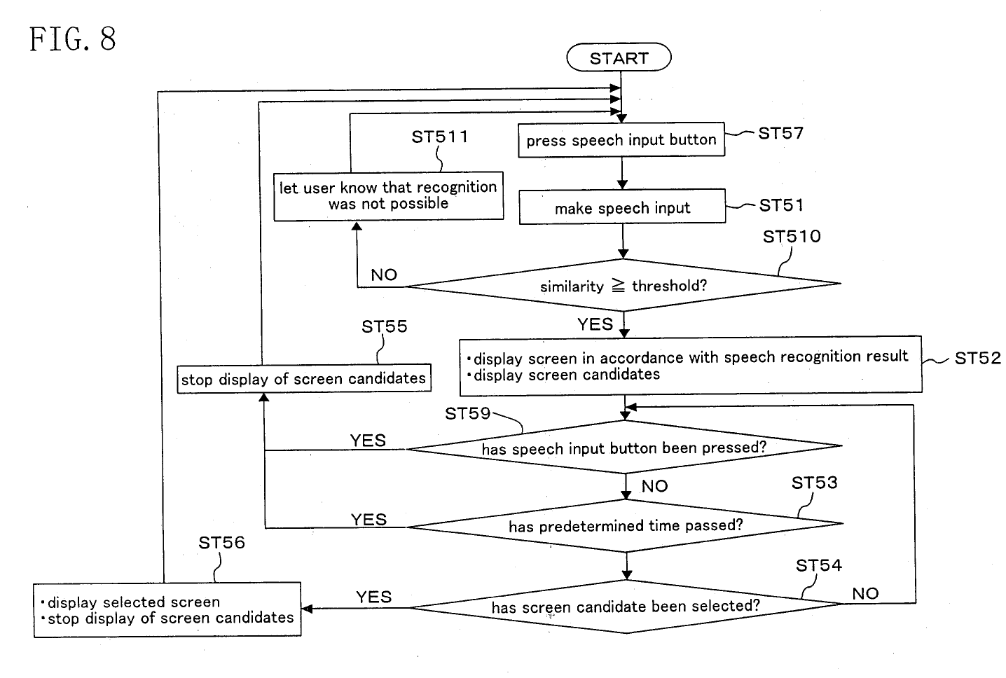

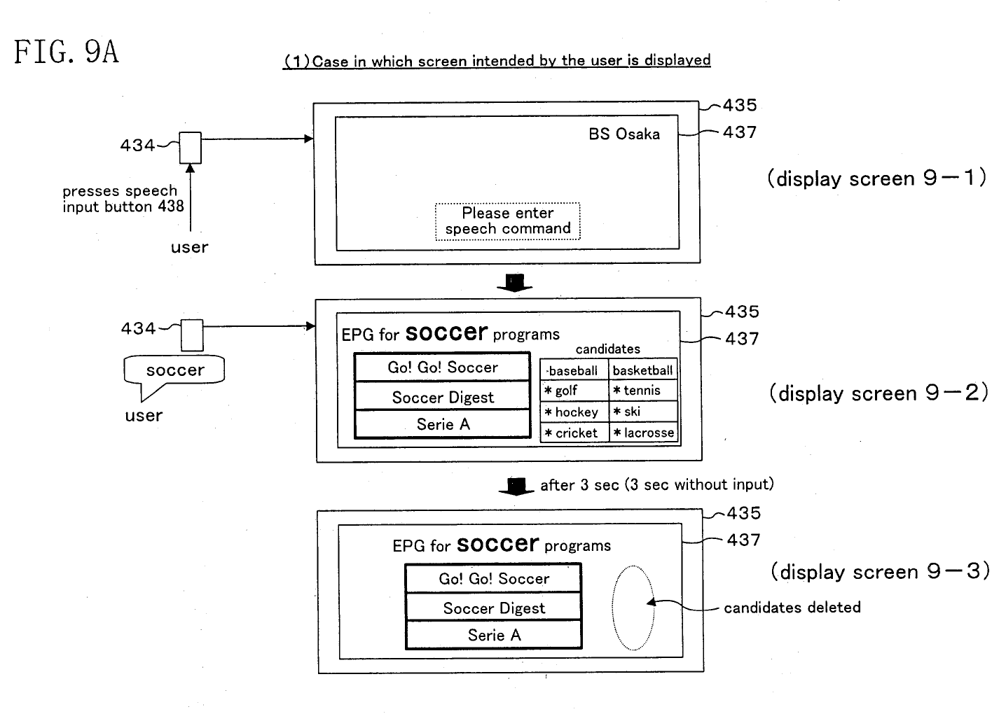

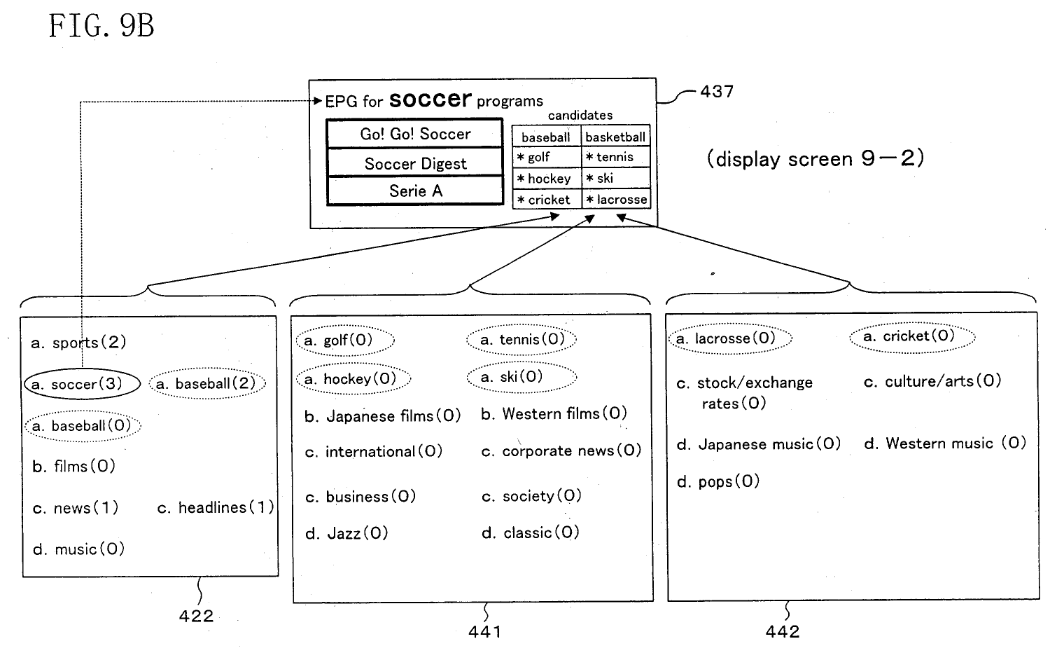

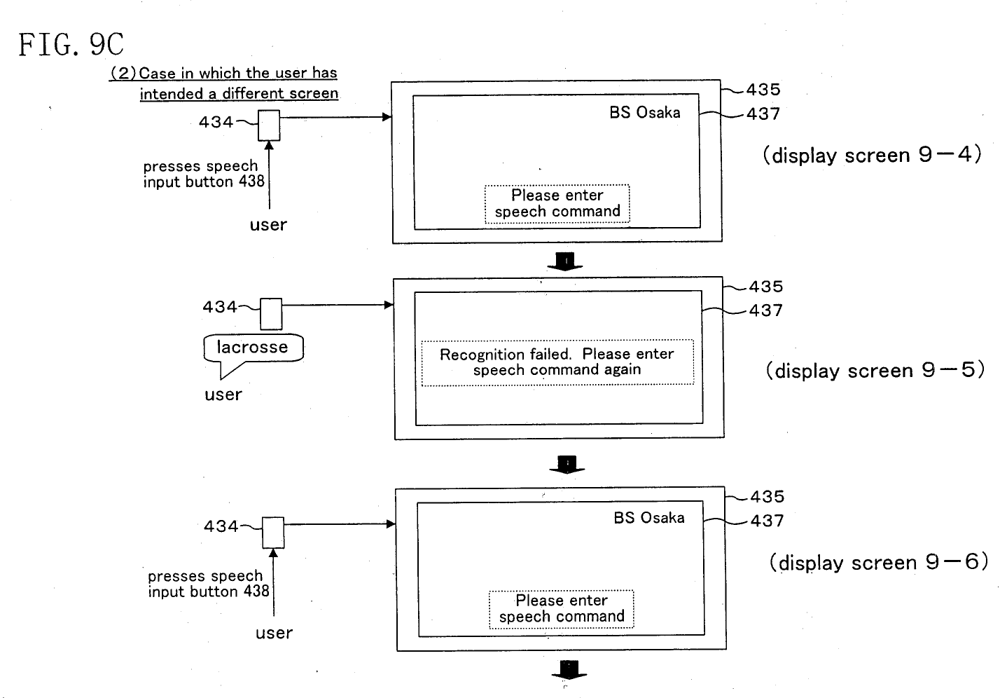

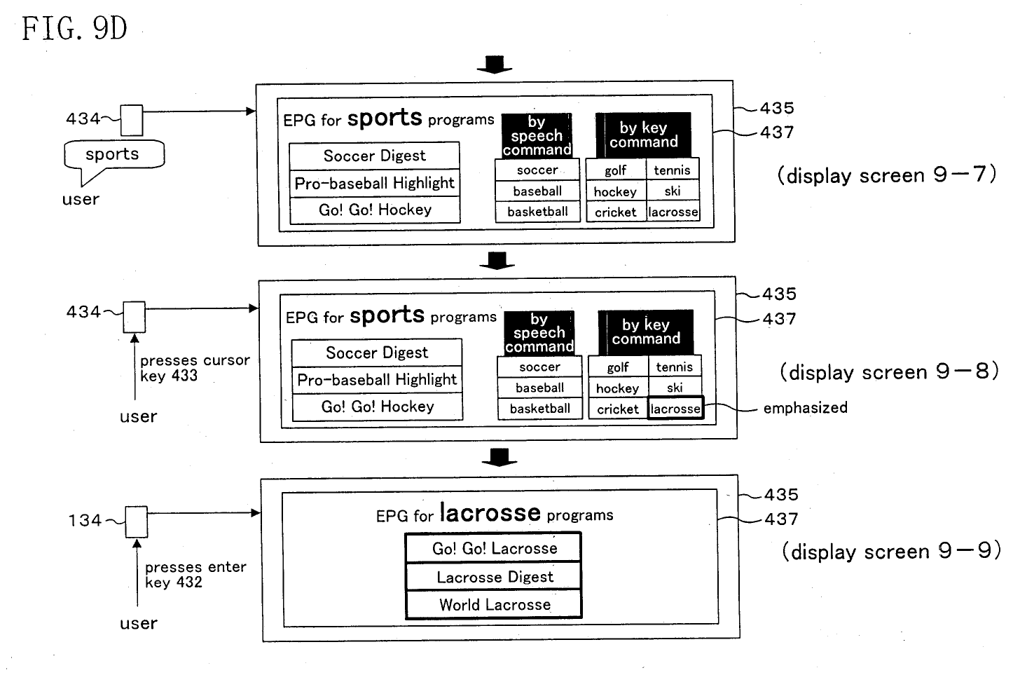

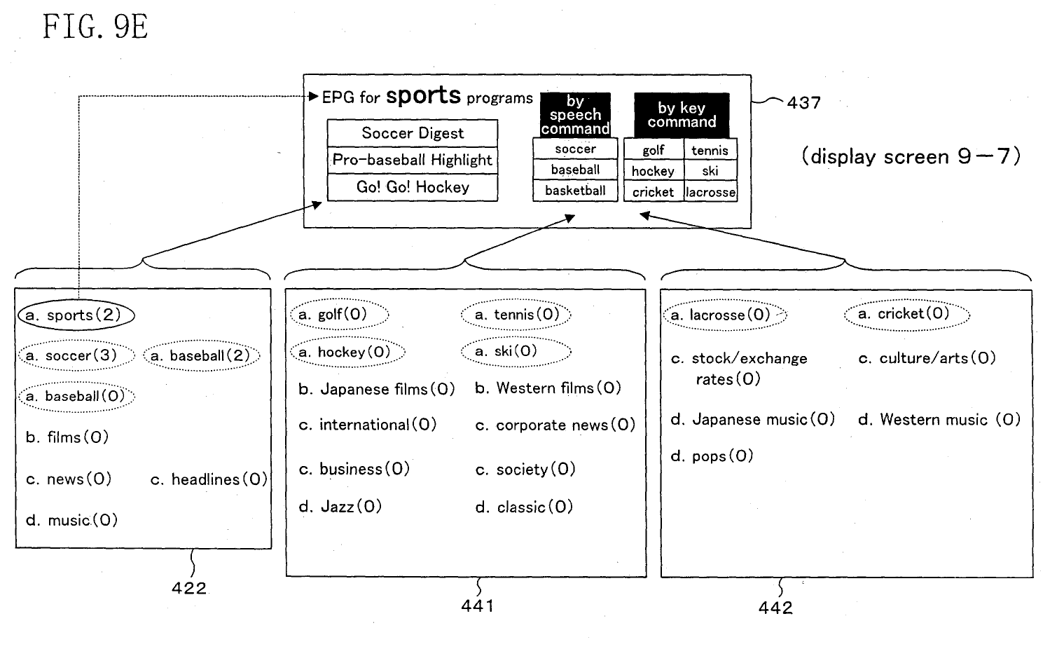

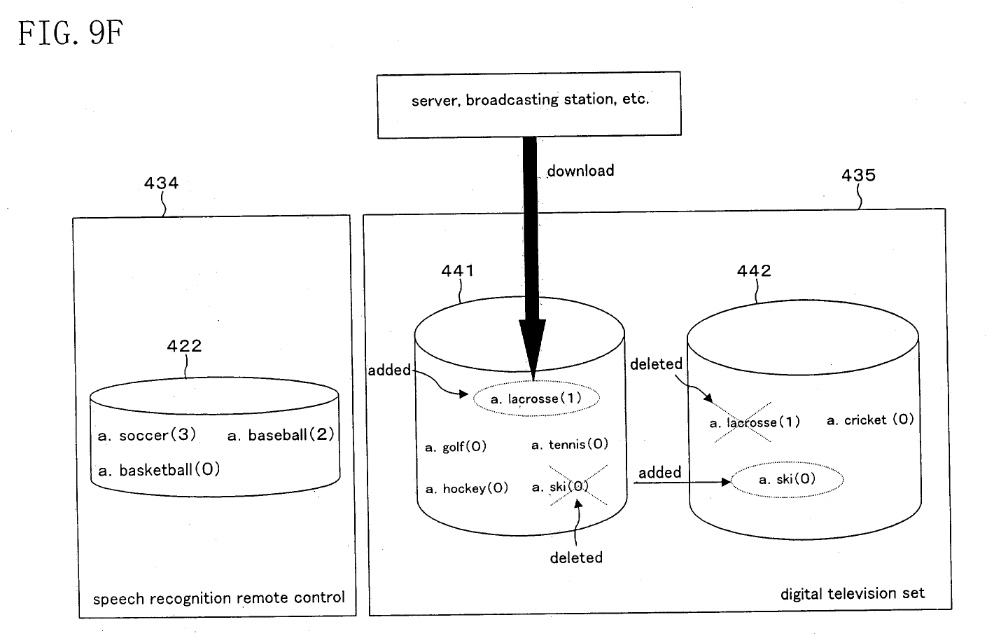

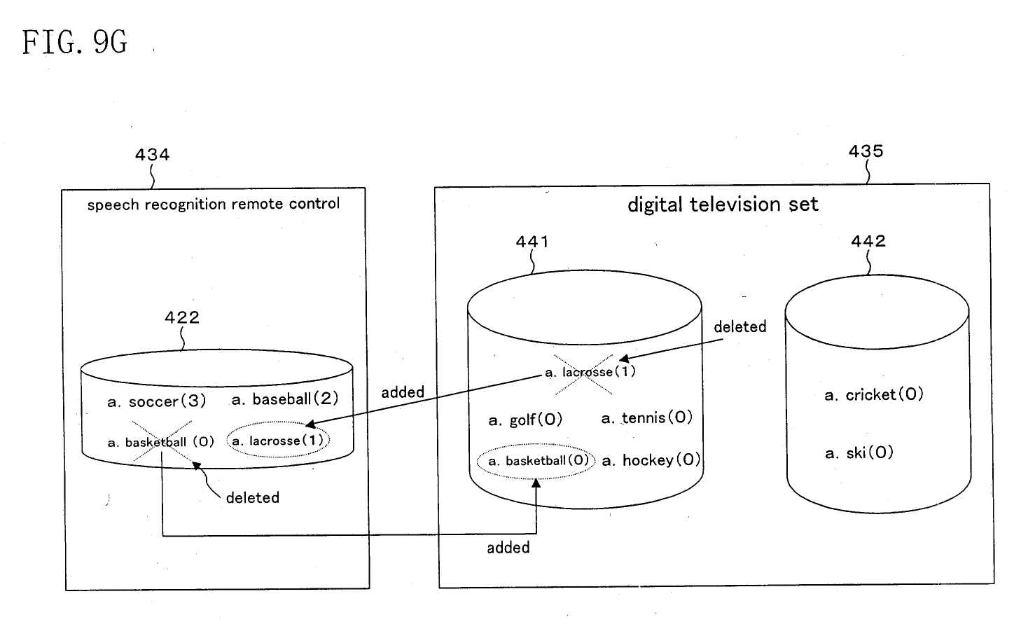

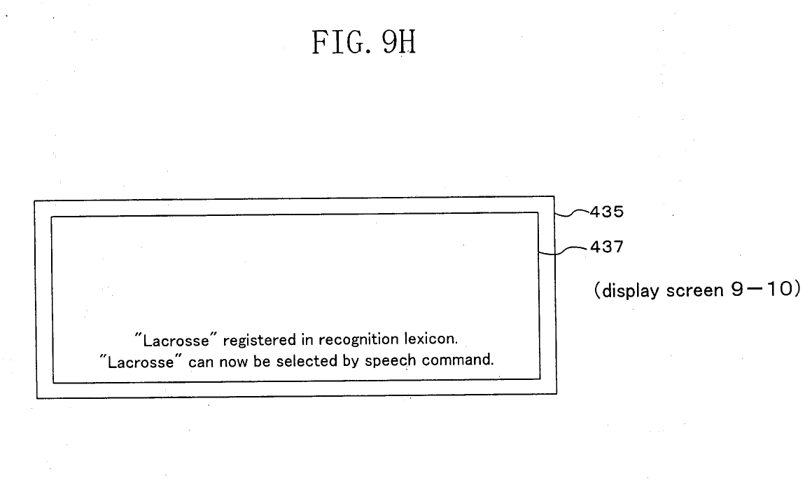

The following is an explanation of the operation of the system configured as described above. With reference to FIG. 8 and FIGS. 9A to 9H, an example is described, in which an electronic television program guide is operated by speech and key operation.

(1) Case in Which the Screen Intended by the User is Displayed

First, the program of the television station “BS Osaka” is shown on the display 437 (display screen 9-1 in FIG. 9).

[Step ST57]

The user presses the speech entry button 438 in order to make a speech input. In response to that, an action signal S445 is sent to the candidate presentation portion 44. In response to the action signal S445, if the candidate presentation portion 44 is displaying task candidates S411 on the display 437, then the display of the task candidates S411 is stopped, and the message “please enter speech command” is shown on the display 437 (see display screen 9-1 in FIG. 9A).

[Step ST51]

While pressing down the speech entry button 438 of the remote control 434, the user faces the microphone 431 and utters “soccer” (display screen 9-2 of FIG. 9A). The entered speech data are sent to the recognition portion 41. The recognition portion 41 selects from the lexicon entries included in the recognition lexicon 422 the lexicon entry that has the greatest similarity with the information concerning the speech data (in this example: “soccer”).

[Step ST510]

Next, the recognition portion 41 determines whether the degree of similarity to the selected lexicon entry is at least a predetermined threshold. If the degree of similarity is at least a predetermined threshold, then the procedure advances to Step ST52. If the degree of similarity is lower than the predetermined threshold, then the procedure advances to Step ST511. Here, it is assumed that the procedure advances to Step ST52.

It should be noted that the “predetermined threshold” does not necessarily have to be fixed to one value. It is also possible to adopt a configuration in which the user can change the threshold as appropriate in accordance with the usage environment or certain usage qualities (for example when the recognition rate is low).

[Step ST52]

The recognition portion 41 outputs “soccer” as the recognition result S410. This recognition result S410 is sent via the infrared light sending portion 430 to the infrared light receiving portion 436 of the television set 435. The infrared light receiving portion 436 sends the received recognition result S410 “soccer” to the task control portion 42 and the candidate creation portion 43.

Based on the recognition result S410 “soccer,” the candidate creation portion 43 creates task candidates 411. The candidate creation portion 43 references the table in the candidate DB 442 (see FIG. 7B), and extracts the glossary entries “baseball,” “basketball,” “golf,” “tennis,” “hockey,” “ski,” “lacrosse” and “cricket,” which belong to the same group (group a) as “soccer.” It should be noted that the glossary entry “soccer” and the glossary entry “sports,” which indicates the genre, are excluded. The candidate creation portion 43 sends the extracted glossary data as the task candidates S411 to the candidate presentation portion 44. The candidate creation portion 43 attaches to each of the task candidates S411 information that indicates whether the extracted glossary entry is included in the recognition lexicon 422.

Based on the recognition result S410 “soccer,” the task control portion 42 displays the electronic program guide for soccer programs, which is the first screen, on the display 437 (first task). The candidate presentation portion 44 displays on the display 437 “baseball,” “basketball,” “golf” “tennis,” “hockey,” “ski,” “lacrosse” and “cricket,” which are the screen candidates for screens different from the first screen (see display screen 9-2 in FIGS. 9A and 9B). As shown in FIG. 9B, no asterisk is put in front of “baseball” and “basketball, which are screen candidates that are included in the recognition lexicon 422, whereas “golf” “tennis,” “hockey,” “ski,” “cricket” and “lacrosse,” which are screen candidates that are not included in the recognition lexicon 422, are marked with an asterisk before them. This indicates to the user whether the displayed candidates are included in the recognition lexicon 422. Thus, the user can know what can be selected by speech and what cannot be selected by speech (that is, what needs to be selected by the operation keys). At the same time as the screen candidates are displayed, the candidate presentation portion 44 sends to the candidate selection portion 45 a trigger signal S443 and presentation position information S444, which is information about the position at which the screen candidates “baseball,” “basketball,” “golf” “tennis,” “hockey,” “ski,” “cricket” and “lacrosse” are shown on the display 437.

[Steps ST59, ST53 and ST54]

If for a time of three seconds (first predetermined time) after the candidate selection portion 45 has received the trigger signal S443, the user does not press the speech entry button 438 to enter speech data, and if for a time of three seconds (predetermined time) after the candidate selection portion 45 has received the trigger signal S443, the cursor key 433 is not operated to express the intention to select a screen candidate, then the candidate selection portion 45 does not produce selection information S412 until the next action signal S445 is received.

[Step ST55]

The candidate presentation portion 44 stops the display of the screen candidates on the display 437 (display screen 9-3 in FIG. 9A).

(2) Screen Intended by the User is Not Displayed

First, the program of the television station “BS Osaka” is shown on the display 437 (display screen 9-4 in FIG. 9C).

[Step ST57]

The user presses the speech entry button 438 in order to make a speech input. In response, an action signal S445 is sent to the candidate presentation portion 44. In response to the action signal S445, if the candidate presentation portion 44 is displaying task candidates S411 on the display 437, then the display of the task candidates S411 is stopped, and the message “please enter speech command” is shown on the display 437 (see display screen 9-4 in FIG. 9C).

[Step ST51]

The user wishes to view the EPG for “lacrosse” on the display 437. Now, since “lacrosse” is a minor sport, the user is uncertain whether the EPG for “lacrosse” can be displayed by speech. To attempt such a display, the user faces the microphone 431 while pressing down the speech entry button 438 of the remote control 434, and tentatively utters the word “lacrosse” (display screen 9-5 in FIG. 9C). The entered speech data are sent to the recognition portion 41. The recognition portion 41 selects from the lexicon entries included in the recognition lexicon 422 the lexicon entry that has the greatest similarity with the information concerning the speech data.

[Step ST510]

Next, the recognition portion 41 determines whether the degree of similarity to the selected lexicon entry is at least a predetermined threshold. If the degree of similarity is at least a predetermined threshold, then the procedure advances to Step ST52. Here, it is assumed that the degree of similarity is lower than the predetermined threshold. The recognition portion 41 sends a signal which indicates this to the task control portion 42. Then, the procedure advances to Step ST511.

[Step ST511]

The task control portion 42 displays the message “Recognition failed. Please enter speech command again.” on the display 437 (see display screen 9-5 in FIG. 9C). Then the procedure returns to Step ST57. It should be noted that as a means for notifying the user, it is also possible to use sound (for example a beep), light (such as an optical signal from an LED or the like) or speech, for example.

[Step ST57]

The user presses the speech input button 438 again. In response to that, the display 437 is cleared, and the message “please enter speech command” appears on the display 437 (display screen 9-6 in FIG. 9C).

[Step ST51]

The user knows that “lacrosse” belongs to the genre “sport.” Thus, while pressing the speech input button of the remote control 434 and facing the microphone 431, the user utters “sports” this time (display screen 9-7 in FIG. 9C). The recognition portion 41 selects from the lexicon entries included in the recognition lexicon 422 the lexicon entry that has the greatest similarity with the information concerning the speech data (in this example: “sports”).

[Step ST510]

Next, the recognition portion 41 determines whether the degree of similarity to the selected lexicon data is at least a predetermined threshold. Here, it is assumed that the degree of similarity is greater than the predetermined threshold.

[Step ST52]

The recognition portion 41 outputs “sports” as the recognition result S410. This recognition result S410 is sent to the task control portion 42 and the candidate creation portion 43.

Based on the recognition result S410 “sports,” the candidate creation portion 43 creates task candidates S411. The candidate creation portion 43 references the table in the candidate DB 442 (see FIG. 7B), and extracts the glossary entries “soccer,” “baseball,” “basketball,” “golf,” “tennis,” “hockey,” “ski,” “lacrosse” and “cricket,” which belong to the same group (group a) as “sports.” It should be noted that the glossary entry “sports” has been excluded. The candidate creation portion 43 sends the extracted glossary entries as the task candidates S411 to the candidate presentation portion 44. The candidate creation portion 43 attaches to each of the task candidates S411 information that indicates whether the extracted glossary entry is included in the recognition lexicon 422.

Based on the recognition result S410 “sports,” the task control portion 42 displays the text “EPG for sports programs” on the display 437 (first task). The candidate presentation portion 44 presents on the display 437 the screen candidates “soccer,” “baseball,” “basketball,” “golf,” “tennis,” “hockey,” “ski,” “lacrosse” and “cricket” (see display screen 9-7 in FIG. 9D and FIG. 9E). As shown in FIG. 9E, “soccer,” “baseball” and “basketball,” which are the screen candidates that are included in the recognition lexicon 422, are displayed in association with the text “speech command OK.” This indicates to the user that it is possible to select “soccer,” “baseball” and “basketball” by speech. On the other hand, the screen candidates “golf,” “tennis,” “hockey,” “ski,” “cricket” and “lacrosse,” which are the screen candidates that are not included in the recognition lexicon 422, are displayed in association with the text “by operation keys.” This indicates to the user that “golf,” “tennis,” “hockey,” “ski,” “cricket” and “lacrosse” cannot be selected by speech and must be selected with the operation keys.

Looking at the display screen 9-7, the user knows that the desired item “lacrosse” cannot be selected by speech, but must be selected with the operation keys.

At the same time as the screen candidates are displayed, the candidate presentation portion 44 sends presentation position information S444 and a trigger signal S443 to the candidate selection portion 45.

[Step ST59, ST53 and ST54]

Within three seconds (first predetermined time) after the candidate selection portion 45 has received the trigger signal S443, the user operates the cursor key 433 on the remote control 434 to express the intention to select a screen candidate. Based on the operation signal S446 produced with the cursor key 433, the candidate selection portion 45 produces preliminary selection position information S441, and “lacrosse,” which is the screen candidate that is currently assumed to be the preliminary screen candidate on the display 437, is emphasized (for example by enclosing it in a bold frame or changing the color of the text) (display screen 9-8 in FIG. 9D). With the operation signal S446 produced by the enter key 432, the candidate selection portion 45 determines “lacrosse” as the selection information S412. The candidate selection portion 45 sends the selection information S412 “lacrosse” to the task control portion 42 (display screen 9-9 in FIG. 9D).

[Step ST56]

Based on the selection information S412, the task control portion 42 shows on the display 437 the electronic program guide for lacrosse programs (second task) (display screen 9-9 in FIG. 9D).

[Adding and Deleting Lexicon Data]

The possibility that the user again selects “lacrosse” can be assumed to be high. Thus, as shown in FIG. 9F, the lexicon control portion 443 downloads the lexicon entry for speech recognition of “lacrosse” from a server or from the broadcasting station. The downloaded lexicon data are stored in the recognition lexicon 441 by the lexicon control portion 443. When the recognition lexicon 441 is full, other lexicon entries are deleted from the recognition lexicon 441 by the lexicon control portion 443. The deleted lexicon data are added to the candidate DB 442 by the lexicon control portion 443.

Then, as shown in FIG. 9G, the number of times that the downloaded “lacrosse” and the lexicon entries included in the recognition lexicon 422 have been selected are compared with one another by the lexicon control portion 443. If there are lexicon entries that have been selected fewer times than “lacrosse,” then those lexicon entries are deleted from the recognition lexicon 422 by the lexicon control portion 443. The deleted lexicon data are added to the recognition lexicon 441 by the lexicon control portion 443. Then, the lexicon entry for “lacrosse” is added to the recognition lexicon 422 by the lexicon control portion 443.

When the lexicon entry for “lacrosse” has been added to the recognition lexicon 422, the display screen 9-10 in FIG. 9H appears on the display 437. Thus, the user knows that from the next time on it will be possible to select “lacrosse” by speech.

Effects

With the second embodiment of the present invention as explained above, the task candidates S411 created by the candidate creation portion 43 are presented and selected by the user at whichever is the faster timing of a first timing with which the second task is executed, a second timing at which a first predetermined time after displaying the task candidates has elapsed, and a third timing at which general information reflecting a task that is different from the first task is entered, and the user does not need to perform again from the beginning the procedure for executing the task intended by the user. Consequently, usage becomes more convenient and less troublesome for the user.

Moreover, the candidate presentation portion 44 automatically stops the presentation of the task candidates S411 if the user shows no intent of selecting a task candidate even after the first predetermined time has passed, so that if the first task that has been executed is the task intended by the user, the user does not need to stop the presentation of the task candidates S411. Consequently, usage becomes more convenient and less troublesome for the user.

Furthermore, the task control portion 42 automatically executes the first task based on the recognition result S410 that has been output by the recognition portion 41, so that if the executed task is the task that was intended by the user, then the user does not have to select a task candidate. Consequently, usage becomes more convenient and less troublesome for the user.

Furthermore, the candidate presentation portion 44 automatically presents the task candidates S411, so that if the first task that is executed is not the task intended by the user, the user does not have to perform an operation in order to present the task candidates. Consequently, usage becomes more convenient and less troublesome for the user.

Moreover, the task candidates 411 created by the candidate creation portion 43 are not candidates that are acoustically close but candidates that are semantically close to the recognition result S410 attained with the recognition portion 41. Thus, the convenience for the user is improved.

Furthermore, if task candidates are produced from the recognition lexicon entries, then the description included among the recognition lexicon data can be presented to the user, so that the recognition ratio is increased. Furthermore, if task candidates are produced that are not among the recognition lexicon entries, then the user can immediately execute tasks that are not included among the recognition lexicon entries. Consequently, usage is convenient for the user.

It should be noted that the present embodiment is not limited to the above description, and the various adaptations listed below are also possible, for example.

a) The present embodiment may be further provided with a cancel function.

b) The recognition portion 41 may perform the recognition using linguistic knowledge, grammatical knowledge or semantic knowledge, and it may perform such processes as keyword extraction.

c) The recognition lexicon entries 422 are not limited to words and may also be phrases or sentences.

d) One task or one task candidate may be determined using a plurality of recognition results.

e) There may be only one task candidate 411.

f) A task of realizing the cancel function may be included as one of the task candidates S411.

g) As task candidates S411, tasks may be included that are related to recognition data that are good matches when comparing information reflecting the entered task content to be recognized with the recognition lexicon 422.

h) Here, the association regions in the table shown in FIG. 7B have been set based on genres (regions of association by genre). However, the criteria for setting the association regions are not limited to this.

For example, the association regions may also be set based on associated keywords (regions of association by term). In that case, associated regions are set for each reference term. The association region corresponding to a certain reference term includes keywords that are associated with that reference term. For example: “Nakata” and “World Cup” may be included in the association region for the reference term “soccer.” “Color, “black” and “apple” may be included in the association region for the reference term “red.” “Soccer,” “baseball” and “golf” are included in the association region for the reference term “sports.”

The association regions may also be set based on the user's personal taste and/or behavioral patterns (regions of association by habits). For example, the keywords “soccer,” “sports digest” and “today's news,” which are keywords of programs that the user often views, may be included in the association region for the reference term “my favorite programs.” Or the keywords “e-mail” and “prepare bath,” which take into account the user and the time of day, may be included in the association region for the reference term “things to do now.”

The association regions may also be set based on related device operations (regions of association by function). For example, in the case of video operation, the keywords “stop,” “skip” and “rewind” may be included in the association region for the reference term “play.”

i) Recognition lexicon entries 422 may be added as necessary.

j) The information that the cancel function has been carried out may be used as general information reflecting a task that is different from the first task.

k) The presentation of the task candidates is not limited to screen displays and may also be accomplished by speech for example.

l) The number of task candidates that are presented does not have to be fixed.

m) Some of the task candidates may be displayed even after the first predetermined time has elapsed.

n) The task candidates may be presented such that they scroll over the display.

o) The communication between remote control and television set is not limited to infrared light, and it is also possible to use the Bluetooth standard, for example.

Third Embodiment

Configuration of Digital Television System

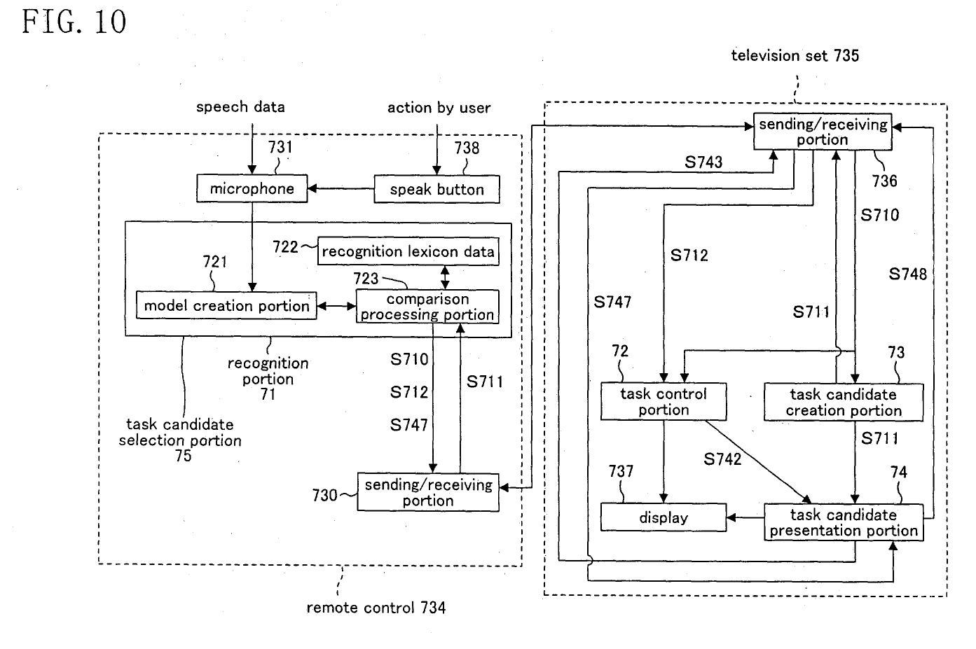

FIG. 10 shows the overall configuration of a digital television system in accordance with a third embodiment. This system is provided with a digital television set 735 and a remote control 734. The digital television set 735 includes a sending/receiving portion 736, a task control portion 72, a task candidate creation portion 73, a task candidate presentation portion 74, and a display 737. The remote control 734 includes a microphone 731, a speak button 738, a recognition portion 71 (task candidate selection portion 75), and a sending/receive portion 730. The recognition portion 71 (task candidate selection portion 75) includes a model creation portion 721, recognition lexicon data 722, and a comparison processing portion 723.

The microphone 731 receives speech data from the user while the speak button 738 is pressed, and sends them to the model creation portion 721.

The model creation portion 721 converts the speech data that have been sent by the microphone 731 into characteristic quantities and stores them as a model.

The comparison processing portion 723 compares the recognition lexicon data 722 with the model stored by the model creation portion 721, and creates a recognition result S710, which it sends to the infrared light sending portion 730.

The sending/receiving portion 730 sends the recognition result S710 to the sending/receiving portion 736.

The sending/receiving portion 736 sends the recognition result S710 sent by the sending/receiving portion 730 to the task control portion 72 and the task candidate creation portion 73.

Based on the recognition result S710 sent by the sending/receiving portion 736, the task control portion 72 switches the screen of the display 737 (first task).

Based on the recognition result S710 that has been sent by the sending/receiving portion 736, the task candidate creation portion 73 creates task candidates S711 and sends those task candidates S711 to the task candidate presentation portion 74 and the sending/receiving portion 736.

The task candidate presentation portion 74 presents the task candidates S711 created by the task candidate creation portion 73 on the display 737, and sends a trigger signal S743 to the sending/receiving portion 736. Furthermore, the task candidate presentation portion 74 sends a switching signal S748 to the sending/receiving portion 736.

Until the sending/receiving portion 736 receives the next switching signal S748, no selection information S712 is sent to the task candidate creation portion 73, but received selection information S712 is sent to the task control portion 72. The sending/receiving portion 736 sends the received trigger signal S743 and the task candidates S711 to the sending/receiving portion 730. The sending/receiving portion 730 sends the received trigger signal S743 and the task candidates S711 to the comparison processing portion 723.

If the model creation portion 721 has received the speech data before a first predetermined time has elapsed after the comparison processing portion 723 has received the trigger signal S743, then the recognition portion 71, which serves as the task candidate selection portion 75, performs a recognition process in the comparison processing portion 723 while restricting the recognition lexicon data 722 to the task candidates S711, and outputs the recognition result as the selection information S712.

The sending/receiving portion 730 receives the selection information S712 and sends the selection information S712 to the sending/receiving portion 736.

The sending/receiving portion 736 sends the received selection information S712 to the task control portion 72.

The task control portion 72 receives the selection information S712 and sends a presentation-stop signal S742 to the task candidate presentation portion 74. Furthermore, the task control portion 72 switches the screen of the display 737 based on the selection information S712 that has been sent by the sending/receiving portion 736 (second task).

The task candidate presentation portion 74 receives the presentation-stop signal 742 sent by the task control portion 72, stops the presentation of the task candidates S711 on the display 737 (first timing), and sends a switching signal S748 to the sending/receiving portion 736.

If the model creation portion 721 does not receive speech data before a first predetermined time has elapsed after the comparison processing portion 723 has received the trigger signal S743, then the recognition portion 71, which serves as the task candidate selection portion 75, sends a presentation-stop signal S747 to the sending/receiving portion 730.

The sending/receiving portion 730 sends the received presentation-stop signal S747 to the sending/receiving portion 736.

The sending/receiving portion 736 sends the received presentation-stop signal S747 to the task candidate presentation portion 74.

The task candidate presentation portion 74 receives the presentation-stop signal S747 and stops the presentation of the task candidates S711 on the display 737 (second timing). Furthermore, the task candidate presentation portion 74 receives the presentation-stop signal S747 and sends a switching signal S748 to the sending/receiving portion 736.

Until receiving the next switching signal S748, the sending/receiving portion 736 sends received recognition results S710 to the task control portion 72 and the task candidate creation portion 73.

Operation of Digital Television System

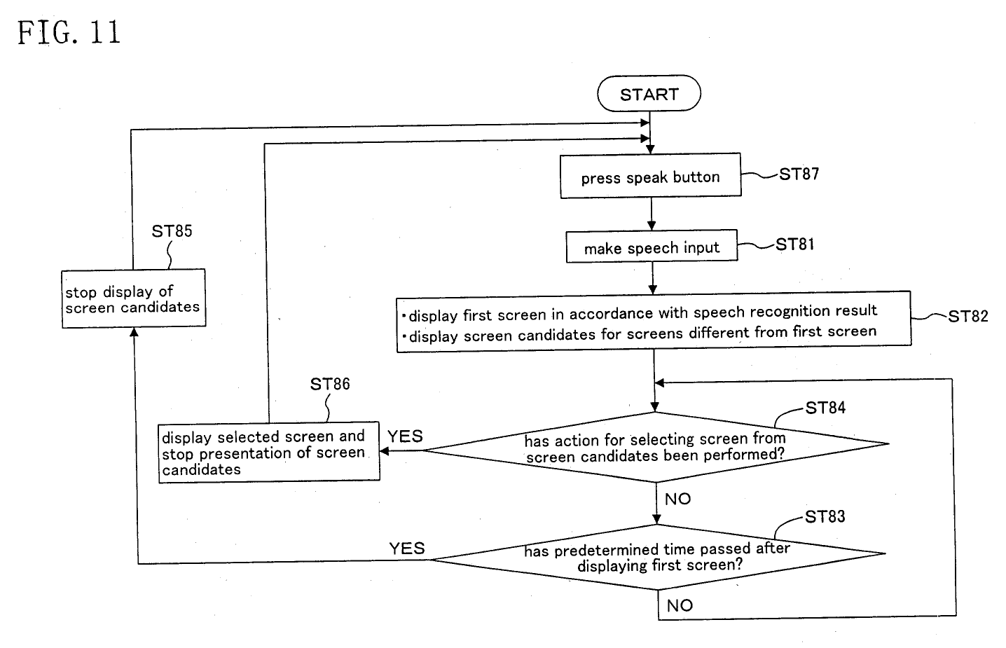

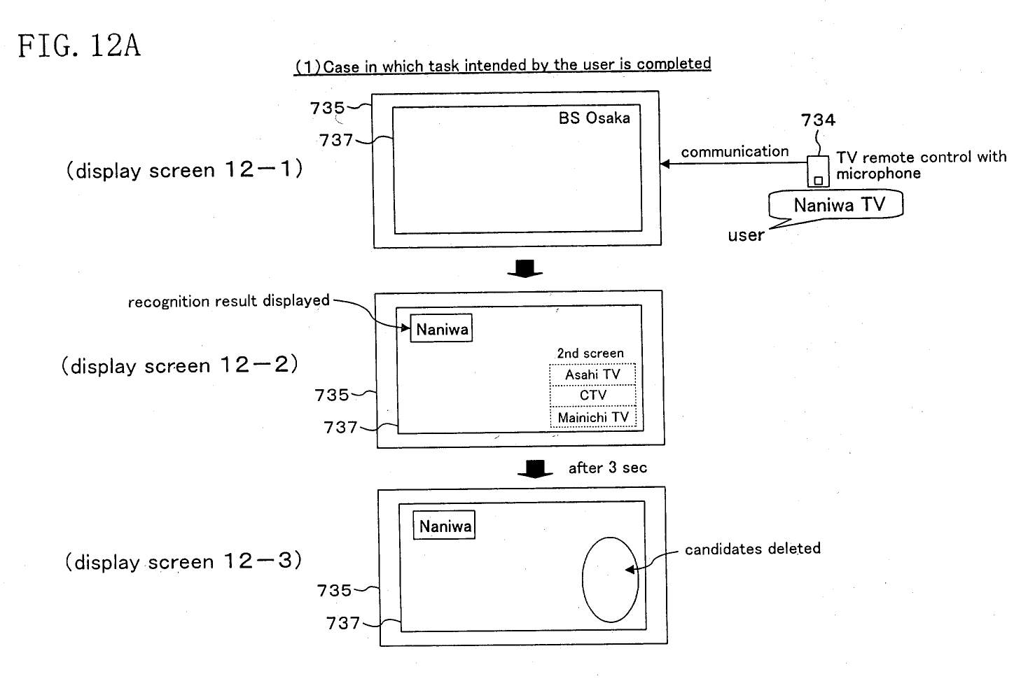

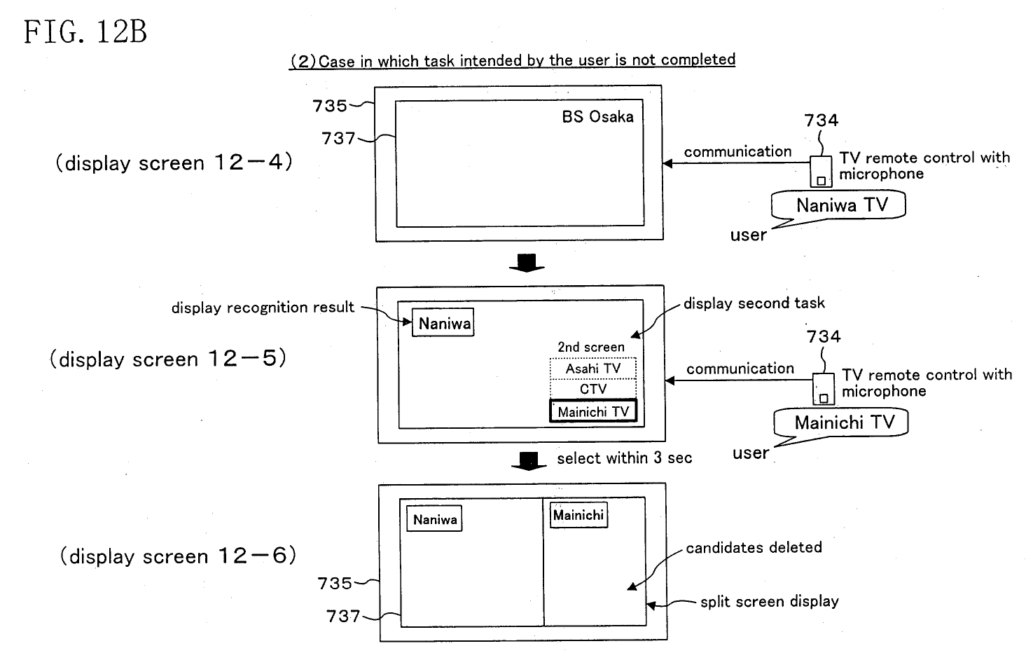

The following is an explanation of the operation of the system configured as described above. Here, an example is described with reference to FIG. 11 and FIGS. 12A and 12B, in which a television program is operated by speech.

(1) Case in Which the Screen Intended by the User is Displayed

First, the program of the television station “BS Osaka” is shown on the display 737 (see display screen 12-1 in FIG. 12A).

[Step ST87]

The user presses the speak button 738 in order to make a speech input.

[Step ST81]

While pressing down the speak button 738, the user enters the speech data “Naniwa TV” into the microphone 731 of the remote control 734 (display screen 12-1 in FIG. 12A). The entered speech data are sent to the recognition portion 71. The recognition portion 71 outputs, as the recognition result S710, “Naniwa TV,” which is the best match between the information concerning the speech data and the recognition lexicon data 722, and sends the recognition result S710 via the sending/receiving portion 730 to the sending/receiving portion 736 of the television set 735. The sending/receiving portion 736 sends the received recognition result S710 “Naniwa TV” to the task control portion 72 and the task candidate creation portion 73. Based on the recognition result S710 “Naniwa TV,” the task candidate creation portion 73 creates the task candidates S711 “Asahi TV,” “CTV” and “Mainichi TV,” which are related to the same genre “broadcasting station (channel).” The task candidate creation portion 73 sends the task candidates S711 to the task candidate presentation portion 74 and the sending/receiving portion 736.

[Step ST82]

Based on the recognition result S710 “Naniwa TV,” the task control portion 72 displays the program of the television station Naniwa TV, which is the first screen, on the display 737 (first task). The candidate presentation portion 74 displays on the display 737 “Asahi TV,” “CTV” and “Mainichi TV,” which are the screen candidates for screens different from the first screen (see display screen 12-2 in FIG. 12A). At the same time as the screen candidates are displayed, the task candidate presentation portion 74 sends to the sending/receiving portion 736 a trigger signal S743. The sending/receiving portion 736 sends the received trigger signal S743 and the task candidates S711 to the sending/receiving portion 730. The sending/receiving portion 730 sends the received trigger signal S743 and the task candidates S711 to the comparison processing portion 723. The task candidate presentation portion 74 sends a switching signal S748 to the sending/receiving portion 736. Until receiving the next switching signal S748, the sending/receiving portion 736 sends received selection information S712 to the task control portion 72, but does not send received selection information S712 to the task candidate creation portion 73. If the sending/receiving portion 736 has received the next switching signal S748, it sends the received recognition result S710 to the task control portion 72 and the task candidate creation portion 73.

[Steps ST84 and ST83]

If for a first predetermined time after the recognition portion 71, which serves as the candidate selection portion 75, has received the trigger signal S443, the user does not press the speak button 738 to enter speech data and express the intention to select a screen candidate, then the candidate selection portion 75 sends a presentation-stop signal S747 to the sending/receiving portion 730. The sending/receiving portion 730 sends the received presentation-stop signal S747 to the sending/receiving portion 736. The sending/receiving portion 736 sends the received presentation-stop signal S747 to the task candidate presentation portion 74. The task candidate presentation portion 74 receives the presentation-stop signal S747 and stops the presentation of the screen candidates on the display 737 (display screen 12-3 of FIG. 12A). The task candidate presentation portion 74 receives the presentation-stop signal S747 and sends a switching signal S748 to the sending/receiving portion 736.

(2) Case in Which the Display of the Screen Intended by the User is Not Completed

First, the program of the television station “BS Osaka” is shown on the display 737 (see display screen 12-4 in FIG. 12B).

[Step ST87]

The user presses the speak button 738 in order to make a speech input.

[Step ST81]

While pressing down the speak button 738, the user enters the speech data “Naniwa TV” into the microphone 731 of the remote control 734 (display screen 12-4 in FIG. 12B). The entered speech data are sent to the recognition portion 71. The recognition portion 71 outputs, as the recognition result S710, “Naniwa TV,” which is the best match between the information concerning the speech data and the recognition lexicon data 722, and sends the recognition result S710 via the sending/receiving portion 730 to the sending/receiving portion 736 of the television set 735. The sending/receiving portion 736 sends the received recognition result S710 “Naniwa TV” to the task control portion 72 and the task candidate creation portion 73. Based on the recognition result S710 “Naniwa TV,” the task candidate creation portion 73 creates the task candidates S711 “Asahi TV,” “CTV” and “Mainichi TV,” which are related to the same genre “broadcasting station (channel).” The task candidate creation portion 73 sends the task candidates S711 “Asahi TV,” “CTV” and “Mainichi TV,” to the task candidate presentation portion 74 and the sending/receiving portion 736.

[Step ST82]

Based on the recognition result S710 “Naniwa TV,” the task control portion 72 displays the program of the television station Naniwa TV, which is the first screen, on the display 737 (first task). The candidate presentation portion 74 displays on the display 737 “Asahi TV,” “CTV” and “Mainichi TV,” which are the screen candidates for screens different from the first screen (see display screen 12-5 in FIG. 12B). At the same time as the screen candidates are displayed, the task candidate presentation portion 74 sends to the sending/receiving portion 736 a trigger signal S743. Furthermore, the task candidate presentation portion 74 sends a switching signal S748 to the sending/receiving portion 736. The sending/receiving portion 736 makes arrangements to the effect that the next received selection information S712 is sent to the task control portion 72, but is not sent to the task candidate creation portion 73. The sending/receiving portion 736 sends the received trigger signal S743 and the task candidates S711 to the sending/receiving portion 730. The sending/receiving portion 730 sends the trigger signal S743 and the task candidates S711 to the recognition portion 71, which serves as the task candidate selection portion 75.

[Steps ST84 and ST83]

Within a first predetermined time after the candidate selection portion 75 has received the trigger signal S443, the user presses the speak button 738 to enter the speech data “Mainichi TV” using the microphone 731. The microphone 731 sends the speech data to the model creation portion 721. The model creation portion 721 converts the speech data “Mainichi TV” into characteristic quantities and stores them. Restricting the lexicon to “Asahi TV,” “CTV” and “Mainichi TV,” which are the received task candidates S711, the comparison processing portion 723 performs keyword spotting using the characteristic quantities stored by the model creation portion 271 and the recognition lexicon data 722, and creates “Mainichi TV” as the selection information S712 (recognition result S710). The comparison processing portion 723 sends the selection information S712 to the sending/receiving portion 730. The sending/receiving portion 730 sends the selection information S711 to the sending/receiving portion 736. The sending/receiving portion 736 sends the received selection information S711 to the task control portion 72.

[Step ST86]

Based on the selection information S712 sent by the sending/receiving portion 736, the task control portion 72 changes the screen of the display 737, divides the screen into two portions, and additionally displays the program of Mainichi TV (second task). As shown in the display screen 12-6 of FIG. 12B, the display of the “program of Naniwa TV” is corrected, but instead of displaying the “program of Mainichi TV” alone, a plurality of programs, namely the “program of Naniwa TV” and “the program of Mainichi TV” are displayed simultaneously in accordance with the recognition result. After receiving the selection information S712, the task control portion 72 sends a presentation-stop signal S742 to the candidate presentation portion 74. The candidate presentation portion 74 receives the presentation-stop signal S742 and stops the display of the task candidates S711 that were shown on the display 737 (display screen 12-6 in FIG. 12B). The task candidate presentation portion 74 receives the presentation-stop signal S742 and sends a switching signal S748 to the sending/receiving portion 736. The sending/receiving portion 736 makes arrangements to the effect that the next received recognition result S710 is sent to the task control portion 72 and the task candidate creation portion 73.

Effects

With the third embodiment of the present invention as explained above, the task candidates S711 created by the candidate creation portion 43 are presented and selected by the user at whichever is the faster timing of a first timing with which the second task is executed and a second timing at which a first predetermined time after presenting the task candidates S711 has elapsed, so that the user does not need to perform again from the beginning the procedure for executing the task intended by the user. Consequently, usage becomes more convenient and less troublesome for the user.

Moreover, the candidate presentation portion 74 automatically stops the presentation of the task candidates S711 if the user shows no intent of selecting a task candidate even after the first predetermined time has passed, so that if the first task that has been executed is the task intended by the user, the user does not need to stop the presentation of the task candidates S711. Consequently, usage becomes more convenient and less troublesome for the user.

Furthermore, the task control portion 72 automatically executes the first task based on the recognition result S710 that has been output by the recognition portion 71, so that if the first task that is executed is the task that was intended by the user, then the user does not have to select a task candidate S711. Consequently, usage becomes more convenient and less troublesome for the user,

Furthermore, the candidate presentation portion 74 automatically presents the task candidates S711, so that if the first task that is executed is not the task intended by the user, the user does not have to perform an operation in order to present the task candidates S711. Consequently, usage becomes more convenient and less troublesome for the user.

Moreover, the task candidates S711 include candidates of tasks that reflect a semantic relation to the first task, which is based on the recognition result 710 output by the recognition portion 71, so that the task intended by the user can be selected immediately. Consequently, usage is convenient for the user.

Furthermore, the task control portion 72 can simultaneously perform a plurality of task controls (such as displaying the program of Mainichi TV while displaying the program of Naniwa TV), based on the recognition result S710. Consequently, usage is convenient for the user.

It should be noted that the present embodiment is not limited to the above description, and the various adaptations listed below are also possible, for example.

a) The present embodiment may be further provided with a cancel function.

b) The recognition portion 71 may perform the recognition using linguistic knowledge, grammatical knowledge or semantic knowledge.

c) A task of realizing the cancel function may be included as one of the task candidates.

d) As task candidates S711, tasks may be included that are related to recognition data that are good matches when comparing information reflecting the entered task content to be recognized with the recognition lexicon data 722.

e) An example has been given, in which task candidates of the same genre (for example “Asahi TV,” “CTV” and “Mainichi TV” for “Naniwa TV”) are given as the task candidates S711 in consideration of the semantic relation to the task based on the recognition result S710 that has been output by the recognition portion 71, but the semantic relation is not limited to genres, and it is also possible to include associated task candidates (for example Tanaka” and “World Cup” for “soccer” or “color, “black” and “apple” for “red”), task candidates that take into account the personal taste of the user (for example, for “my favorite programs,” the task candidates “soccer,” “sports digest” and “today's news,” which are programs that the user often views, or for “things to do now,” the task candidates “mail” and “prepare bath,” which are task candidates that take into account the user and the time of day), or task candidates related to the operated device (for example, “stop,” “skip” and “rewind” for “play” in the operation of a video player).

f) The presentation of the task candidates S711 is not limited to screen displays and may be accomplished by speech.

g) The number of task candidates that are presented does not have to be fixed.

h) Some of the task candidates may be displayed even after the first predetermined time has elapsed.

i) The task candidates may be presented such that they scroll over the display.

j) The communication between remote control and television set is not limited to infrared light, and it is also possible to use Bluetooth Standard or the like.

Fourth Embodiment

Configuration of Video System

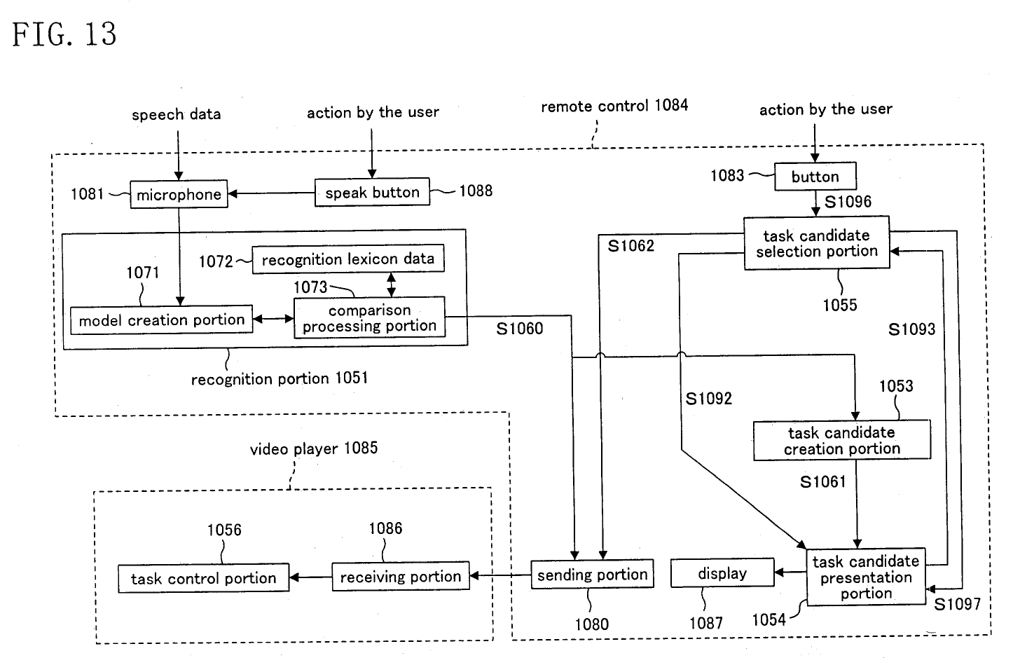

FIG. 13 is a block diagram showing the overall configuration of a video system in accordance with a fourth embodiment. The system shown in FIG. 13 includes a video player 1085 and a remote control 1084. The video player 1085 includes a receiving portion 1086 and a task control portion 1056. The remote control 1084 includes a microphone 1081, a speak button 1088, a recognition portion 1051, a task candidate creation portion 1053, a task candidate presentation portion 1054, a display 1087, a button 1083, a task candidate selection portion 1055, and a sending portion 1080. The recognition portion 1051 includes a model creation portion 1071, recognition lexicon data 1072, and a comparison processing portion 1073.

The microphone 1081 receives speech data from the user while the speak button 1088 is pressed, and sends them to the model creation portion 1071.

The model creation portion 1071 converts the speech data that have been sent by the microphone 1081 into characteristic quantities, creates a model and stores that model.

The comparison processing portion 1073 compares the recognition lexicon data 1072 with the model stored by the model creation portion 1071, creates a recognition result S1060, and sends this recognition result S1060 to the sending portion 1080 and the task candidate creation portion 1053.

The sending portion 1080 sends the received recognition result S1060 to the receiving portion 1086.

The receiving portion 1086 sends the received recognition result S1060 to the task control portion 1056.

Based on the received recognition result S1060, the task control portion 1056 operates the video player (first task).

Based on the received recognition result S1060, the task candidate creation portion 1053 creates task candidates S1061 and sends those task candidates S1061 to the task candidate presentation portion 1054.

The task candidate presentation portion 1054 presents the received task candidates S1061 on the display 1087, and sends a trigger signal S1093 to the task candidate selection portion 1055.

If the task candidate selection portion 1055 does not receive an operation signal S1096 produced with the button 1083 after the trigger signal S1093 has been received and before a first predetermined time has elapsed, then a presentation-stop signal S1092 is sent to the candidate presentation portion 1054.

The task candidate presentation portion 1054 receives the presentation-stop signal S1092 and stops the display of the task candidates S1061 that are presented on the display 1087 (second timing).

If the task candidate selection portion 1055 has received an operation signal S1096 produced by the button 1083 after the trigger signal S1093 sent by the task candidate presentation portion 1054 has been received and before a first predetermined time has elapsed, then selection information S1062 is produced based on the operation signal S1096, and this selection information S1062 is sent to the sending portion 1080. Moreover, the task candidate selection portion 1055 receives the action signal S1096 and sends a presentation-stop signal S1092 to the task candidate presentation portion 1054.

The sending portion 1080 sends the received selection information S1062 to the receiving portion 1086.

The receiving portion 1086 sends the received selection information S1062 to the task control portion 1056.

The task control portion 1056 performs the operation of the video player based on the received selection information S1062 (second task).

The task candidate presentation portion 1054 receives the presentation-stop signal S1092 and stops the presentation of the task candidates S1061 that are presented on the display 1087 (first timing).

Operation of Video System

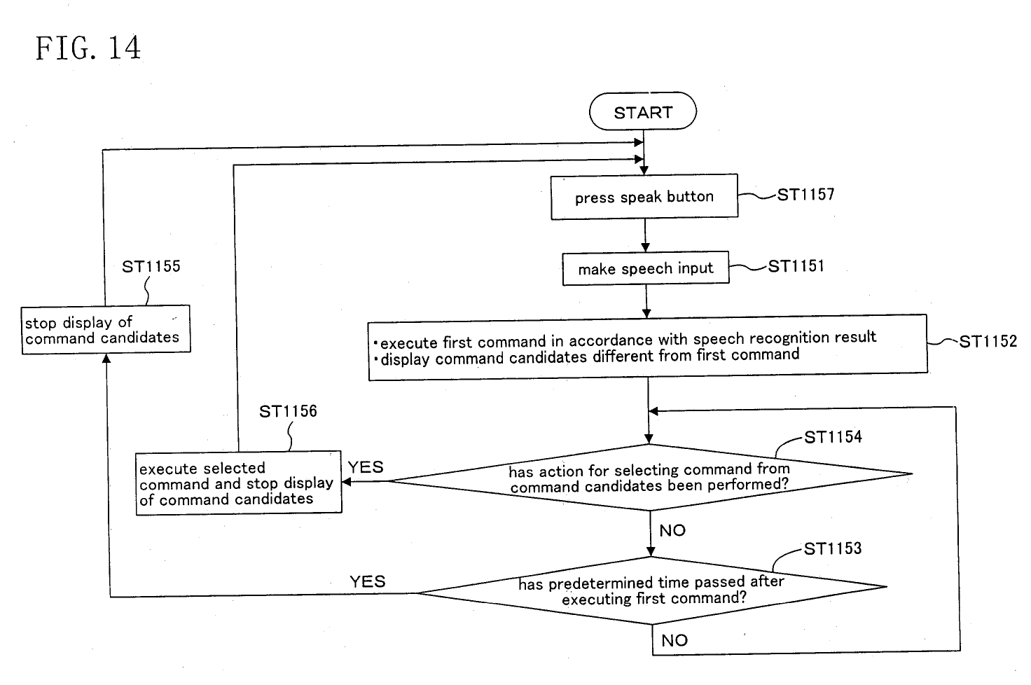

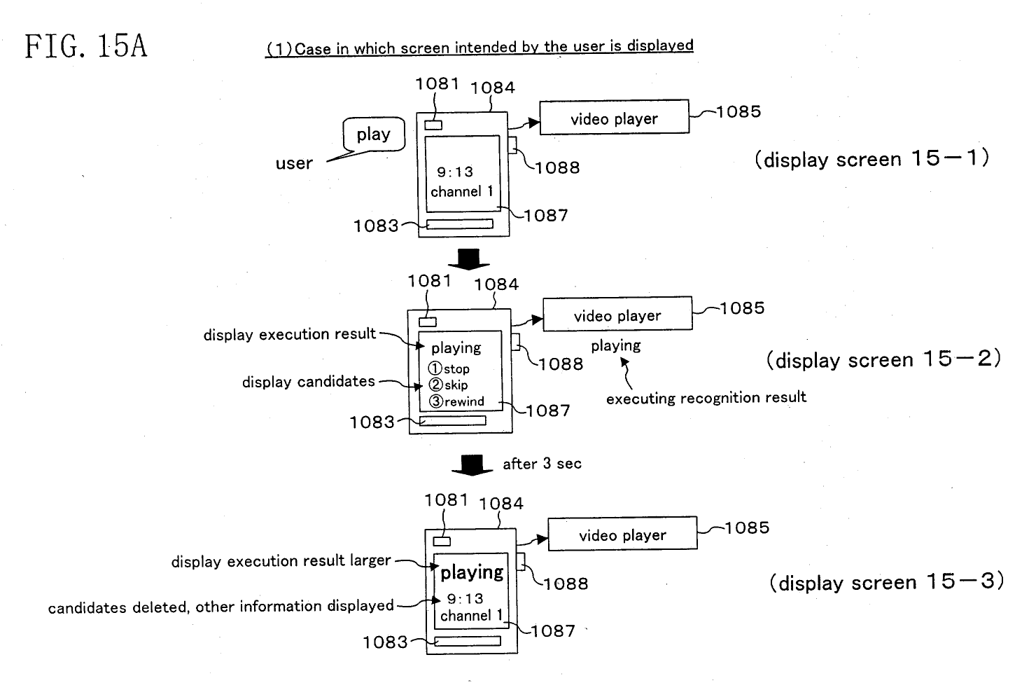

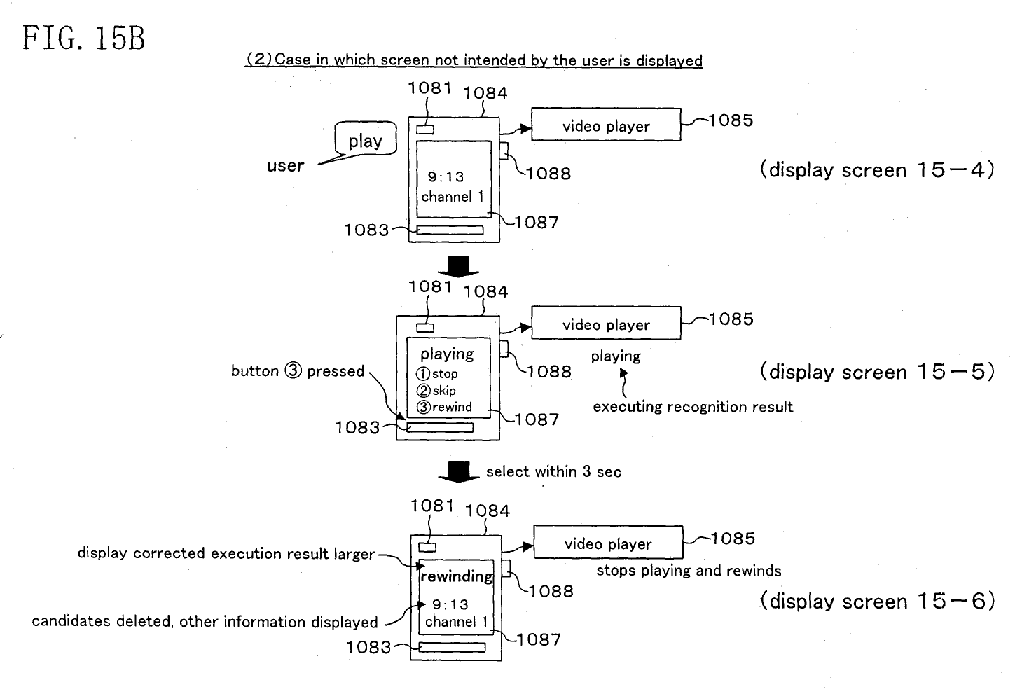

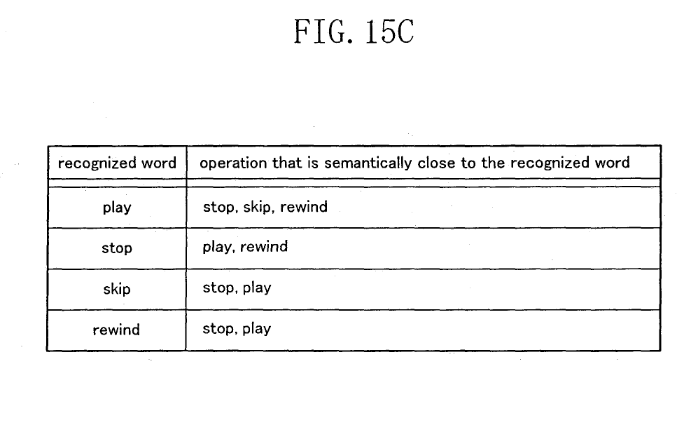

The following is an explanation of the system configured as described above. Referring to FIG. 14 and FIGS. 15A to 15C, the following describes an example, in which a video player is operated by speech and button operation.

(1) Case in Which the Task Intended by the User is Executed

[Step ST1157]

The user presses the speak button 1088 in order to make a speech input. [Step ST1151]

While pressing down the speak button 1088, the user enters the speech data “play” into the microphone 1081 of the remote control (display screen 15-1 in FIG. 1SA). The entered speech data are sent to the recognition portion 1051. The recognition portion 1051 outputs as the recognition result S1060 “play,” which is the best match between the information concerning the speech data and the recognition lexicon data 1072, and sends the recognition result S1060 via the sending portion 1080 and the receiving portion 1086 to the task control portion 1056 of the video player 1085.

[Step ST1152]

Based on the received recognition result S1060 “play,” the task control portion 1056 performs a play operation on the video player (first task). Furthermore, the recognition portion 1051 sends a recognition result S1060 to the task candidate creation portion 1053. The task candidate creation portion 1053 includes a table as shown in FIG. 15C. The table shown in FIG. 15C associates recognition terms with operations that are semantically close to those recognition terms. Here, “operations that are semantically close” means operations that, based on the operation indicated by the recognition term, have a high probability of being functionally used. That is to say, in the table shown in FIG. 15C, four association regions have been set based on the device operation (regions of association by function). With the four association regions, the four recognition terms (reference terms) “play,” “stop,” “skip” and “rewind” are associated with one another. These association regions include those words that indicate operations that have a high possibility of being functionally used based on the operation indicated by the corresponding recognition term. The task candidate creation portion 1053 references the table shown in FIG. 15C and creates, as task candidates S1061, “\mathring{1} stop,” “\mathring{2} skip,” and “\mathring{3} rewind,” which, based on the received recognition result S1060 “play” have a high probability of being functionally used, and sends those task candidates to the task candidate presentation portion 1054. The task candidate presentation portion 1054 displays the received task candidates S1061 “\mathring{1} stop,” “\mathring{2} skip,” and “\mathring{3} rewind” on the display 1087 (display screen 15-2 in FIG. 15A). The task candidate presentation portion 1054 receives the task candidates S1061 and sends a trigger S1093 to the task candidate selection portion 1055.

[Steps ST1154 and ST1153]

If for a first predetermined time (here: three seconds) after the task candidate selection portion 1055 has received the trigger signal S1093, the user does not press the button 1083 to express the intention to select a task candidate S1061, then the task candidate selection portion 1055 does not produce selection information S1062 until the next trigger signal S1093 is received. The task candidate selection portion 1055 sends a presentation-stop signal S1092 to the task candidate presentation portion 1054.

[Step ST1155]

The task candidate presentation portion 1054 receives the presentation-stop signal S1092 and stops the display of the task candidates 1061 on the display 437 (display screen 15-3 in FIG. 15A).

(2) Case in Which the Task Intended by the User is Not Executed

The user presses the speak button 1088 in order to make a speech input.

[Step ST1151]

While pressing down the speak button 1088, the user enters the speech data “play” into the microphone 1081 of the remote control (display screen 15-4 in FIG. 15B). The entered speech data are sent to the recognition portion 1051. The recognition portion 1051 outputs the recognition result S1060 “play,” which is the best match between the information concerning the speech data and the recognition lexicon data 1072, and sends the recognition result S1060 via the sending portion 1080 and the receiving portion 1086 to the task control portion 1056 of the video player 1085.

[Step ST1152]

Based on the received recognition result S1060 “play,” the task control portion 1056 performs a play operation on the video player (first task). The recognition portion 1051 sends the recognition result S1060 to the task candidate creation portion 1053. The task candidate creation portion 1053 creates, as task candidates S1061, “\mathring{1} stop,” “\mathring{2} skip,” and “\mathring{3} rewind,” which, based on the received recognition result S1060 “play” have a high probability of being functionally used, and sends those task candidates S1061 to the task candidate presentation portion 1054. The task candidate presentation portion 1054 displays the received task candidates S1061 “\mathring{1} stop,” “\mathring{2} skip,” and “\mathring{3} rewind” on the display 1087 (display screen 15-2 in FIG. 15B). The task candidate presentation portion 1054 receives the task candidates S1061 and sends a trigger signal S1093 to the task candidate selection portion 1055.

[Steps ST1154 and ST1153]

Within a first predetermined time (here: three seconds) after the task candidate selection portion 1055 has received the trigger signal S1093, the user presses the button 1083 and selects a task candidate S1061. Here, as shown in display screen 15-5 of FIG. 15B, the button □ is pressed and “\mathring{3} rewind” is selected. Based on the operation signal S1096 produced with the button 1083 the task candidate selection portion 1055 produces the selection information S1062 “rewind” and sends it to the sending portion 1080. The sending portion 1080 sends the received selection information S1062 via the receiving portion 1086 to the task control portion 1056.

[Step ST1156]

Based on the received selection information S1062, the task control portion 1056 executes the rewinding of the video player. After producing the selection information S1062, the task candidate selection portion 1055 sends a presentation-stop signal S1092 to the task candidate presentation portion 1054. The task candidate presentation portion 1054 receives the presentation-stop signal S1092 and stops the display of the task candidates S1061 that are shown on the display 1087 (display screen 15-6 in FIG. 15B).

Effects

With the fourth embodiment as explained above, the task candidates S1061 created by the candidate creation portion 1053 are presented and selected by the user at whichever is the faster timing of a first timing with which the second task is executed and a second timing at which a first predetermined time after presenting the task candidates S1061 has elapsed, so that the user does not need to perform again from the beginning the procedure for executing the task intended by the user. Consequently, usage becomes more convenient and less troublesome for the user.

Moreover, the task candidate presentation portion 1054 automatically stops the presentation of the task candidates S1061 if the user shows no intent of selecting a task candidate even after the first predetermined time has passed, so that if the first task that has been executed is the task intended by the user, the user does not need to stop the presentation of the task candidates S1061. Consequently, usage becomes more convenient and less troublesome for the user.

Furthermore, the task control portion 1056 automatically executes the first task based on the recognition result S1060 that has been output by the recognition portion 1051, so that if the task that is executed is the task that was intended by the user, then the user does not have to select a task candidate. Consequently, usage becomes more convenient and less troublesome for the user.

Furthermore, the task candidate presentation portion 1054 automatically presents the task candidates S1061, so that if the first task that is executed is not the task intended by the user, the user does not have to perform an operation in order to present the task candidates. Consequently, usage becomes more convenient and less troublesome for the user.

Moreover, the task candidates S1061 include candidates of tasks that reflect a semantic relation to the first task, based on the recognition result S1060 output by the recognition portion 1051, so that the task intended by the user can be selected immediately. Consequently, usage is convenient for the user.

It should be noted that the present embodiment is not limited to the above description, and the various adaptations listed below are also possible, for example.

a) It is possible to further provide the present invention with a cancel function.

b) The recognition portion 1051 may perform the recognition using linguistic knowledge, grammatical knowledge or semantic knowledge, and it may perform such processes as keyword extraction.

c) The recognition lexicon data 1072 are not limited to words and may also be phrases or sentences.

d) One task or one task candidate may be determined using a plurality of recognition results.

e) There may be only one task candidate 411.

f) A task of realizing the cancel function may be included as one of the task candidates.

g) As task candidates S1061, tasks may be included that are related to recognition data that are good matches when comparing information reflecting the entered task content to be recognized with the recognition lexicon data 1072.

h) Recognition lexicon data 1072 may be added as necessary.

i) The presentation of the task candidates S1061 is not limited to screen displays and may be accomplished by speech.

j) The number of task candidates S1061 that are presented does not have to be fixed.

k) Some of the task candidates S1061 may be displayed even after the first predetermined time has elapsed.

l) The task candidates S1061 may be presented such that they scroll over the display 1087.

m) The communication between remote control and video player may also be performed using infrared light or Bluetooth Standard or the like.

Fifth Embodiment

Configuration of Car Navigation System

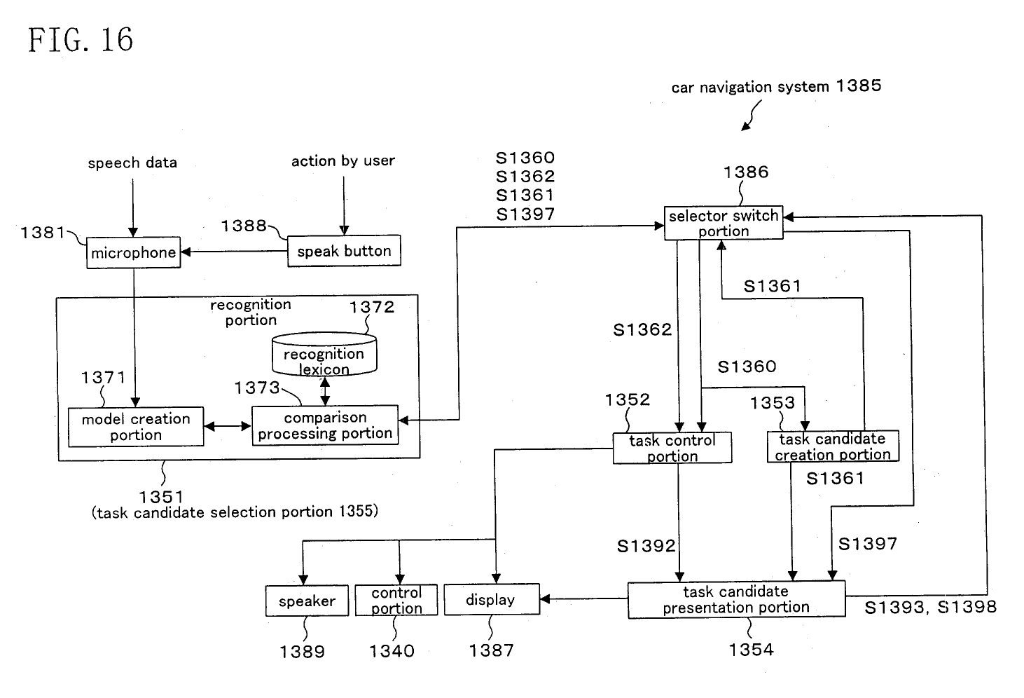

FIG. 16 is a block diagram showing the overall configuration of a car navigation system in accordance with a fifth embodiment. The car navigation system 1385 shown in FIG. 16 is provided with a microphone 1381, a speak button 1388, a recognition portion 1351 (task candidate selection portion 1355), a selector switch portion 1386, a task candidate creation portion 1353, a task candidate presentation portion 1354, a display 1387, a speaker 1389, a control portion 1340, and a task control portion 1352. The recognition portion 1351 includes a model creation portion 1371, recognition lexicon data 1372, and a comparison processing portion 1373.

The microphone 1381 receives speech data from the user while the speak button 1388 is pressed, and sends them to the model creation portion 1371.

The model creation portion 1371 converts the speech data that have been sent by the microphone 1381 into characteristic quantities, creates a model, and stores that model.

The comparison processing portion 1373 compares the recognition lexicon data 1372 with the model stored by the model creation portion 1371, and creates a recognition result S1360, which it sends to the sending portion 1080 and the selector switch portion 1386.

The selector switch portion 1386 sends the received recognition result S1360 to the task control portion 1352 and the task candidate creation portion 1353.

Based on the recognition result S1360 sent by the selector switch portion 1386, the task control portion 1352 switches the screen of the display 1387, puts out a spoken announcement from the speaker 1389, and sets a destination with the control portion 1340 (first task).

Based on the recognition result S1360 sent by the selector switch portion 1386, the task candidate creation portion 1353 creates task candidates S1361 and sends those task candidates S1361 to the task candidate presentation portion 1354 and the selector switch portion 1386.

The task candidate presentation portion 1354 presents the task candidates S1361 created by the task candidate creation portion 1353 on the display 1387, and sends a trigger signal S1393 to the selector switch portion 1386. Furthermore, the task candidate presentation portion 1354 sends a switching signal S1398 to the selector switch portion 1386.

Until receiving the next switching signal S1398, the selector switch portion 1386 sends out no selection information S1362 to the task candidate creation portion 1353, but sends out received selection information S1362 to the task control portion 1352. The selector switch portion 1386 sends the received trigger signal S1393 and the task candidates S1361 to the comparison processing portion 1373.

If the model creation portion 1371 receives speech data before a first predetermined time has passed after the comparison processing portion 1373 has received the trigger signal S1393, then the recognition portion 1351, which also serves as the task candidate selection portion 1355 performs a recognition process in the comparison processing portion 1373 while restricting the recognition lexicon data 1372 to the task candidates S1361, and outputs the recognition result as the selection information S1362.

The selector switch portion 1386 receives the selection information S1362 output by the comparison processing portion 1373 and sends the selection information S1362 to the task control portion 1352.

The task control portion 1352 receives the selection information S1362 and sends a presentation-stop signal S1392 to the task candidate presentation portion 1354. Furthermore, the task control portion 1352 switches the screen of the display 1387 based on the received selection information S1362, puts out a spoken announcement from the speaker 1389, and sets a destination with the control portion 1340 (second task).

The task candidate presentation portion 1354 receives the presentation-stop signal S1392 sent by the task control portion 1352, and stops the presentation of the task candidates S1361 on the display 1387 (first timing), and sends a switching signal S1398 to the selector switch portion 1386.

If the model creation portion 1371 does not receive speech data before a first predetermined time has elapsed after the comparison processing portion 1373 has received the trigger signal S1393, then the recognition portion 1351, which serves as the task candidate selection portion 1355, sends a presentation-stop signal S1397 to the selector switch portion 1386.

The selector switch portion 1386 sends the received presentation-stop signal S1397 to the task candidate presentation portion 1354.

The task candidate presentation portion 1354 receives the presentation-stop signal S1397 and stops the presentation of the task candidates S1361 that have been presented on the display 1387 (second timing). Furthermore, the task candidate presentation portion 1354 receives the presentation-stop signal S1397 and sends a switching signal S1398 to the selector switch portion 1386.

Until receiving the next switching signal S1398, the selector switch portion 1386 sends received recognition results S1360 to the task control portion 1352 and the task candidate creation portion 1353.

Operation of Car Navigation System

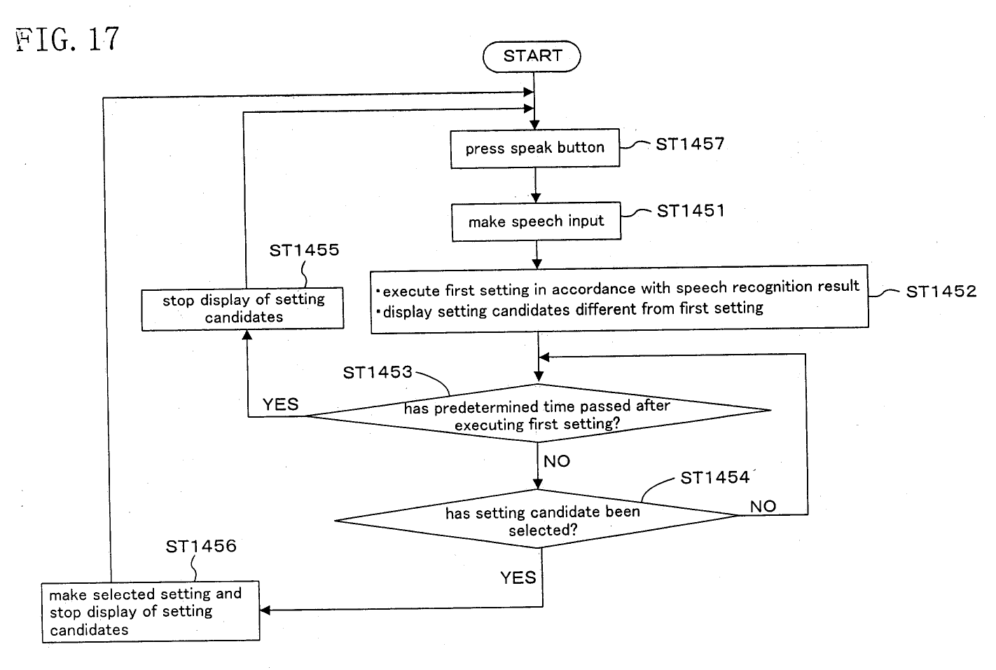

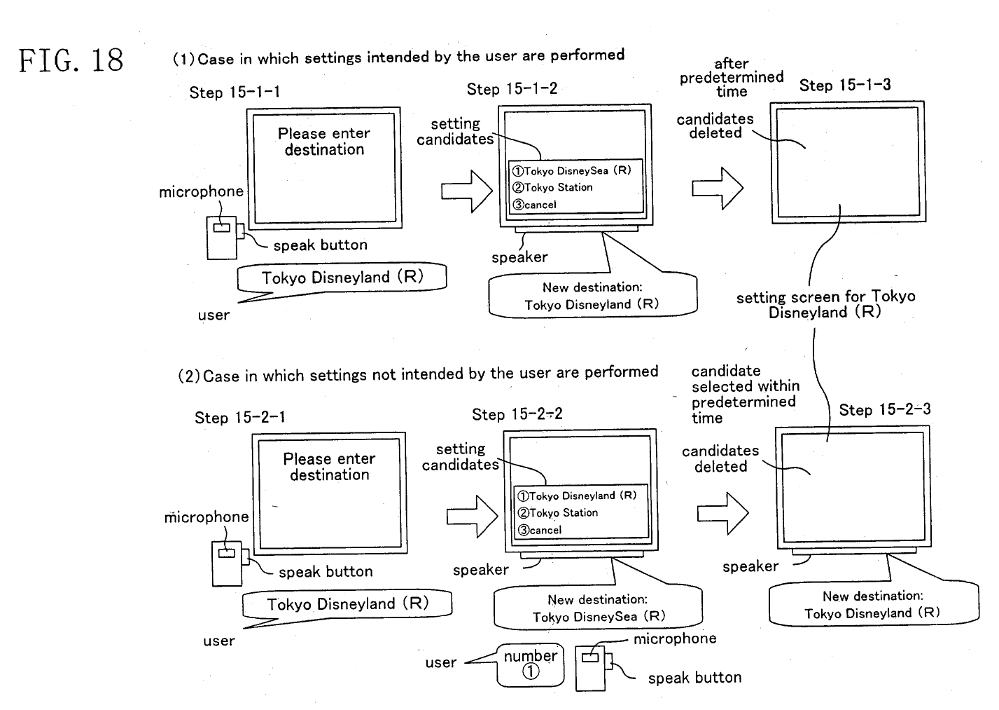

The following is an explanation of the operation of the car navigation system configured as described above. Referring to FIG. 17 and FIG. 18, the following describes an example, in which a car navigation system is operated by speech.

(1) Case in Which the Task Intended by the User is Executed

The message “Please enter destination” is shown on the display 1387 (Step 151-1 in FIG. 18).

[Step ST14571]

The user presses the speak button 1388 in order to enter a destination by speech.

[Step ST1451]

After pressing down the speak button 1388, the user enters the speech data “Tokyo Disneyland®” into the microphone 1381 (Step 15-1-1 in FIG. 18). The entered speech data are sent to the recognition portion 1351. The recognition portion 1351 outputs, as the recognition results S1360, “Tokyo Disneyland®,” “Tokyo DisneySea®” and “Tokyo Station,” which are the best matches between the information concerning the speech data and the recognition lexicon data 1372, and sends the recognition result S1360 to the selector switch portion 1386. Here, the recognition lexicon data 1372 include word lexicon data, and the comparison processing portion 1373 includes an acoustic model for each phoneme. The comparison processing portion 1373 creates the recognition results S1360 using the acoustic model for each phoneme and the word lexicon data of the recognition lexicon data 1372. The selector switch portion 1386 sends the received recognition result S1360 “Tokyo Disneyland®” to the task control portion 1352, and sends the received recognition results S1360 “Tokyo DisneySea®” and “Tokyo Station” to the task candidate creation portion 1353. Based on the recognition results S1360 “Tokyo DisneySea®” and “Tokyo Station” the task candidate creation portion 1353 creates the task candidates S1361 “\mathring{1} Tokyo DisneySea®” and “\mathring{2} Tokyo Station.” The task candidate creation portion 1353 also creates the task candidate S1361 “\mathring{3} cancel.” The task candidate creation portion 1353 sends the task candidates S1361 to the task candidate presentation portion 1354 and the selector switch portion 1386.

[Step ST1452]

Based on the received recognition result S1360 “Tokyo Disneyland®,” the task control portion 1352 displays a map of the surroundings of Tokyo Disneyland® on the display 1387, and the announcement “New destination: Tokyo Disneyland®” is played from the speaker 1389. Then, the control portion 1340 searches a route to the first setting, Tokyo Disneyland®, and sets this route (first task).

The task candidate presentation portion 1354 shows the task candidates S1361 “\mathring{1} Tokyo DisneySea®,” “\mathring{2} Tokyo Station” and “\mathring{3} cancel” on the display 1387 (Step 15-1-2 in FIG. 18). At the same time as the task candidates S1361 are displayed, the task candidate presentation portion 1354 sends a trigger signal S1393 to the selector switch portion 1386. The selector switch portion 1386 sends the received trigger signal S1393 and the task candidates S1361 to the comparison processing portion 1373. The task candidate presentation portion 1354 sends a switching signal S1398 to the selector switch portion 1386. Until receiving the next switching signal S1398, the selector switch portion 1386 sends received selection information S1362 to the task control portion 1352, but does not send received selection information S1362 to the task candidate creation portion 1353. After the selector switch portion 1386 has received the next switching signal S1398, it sends received recognition results S1360 to the task control portion 1352 and the task candidate creation portion 1353.

[Steps ST1454 and ST1453]

If for a first predetermined time after the recognition portion 1351, which also serves as the task candidate selection portion 1355, has received the trigger signal S1393, the user does not press the speak button 1388 to express the intention to select a task candidate, then the task candidate selection portion 1355 sends a presentation-stop signal S1397 to the selector switch portion 1386. The selector switch portion 1386 sends the received presentation-stop signal S1392 to the task candidate presentation portion 1354. The task candidate presentation portion 1354 receives the presentation-stop signal S1392 and stops the display of the task candidates on the display 1387 (Step 15-1-3 in FIG. 18). The task candidate display portion 1354 receives the presentation-stop signal S1392 and sends a switching signal S1398 to the selector switch portion 1386.

(2) Case in Which the Task Intended by the User is Not Executed

The message “Please enter destination” is shown on the display 1387 (Step 15-2-1 in FIG. 18).

[Step ST1457]

The user presses the speak button 1388 in order to enter a destination by speech.

[Step ST1451]

After pressing down the speak button 1388, the user enters the speech data “Tokyo Disneyland®” into the microphone 1381 (Step 15-2-1 in FIG. 18). The entered speech data are sent to the recognition portion 1351. The recognition portion 1351 outputs, as the recognition results S1360, “Tokyo DisneySea®,” “Tokyo Disneyland®” and “Tokyo Station,” which are the best matches between the information concerning the speech data and the recognition lexicon data 1372, and sends the recognition results S1360 to the selector switch portion 1386. The selector switch portion 1386 sends the received recognition result S1360 “Tokyo DisneySea®” to the task control portion 1352, and sends the received recognition results S1360 “Tokyo Disneyland®” and “Tokyo Station” to the task candidate creation portion 1353. Based on the recognition results S1360 “Tokyo Disneyland®” and “Tokyo Station,” the task candidate creation portion 1353 creates the task candidates S1361 “\mathring{1} Tokyo Disneyland®” and “\mathring{2} Tokyo Station.” The task candidate creation portion 1353 also creates the task candidate S1361 “\mathring{3} cancel.” Here, numbers (\mathring{1}, \mathring{2}, \mathring{3} etc.), for which speech recognition is easier than for “Tokyo Disneyland®” or “Tokyo Station,” are added. Furthermore, the numbers (\mathring{1}, \mathring{2}, \mathring{3} etc.), are registered in the recognition lexicon data 1372. The task candidate creation portion 1353 sends the task candidates S1361 to the task candidate presentation portion 1354 and the selector switch portion 1386.

[Step ST1452]

Based on the received recognition result S1360 “Tokyo DisneySea®,” the task control portion 1352 displays a map of the surroundings of Tokyo DisneySea® on the display 1387, and the announcement “New destination: Tokyo DisneySea®” is played from the speaker 1389. Then, the control portion 1340 searches a route to the first setting, Tokyo DisneySea®, and sets this route (first task).

The task candidate presentation portion 1354 shows the task candidates S1361 “\mathring{1} Tokyo Disneyland®,” “\mathring{2} Tokyo Station” and “\mathring{3} cancel” on the display 1387 (Step 15-2-2 in FIG. 18). At the same time as the task candidates S1361 are displayed, the task candidate presentation portion 1354 sends a trigger signal S1393 to the selector switch portion 1386. The selector switch portion 1386 sends the received trigger signal S1393 and the task candidates S1361 to the comparison processing portion 1373. The task candidate presentation portion 1354 sends a switching signal S1398 to the selector switch portion 1386. Until receiving the next switching signal S1398, the selector switch portion 1386 sends received selection information S1362 to the task control portion 1352, but does not send received selection information S1362 to the task candidate creation portion 1353. After the selector switch portion 1386 has received the next switching signal S1398, it sends received recognition results S1360 to the task control portion 1352 and the task candidate creation portion 1353.

[Steps ST1453 and ST1454]

Within the first predetermined time after the recognition portion 1351, which also serves as the task candidate selection portion 1355, has received the trigger signal S1393, the user presses the speak button 1388 and enters the speech data “number \mathring{1}.” The microphone 1381 sends the speech data to the model creation portion 1371. The model creation portion 1371 converts the speech data “number \mathring{1}” into characteristic quantities and stores them. Using the recognition lexicon data 1372 and the characteristic quantities stored by the model creation portion 1371, the comparison processing portion 1373 produces the recognition result S1360 “number \mathring{1},” and, based on the recognition result S1360 “number \mathring{1}” and the task candidate S1361 “\mathring{1} Tokyo Disneyland®,” it produces the selection information S1362 “\mathring{1} Tokyo Disneyland®.” The comparison processing portion 1373 sends the selection information S1362 to the selector switch portion 1386. The selector switch portion 1386 sends the received selection information S1362 to the task control portion 1352.

[Step ST1456]

Based on the received selection information S1362, the task control portion 1352 displays a map of the surroundings of Tokyo Disneyland® on the display 1340, and the announcement “New destination: Tokyo Disneyland®” is played from the speaker 1389. Then, the control portion 1340 searches a route to Tokyo Disneyland®, and sets this route (second task).

After receiving the selection information S1362, the task control portion 1352 sends a presentation-stop signal S1392 to the task candidate presentation portion 1354. The task candidate presentation portion 1354 receives the presentation-stop signal S1392 and stops the display of the task candidates S1361 on the display 1387 (Step 15-2-3 in FIG. 18). The task candidate display portion 1354 receives the presentation-stop signal S1392 and sends a switching signal S1398 to the selector switch portion 1386. The selector switch portion 1386 makes arrangements to the effect that the next received recognition result S1360 is sent to the task control portion 1352 and the task candidate creation portion 1353.

Effects

With the fifth embodiment as explained above, the task candidates S1361 created by the task candidate creation portion 1353 are presented and selected by the user at whichever is the faster timing of a first timing with which the second task is executed and a second timing at which a first predetermined time after presenting the task candidates S1361 has elapsed, so that the user does not need to perform again from the beginning the procedure for executing the task intended by the user. Consequently, usage becomes more convenient and less troublesome for the user.

Moreover, the task candidate presentation portion 1354 automatically stops the presentation of the task candidates S1361 if the user shows no intent of selecting a task candidate even after the first predetermined time has passed, so that if the first task that has been executed is the task intended by the user, the user does not need to stop the presentation of the task candidates S1361. Consequently, usage becomes more convenient and less troublesome for the user.

Furthermore, the task control portion 1352 automatically executes the first task based on the recognition result S1360 that has been output by the recognition portion 1351, so that if the first task that is executed is the task that was intended by the user, then the user does not have to select a task candidate. Consequently, usage becomes more convenient and less troublesome for the user.

Furthermore, the task candidate presentation portion 1354 automatically presents the task candidates S1361, so that if the first task that is executed is not the task intended by the user, the user does not have to perform an operation in order to present the task candidates. Consequently, usage becomes more convenient and less troublesome for the user.

Furthermore, the task candidates created by the task candidate creation portion 1353 include tasks related to the recognition data that are good matches when comparing information reflecting the entered task content to be recognized with the recognition lexicon data 1372, so that even when a misrecognition has occurred, it is possible to include the correctly recognized task among the task candidates S1361 and to correct the misrecognition with the user's selection. Consequently, usage becomes more convenient for the user.

Furthermore, the task control portion 1352 can perform a plurality of task controls base on the recognition result S1360 (such as displaying a map of the surroundings of Tokyo Disneyland® on the display 1387, playing the announcement “New destination: Tokyo Disneyland®” from the speaker 1389, and searching and setting the route to Tokyo Disneyland® in the control portion 1340). Consequently, usage becomes more convenient for the user.

Furthermore, the selection of the task candidates S1361 is performed after adding to the task candidates S1361 words (here, for example, numbers) whose recognition is easier than that of the recognition results S1360, so that erroneous selections do not occur. Consequently, usage becomes more convenient for the user.

Furthermore, since a cancel function is included as one of the task candidates S1361, it is possible to cancel and return to the original state instead of executing the desired task. Consequently, usage becomes more convenient for the user.

It should be noted that the present embodiment is not limited to the above description, and the various adaptations listed below are also possible, for example.

a) The recognition portion 1351 may perform the recognition using linguistic knowledge, grammatical knowledge or semantic knowledge, for example.

b) Task candidates S1361 may be included that have a semantic relation with the task based on the recognition result S1360 output by the recognition portion 1351.

c) The presentation of the task candidates S1361 is not limited to screen displays and may be accomplished by speech.

d) The number of task candidates S1361 that are presented does not have to be fixed.

e) Some of the task candidates S1361 may be displayed even after the first predetermined time has elapsed.

f) The task candidates S1361 may be presented such that they scroll over the touch-panel display 1387.

Sixth Embodiment

Configuration of Mobile Phone

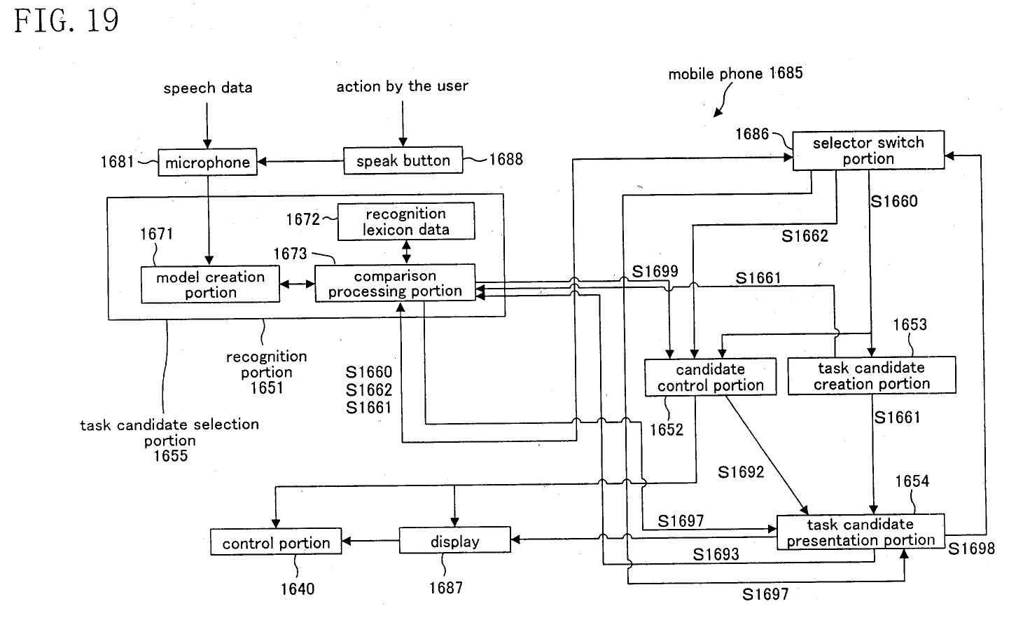

FIG. 19 is a block diagram showing the overall configuration of a mobile phone in accordance with a sixth embodiment. The mobile phone 1685 shown in FIG. 19 includes a microphone 1681, a speak button 1688, a recognition portion 1651 (task candidate selection portion 1655), a selector switch portion 1686, a task candidate creation portion 1653, a task candidate presentation portion 1654, a display 1687, a control portion 1640, and a task control portion 1652. The recognition portion 1651 (task candidate selection portion 1655) includes a model creation portion 1671, recognition lexicon data 1672, and a comparison processing portion 1073.

The microphone 1681 receives speech data from the user while the speak button 1688 is pressed, and sends them to the model creation portion 1671.

The model creation portion 1671 converts the speech data that have been sent by the microphone 1681 into characteristic quantities, creates a model, and stores that model.

The comparison processing portion 1673 compares the recognition lexicon data 1672 with the model stored by the model creation portion, and creates a recognition result S1660, which it sends to the selector switch portion 1686.

The selector switch portion 1686 sends the received recognition result S1660 to the task control portion 1652 and the task candidate creation portion 1653.

Based on the recognition result S1660 sent by the selector switch portion 1686, the task control portion 1652 switches the screen of the display 1687. Furthermore, the task control portion 1652 receives trigger signals S1699 sent by the comparison processing portion 1673 (after a second predetermined time has passed), and, based on the recognition result S1660 sent by the selector switch portion 1686, changes the screen of the display 1687 and initiates a call to a number to be called with the control portion 1640 (first task).

Based on the recognition result S1660 that has been sent by the selector switch portion 1686, the task candidate creation portion 1653 creates task candidates S1661 and sends those task candidates S1661 to the candidate presentation portion 1654 and the comparison processing portion 1673.

The task candidate presentation portion 1654 presents the task candidates S1661 created by the task candidate creation portion 1653 on the display 1687, and sends a trigger signal S1693 to the comparison processing portion 1673. The task candidate presentation portion 1654 also sends a switching signal S1698 to the selector switch portion 1686.

Until receiving the next switching signal S1698, the selector switch portion 1686 does not send selection information S1662 to the task candidate creation portion 1653, but sends received selection information S1662 to the task control portion 1652.

If the model creation portion 1671 has received speech data before a first predetermined time has elapsed after the comparison processing portion 1673 has received the trigger signal S1693, then the recognition portion 1651, which serves as the task candidate selection portion 1655, performs a recognition process in the comparison processing portion 1673 while restricting the recognition lexicon data 1672 to the task candidates S1661, and outputs the recognition result as the selection information S1662.

The selector switch portion 1686 receives the selection information S1662 that has been output by the comparison processing portion 1673 and sends the selection information S1662 to the task control portion 1652.

The task control portion 1652 receives the selection information S1662 and sends a presentation-stop signal S1692 to the task candidate presentation portion 1654. Furthermore, the task control portion 1652 switches the screen of the display 1687 based on the received selection information S1662 and initiates a call to the number to be called with the control portion 1640 (second task).

The task candidate presentation portion 1654 receives the presentation-stop signal S1692 sent by the task control portion 1652, and stops the presentation of the task candidates S1661 on the display 1687 (first timing), and sends a switching signal S1698 to the selector switch portion 1686.

If, in the recognition portion 1651, which serves as the task candidate selection portion 1655, the model creation portion 1671 has not received any speech data before a first predetermined time has elapsed after the comparison processing portion 1673 has received the trigger signal S1693, then the comparison processing portion 1673 sends a presentation-stop signal S1697 to the task candidate presentation portion 1654. The comparison processing portion 1673 also sends a trigger signal S1699 to the task control portion 1652.

The task candidate presentation portion 1654 receives the presentation-stop signal S1697 and stops the presentation of the task candidates S1661 that are presented on the display 1687 (second timing). Furthermore, the task candidate presentation portion 1654 receives the presentation-stop signal S1697 and sends a switching signal S1698 to the selector switch portion 1686.

Until receiving the next switching signal S1698, the selector switch portion 1686 sends received recognition results S1660 to the task control portion 1652 and the task candidate creation portion 1353.

Operation of the Mobile Phone

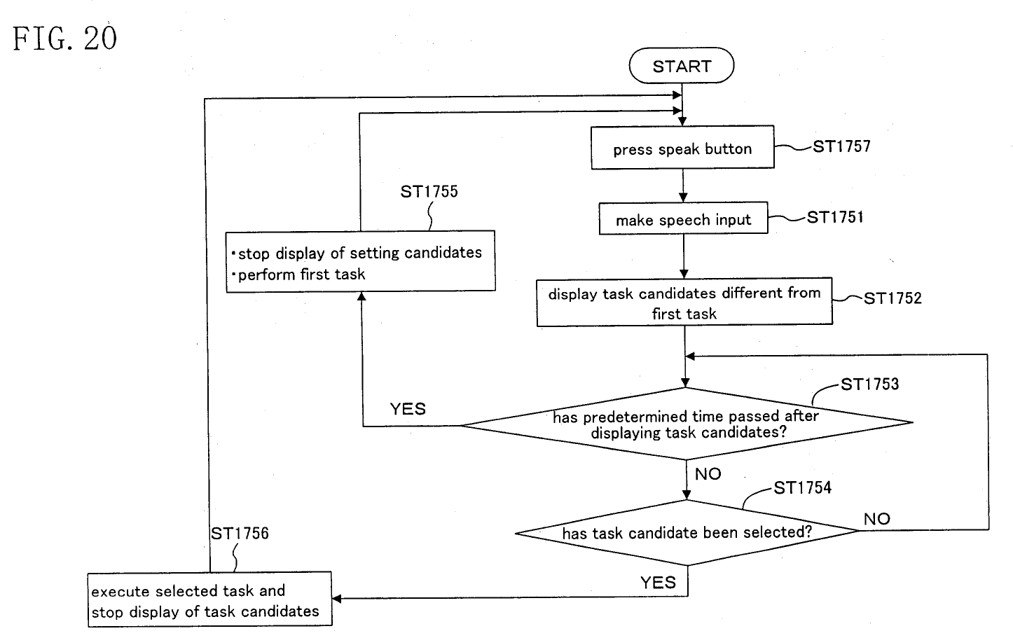

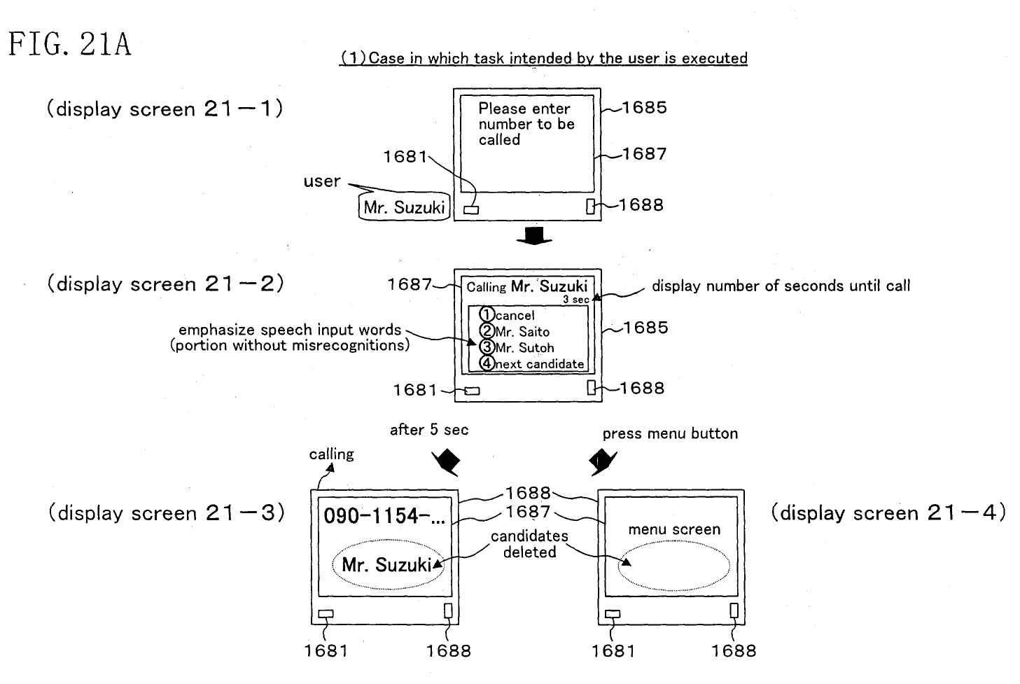

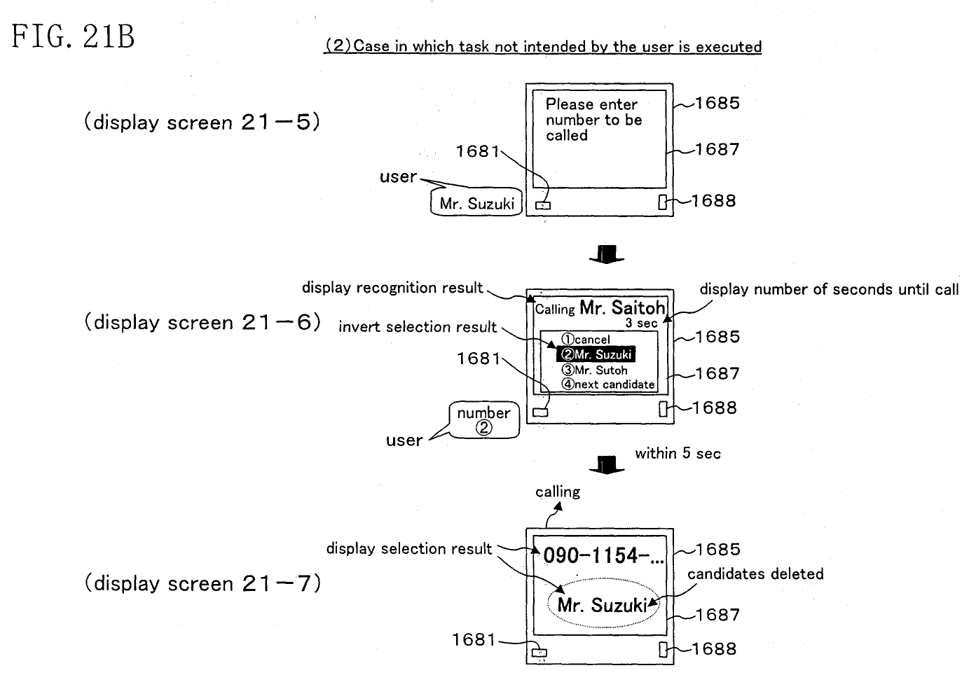

The following is an explanation of the operation of the mobile phone 1685 configured as described above. Here, an example is described with reference to FIG. 20 and FIGS. 21A to 21B, in which a calling operation with the mobile phone is carried out by speech.

(1) Case in Which the Task Intended by the User is Performed

First, the message “please enter number to be called” is shown on the display 1687 (see display screen 21-1 in FIG. 21A).

[Step ST1757]

The user presses the speak button 1688 in order to enter by speech the number to be called.

[Step ST1751]

After pressing the speak button 1688, the user enters the speech data “Mr. Suzuki” into the microphone 1681 (display screen 21-1 in FIG. 21A). The entered speech data are sent to the recognition portion 1651. The recognition portion 1651 outputs, as the recognition results, S1660 “Mr. Suzuki,” “Mr. Saitoh” and “Mr. Sutoh,” which are the best matches between the information concerning the speech data and the recognition lexicon data 1672, and sends the recognition results S1660 to the selector switch portion 1686. The selector switch portion 1686 sends the received recognition result S1660 “Mr. Suzuki” to the task control portion 1652, and sends the received recognition results S1660 “Mr. Saitoh” and “Mr. Sutoh” to the task candidate creation portion 1653. Based on the recognition results S1660 “Mr. Saitoh” and “Mr. Sutoh,” the task candidate creation portion 1653 creates the task candidates S1661 “\mathring{2} Mr. Saitoh” and “\mathring{3} Mr. Sutoh.” The task candidate creation portion 1653 also creates the task candidates S1661 “\mathring{1} cancel” and “\mathring{4} next candidate.” The task candidate creation portion 1653 sends the task candidates S1661 to the task candidate presentation portion 1654 and the comparison processing portion 1673.

[Step ST1752]

Based on the recognition result S1660 “Mr. Suzuki,” the task control portion 1652 displays “Calling Mr. Suzuki” and the remaining number of seconds “3 sec” until the first predetermined time (5 sec) on the display 1687 (first task).

The task candidate presentation portion 1654 displays on the display 1687 the task candidates S1661 “\mathring{1} cancel,” “\mathring{2} Mr. Saitoh,” “\mathring{3} Mr. Sutoh” and “\mathring{4} next candidate” (display screen 21-2 in FIG. 21A). At the same time as the task candidates S1661 are displayed, the task candidate presentation portion 1654 sends a trigger signal S1693 to the comparison processing portion 1673. The task candidate presentation portion 1654 also sends a switching signal S1698 to the selector switch portion 1698. Until receiving the next switching signal S1698, the selector switch portion 1686 sends received selection information S1662 to the task control portion 1652, but does not send received selection information S1662 to the task candidate creation portion 1653. After the selector switch portion 1686 has received the next switching signal S1698, it sends received recognition results S1660 to the task control portion 1652 and the task candidate creation portion 1653.

[Steps ST1753 and ST1754]

If, in the recognition portion 1651 which serves as the task candidate selection portion 1655, the user does not press the speak button 1688 to enter speech data and express the intention to select a task candidate within a first predetermined time (5 sec) after the comparison processing portion 1673 has received the trigger signal S1693, then the comparison processing portion 1673 of the task candidate selection portion 1655 sends a presentation-stop signal S1697 to the task candidate presentation portion 1654. The comparison processing portion 1673 sends a trigger signal S1699 to the task control portion 1652. The task candidate presentation portion 1654 receives the presentation-stop signal S1697 and stops the display of the task candidates on the display 1687. The task control portion 1652 receives the trigger signal S1699, and (after a second predetermined time (here: 5 sec) has passed) initiates a call to Mr. Suzuki based on the recognition result S1660 “Mr. Suzuki” (first task) (display screen 21-3 of FIG. 21A). The task candidate presentation portion 1654 receives the presentation-stop signal S1697 and sends a switching signal S1698 to the selector switch portion 1686. It should be noted that if the menu button is pressed during the above-noted first predetermined time (5 sec), then a menu screen is shown on the display 1687 (display screen 21-4 of FIG. 21A).

(2) Case in Which the Task Intended by the User is Not Executed

First, the message “please enter number to be called” is shown on the display 1687 (display screen 21-5 in FIG. 21B).

[Step ST1757]

The user presses the speak button 1688 in order to enter by speech the number to be called.

[Step ST1751]

After pressing the speak button 1688, the user enters the speech data “Mr. Suzuki” into the microphone 1681 (display screen 21-5 in FIG. 21B). The entered speech data are sent to the recognition portion 1651. The recognition portion 1651 outputs, as the recognition results, S1660 “Mr. Saitoh,” “Mr. Suzuki” and “Mr. Sutoh,” which are the best matches between the information concerning the speech data and the recognition lexicon data 1672, and sends the recognition results S1660 to the selector switch portion 1686. The selector switch portion 1686 sends the received recognition result S1660 “Mr. Saitoh” to the task control portion 1652, and sends the received recognition results S1660 “Mr. Suzuki” and “Mr. Sutoh” to the task candidate creation portion 1653. Based on the recognition results S1660 “Mr. Suzuki” and “Mr. Sutoh,” the task candidate creation portion 1653 creates the task candidates S1661 “\mathring{2} Mr. Suzuki” and “\mathring{3} Mr. Sutoh.” The task candidate creation portion 1653 also creates the task candidates S1661 “\mathring{1} cancel” and “\mathring{4} next candidate.” The task candidate creation portion 1653 sends the task candidates S1661 to the task candidate presentation portion 1654 and the comparison processing portion 1673.

[Step ST1752]

Based on the recognition result S1660 “Mr. Saitoh,” the task control portion 1652 displays “Calling Mr. Saitoh” and the remaining number of seconds “3 sec” until the first predetermined time on the display 1687 (first task).

The task candidate presentation portion 1654 displays on the display 1687 the task candidates S1661 “\mathring{1} cancel,” “\mathring{2} Mr. Suzuki,” “\mathring{3} Mr. Sutoh” and “\mathring{4} next candidate” (display screen 21-6 in FIG. 21B). At the same time as the task candidates S1661 are displayed, the task candidate presentation portion 1654 sends a trigger signal S1693 to the comparison processing portion 1673. The task candidate presentation portion 1654 sends a switching signal S1698 to the selector switch portion 1686. Until receiving the next switching signal S1698, the selector switch portion 1686 sends received selection information S1662 to the task control portion 1652, but does not send any received selection information S1662 to the task candidate creation portion 1653. After the selector switch portion 1686 has received the next switching signal S1698, it sends received recognition results S1660 to the task control portion 1652 and the task candidate creation portion 1653.

[Steps ST1753 and ST1754]

Within five seconds (first predetermined time) after the comparison processing portion 1673 in the recognition portion 1651, which also serves as the task candidate selection portion 1655, has received the trigger signal S1693, the user presses the speak button 1688 to enter the speech data “two”. The microphone 1681 sends the speech data to the model creation portion 1671. The model creation portion 1671 converts the speech data “two” into characteristic quantities and stores them. The comparison processing portion 1673 creates the recognition result S1660 “two” using the characteristic quantities stored by the model creation portion 1673 and the recognition lexicon data 1672, and creates the selection information S1662 “Mr. Suzuki” based on the recognition result S1660 “two” and the task candidate S1661 “\mathring{2} Mr. Suzuki.” The comparison processing portion 1673 sends the selection information S1662 to the selector switch portion 1686. The selector switch portion 1686 sends the received selection information S1662 to the task control portion 1652.

[Step ST1756]

After a second predetermined time has passed and based on the received selection information S1662, the task control portion 1652 displays Mr. Suzuki's telephone number as well as “Mr. Suzuki” on the display 1687, and initiates a call to Mr. Suzuki (second task).

After receiving the selection information S1662, the task control portion 1652 sends a presentation-stop signal S1692 to the task candidate presentation portion 1654. The task candidate presentation portion 1654 receives the presentation-stop signal S1692 and stops the display of the task candidates S1661 shown on the display 1687 (display screen 21-7 in FIG. 21B). The task candidate presentation portion 1654 receives the presentation-stop signal S1692 and sends a switching signal S1698 to the selector switch portion 1686. The selector switch portion 1686 makes arrangements to the effect that the subsequently received recognition result S1660 is sent to the task control portion 1652 and the task candidate creation portion 1653.

Effects

With the sixth embodiment as explained above, the task candidates S1661 created by the task candidate creation portion 1653 are presented and selected by the user at whichever is the faster timing of a first timing with which the second task is executed and a second timing at which a first predetermined time after presenting the task candidates S1661 has elapsed, so that the user does not need to perform again from the beginning the procedure for executing the task intended by the user. Consequently, usage becomes more convenient and less troublesome for the user.

Moreover, the task candidate presentation portion 1654 automatically stops the presentation of the task candidates S1661 if the user shows no intent of selecting a task candidate even after the first predetermined time has passed, so that if the first task that has been executed is the task intended by the user, the user does not need to stop the presentation of the task candidates S1661. Consequently, usage becomes more convenient and less troublesome for the user.

Furthermore, the task control portion 1652 automatically executes the first task based on the recognition result S1660 that has been output by the recognition portion 1651, so that if the first task that is executed is the task that was intended by the user, then the user does not have to select a task candidate. Consequently, usage becomes more convenient and less troublesome for the user.

Furthermore, the task candidate presentation portion 1654 automatically presents the task candidates S1661, so that if the first task that is executed is not the task intended by the user, the user does not have to perform an operation in order to present the task candidates. Consequently, usage becomes more convenient and less troublesome for the user.

Furthermore, the task candidates S1661 created by the task candidate creation portion 1653 include tasks related to the recognition data that are good matches when comparing information reflecting the entered task content to be recognized with the recognition lexicon data 1672, so that even when a misrecognition has occurred, it is possible to include the correctly recognized task among the task candidates S1661 and to correct the misrecognition with the user's selection. Consequently, usage becomes more convenient for the user.

Furthermore, since the first task (initiating a call) based on the recognition result S1660 is executed after the second predetermined time, execution of a first task not intended by the user can be prevented. Consequently, usage becomes more convenient for the user.

Furthermore, the selection of the task candidates S1661 is performed after adding to the task candidates S1661 words (here, for example, numbers) whose recognition is easier than that of the recognition results S1660, so that erroneous selections do not occur. Consequently, usage becomes more convenient for the user.

Furthermore, since a cancel function is included as one of the task candidates S1661, it is possible to cancel and return to the original state instead of executing the desired task. Consequently, usage becomes more convenient for the user.

It should be noted that the present embodiment is not limited to the above description, and the various adaptations listed below are also possible, for example.

a) The recognition portion 1651 may perform the recognition using linguistic knowledge, grammatical knowledge or semantic knowledge, for example.

b) Task candidates S1661 may be included that have a semantic relation with the task based on the recognition result S1660 output by the recognition portion 1651 (for example “read Mr. Suzuki's mail” or “view Mr. Suzuki's personal information” for “Mr. Suzuki”).

c) The presentation of the task candidates S1661 is not limited to screen displays and may be accomplished by speech.

d) The number of task candidates S1661 that are presented does not have to be fixed.

e) As shown in the display screen 21-4 of FIG. 21A, it is also possible to use the information “menu screen button has been pressed,” which is general information reflecting a task that is different from the first task.

f) The recognition portion 1651 is not limited to speech recognition means, and may also perform character recognition or the like.

g) The first predetermined time and the second predetermined time related to the execution of the first task may be set independently.

h) Some of the task candidates S1661 may be displayed even after the first predetermined time has elapsed.

i) It is also possible to use for example character recognition instead of speech recognition.

Seventh Embodiment

Configuration of Translation Apparatus

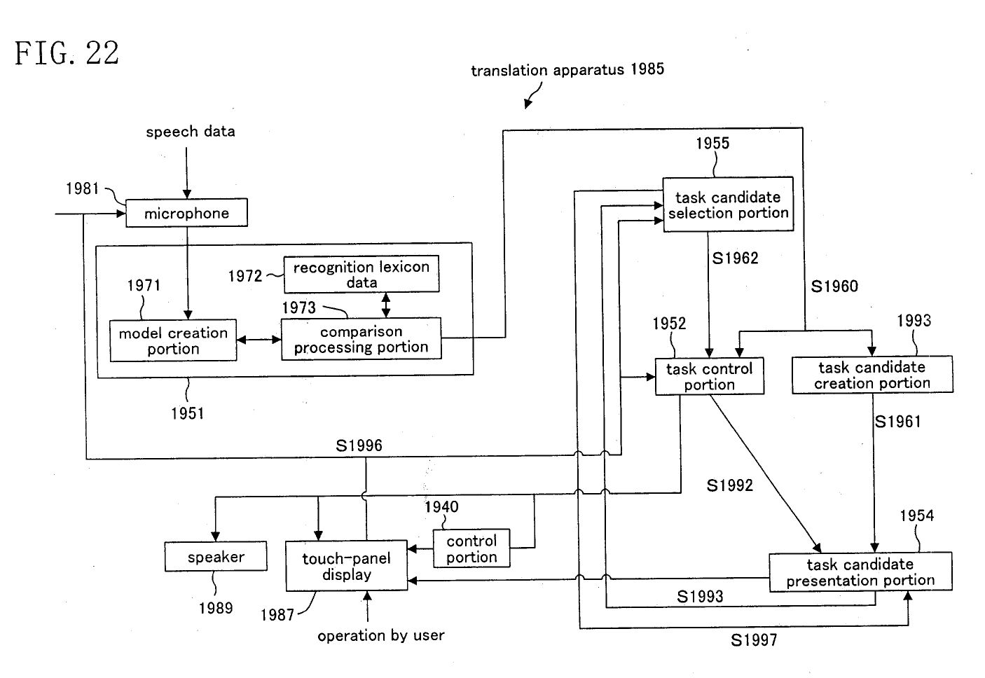

FIG. 22 is a block diagram showing the overall configuration of a translation apparatus in accordance with a seventh embodiment. The translation apparatus 1985 shown in FIG. 22 includes a microphone 1981, a recognition portion 1951, a task control portion 1952, a task candidate creation portion 1993, a task candidate presentation portion 1954, a task candidate selection portion 1955, a touch-panel display 1987, a control portion 1940, and a speaker 1989. The recognition portion 1951 includes a model creation portion 1971, recognition lexicon data 1972, and a comparison processing portion 1973.

When a portion marked “speak button” on the touch-panel display 1987 is pressed with a pen, an operation signal S1996 is sent to the microphone 1981.

After receiving the operation signal S1996, the microphone 1981 receives speech data, and sends them to the model creation portion 1971.

The model creation portion 1971 converts the speech data that have been sent by the microphone 1981 into characteristic quantities, and stores them as a model.

The comparison processing portion 1973 compares the recognition lexicon data 1972 with the model stored by the model creation portion 1971, and creates a recognition result S1960, which it sends to the task control portion 1952 and the task candidate creation portion 1993.

Based on the received recognition result S1960, the task control portion 1952 displays the recognition result that is the best match on the touch-panel display 1987, changes the speak button on the touch-panel display 1987 into a synthetic voice button, lets the control portion 1940 translate the recognition result that is the best match, and displays the translation result on the touch-panel display 1987 (first task).

Based on the received recognition result S1960, the task candidate creation portion 1993 creates task candidates S1961 and sends those task candidates S1961 to the candidate presentation portion 1954.

The task candidate presentation portion 1954 displays the received task candidates S1961 on the touch-panel display l987, and sends a trigger signal S1993 to the task candidate selection portion 1955.

If the task candidate selection portion 1955 does not receive an operation signal S1996 produced by a selection of a candidate with the touch-panel display 1987 after the trigger signal S1993 has been received and before a first predetermined time has elapsed, then a presentation-stop signal S1997 is sent to the candidate presentation portion 1954.

After receiving the presentation-stop signal S1997, the candidate presentation portion 1954 stops the presentation of the task candidates S1961 that are presented on the touch-panel display 1987 (second timing).

If the task candidate selection portion 1955 has received an operation signal S1996 produced by a selection of a candidate with the touch-panel display 1987 after the trigger signal S1993 has been received and before a first predetermined time has elapsed, then it produces selection information S1962 based on the received operation signal S1996 and sends the selection signal S1962 to the task selection portion 1952.

Based on the received selection signal S1962, the task control portion 1952 displays the selected recognition result on the touch-panel display 1987, lets the control portion 1940 translate the selected recognition result, and displays the translation result on the touch-panel display 1987 (second task).

The task control portion 1952 receives the selection information S1962 produced by the task candidate selection portion 1955 and sends a presentation-stop signal S1992 to the task candidate presentation portion 1954.

The task candidate presentation portion 1954 receives the presentation-stop signal S1992 sent by the task control portion 1952, and stops the presentation of the task candidates S1961 displayed on the touch-panel display 1987 (first timing).

The task control portion 1952 receives an operation signal S1996 (general information reflecting a task that is different from the first task) produced with the touch-panel display 1987 by pressing the synthetic voice button, and sends a presentation-stop signal S1992 to the task candidate presentation portion 1954.

The task candidate selection portion 1955 receives the operation signal S1996 produced with the touch-panel display 1987 by pressing the synthetic voice button, and does not produce selection information S1962 until receiving the next trigger signal S1993.

The task candidate presentation portion 1954 receives the presentation-stop signal S1992, and stops the display of the task candidates S1961 that are displayed on the touch-panel display 1987 (third timing).

Operation of the Translation Apparatus

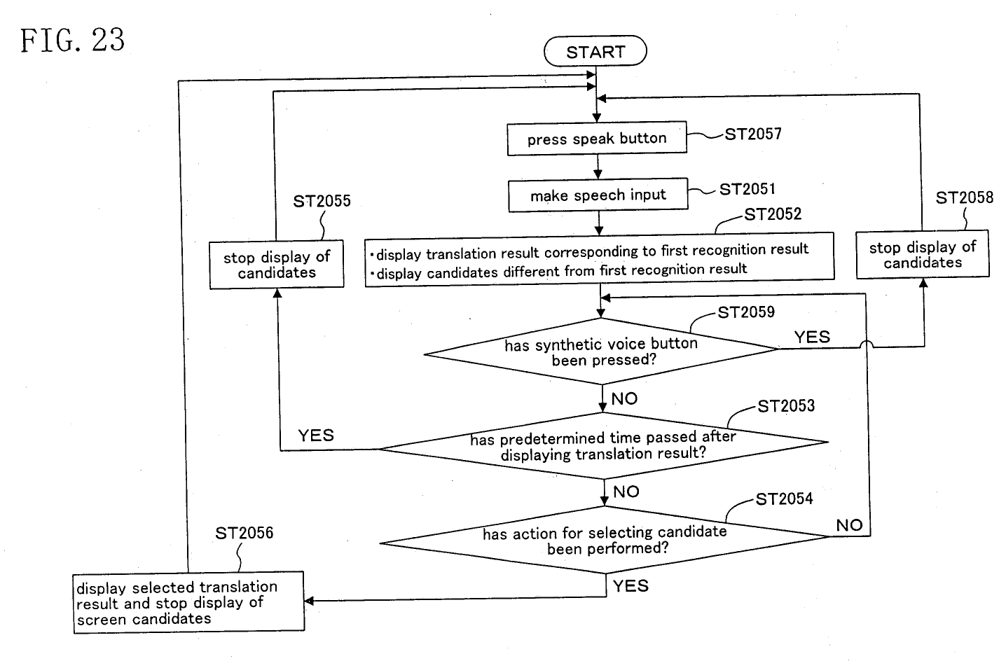

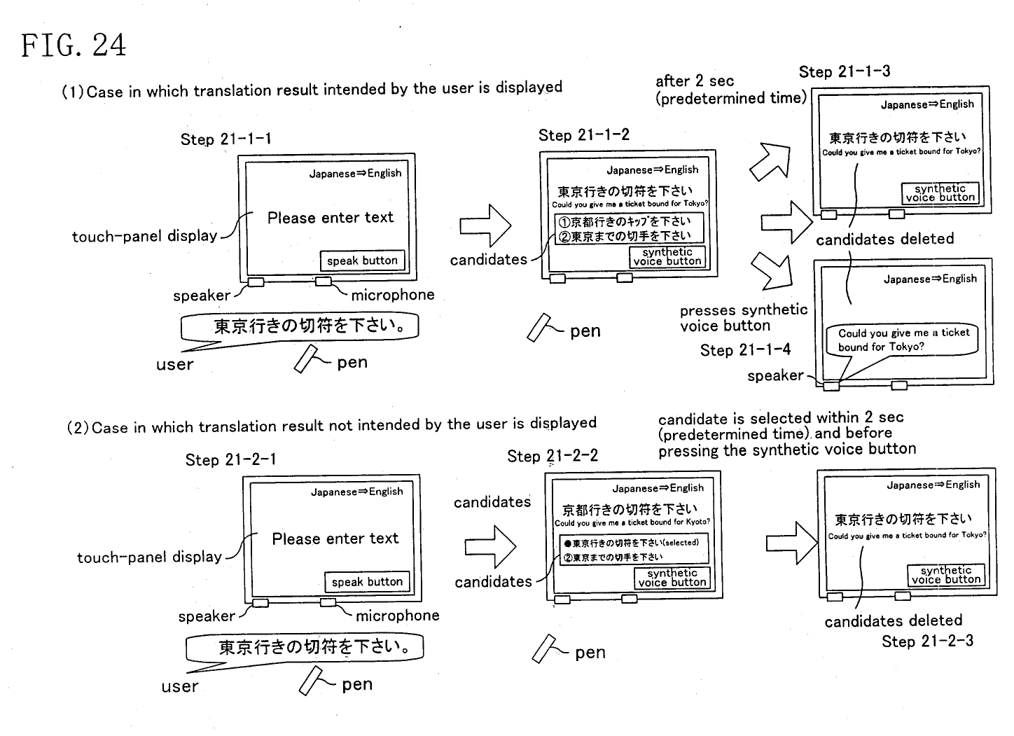

The following is an explanation of the operation of the translation apparatus 1985 configured as described above. Here, an example is described with reference to FIG. 23 and FIG. 24, in which the translation apparatus 1985 is operated by operating a touch panel using speech and pen.

(1) Example 1 of a Case in Which the Translation Result Intended by the User is Displayed

[Step ST2057]

The user presses the speak button on the touch-panel display 1987 with a pen in order to make a speech input. [Step ST2051]

The user enters the speech data [symbol] [symbol] [symbol] (which is Japanese for “Could you give me a ticket bound for Tokyo?”) into the microphone 1981 (Step 21-1-1 in FIG. 24). The entered speech data are sent to the recognition portion 1951. The recognition portion 1951 outputs, as the recognition results, S1960 [symbol] [symbol] [symbol] (Japanese for “Could you give me a ticket bound for Tokyo?”), [symbol] [symbol] [symbol] (Japanese for “Could you give me a ticket bound for Kyoto?”), and [symbol] [symbol] [symbol] (Japanese for “Could you give me a stamp for Tokyo?”), which are the best matches between the information concerning the speech data and the recognition lexicon data 1972, sends the recognition result S1960 [symbol] [symbol] [symbol] to the task control portion 1952, and sends the recognition results S1960 [symbol] [symbol] [symbol] and [symbol] [symbol] [symbol] to the task candidate creation portion 1993. Here, the recognition results S1960 are produced by extracting keywords from the speech data and selecting the sample sentences (of the recognition lexicon data 1972) that include the most of the keywords extracted from the speech data. Based on the recognition results S1960, the task candidate creation portion 1961 creates \mathring{1} [symbol] [symbol] [symbol] and \mathring{2} [symbol] [symbol] [symbol] as task candidates S1961. The task candidate creation portion 1961 sends the task candidates S1961 to the task candidate presentation portion 1954.

[Step ST2052]

Based on the recognition result S1960 [symbol] [symbol] [symbol] the task control portion 1952 displays [symbol] [symbol] [symbol] on the touch-panel display 1987, changes the speak button on the touch-panel display 1987 into a synthetic voice button, lets the control portion 1940 translate the phrase [symbol] [symbol] [symbol] and displays the translation result on the touch-panel display 1987 (first task).

The task candidate presentation portion 1954 displays the task candidates S1961 “\mathring{1} [symbol] [symbol] [symbol] and “\mathring{2} [symbol] [symbol] [symbol] on the touch-panel display 1987 (Step 21-1-2 in FIG. 24).

[Steps ST2059, ST2053 and ST2054]

If within two seconds (first predetermined) after the task candidate selection portion 1955 has received the trigger signal S1993, the task candidate selection portion 1955 does not receive an operation signal S1996 produced by the synthetic voice button on the touch-panel display 1987, and the task candidate selection portion 1955 does not receive an operation signal S1996 for selecting a task candidate 1961 with the touch-panel display 1987, then the task candidate selection portion 1955 sends a presentation-stop signal S1996 to the task candidate presentation portion 1954. Furthermore, the task candidate selection portion does not send selection information S1962 until it has received the next trigger signal S1993.

[Step ST2055]

The task candidate presentation portion 1954 stops the display of the task candidates S1961 on the touch-panel display 1987 (Step 21-1-3 in FIG. 24). Here, the phrase “Could you give me a ticket bound for Tokyo?” is emitted from the speaker 1989 when pressing the synthetic voice button on the touch-panel display 1987.

(2) Example 2 of a Case in Which the Translation Result Intended by the User is Displayed

[Step ST2057]

The user presses the speak button on the touch-panel display 1987 with a pen in order to make a speech input.

[Step ST2051]

The user enters the speech data [symbol] [symbol] [symbol] (which is Japanese for “Could you give me a ticket bound for Tokyo?”) into the microphone 1981 (Step 21-1-1 in FIG. 24). The entered speech data are sent to the recognition portion 1951. The recognition portion 1951 outputs, as the recognition results, S1960 [symbol] [symbol] [symbol] (Japanese for “Could you give me a ticket bound for Tokyo?”), [symbol] [symbol] [symbol] (Japanese for “Could you give me a ticket bound for Kyoto?”), and [symbol] [symbol] [symbol] (Japanese for “Could you give me a stamp for Tokyo?”), which are the best matches between the information concerning the speech data and the recognition lexicon data 1972, sends the recognition result S1960 [symbol] [symbol] [symbol] to the task control portion 1952, and sends the recognition results S1960 [symbol] [symbol] [symbol] and [symbol] [symbol] [symbol] to the task candidate creation portion 1993. Here, the recognition results S1960 are produced by extracting keywords from the speech data and selecting the sample sentences (which are the recognition lexicon data 1972) that include the most of the keywords extracted from the speech data. Based on the recognition results S1960, the task candidate creation portion 1961 creates \mathring{1} [symbol] [symbol] z,66 and \mathring{2} [symbol] [symbol] [symbol] as task candidates S1961. The task candidate creation portion 1961 sends the task candidates S1961 to the task candidate presentation portion 1954.

[Step ST2052]

Based on the recognition result S1960 [symbol] [symbol] [symbol] the task control portion 1952 displays [symbol] [symbol] [symbol] on the touch-panel display 1987, changes the speak button on the touch-panel display 1987 into a synthetic voice button, lets the control portion 1940 translate the phrase [symbol] [symbol] [symbol] and displays the translation result on the touch-panel display 1987 (first task). The task candidate presentation portion 1954 displays the task candidates S1961 “\mathring{1} [symbol] [symbol] [symbol] and \mathring{2} [symbol] [symbol] [symbol] on the touch-panel display 1987 (Step 21-1-2 in FIG. 24).

[Steps ST2059, ST2053 and ST2054]

If within two seconds (first predetermined time) after the task candidate selection portion 1955 has received the trigger signal S1993, the task candidate selection portion 1955 receives an operation signal S1996 produced by the synthetic voice button on the touch-panel display 1987, then the task candidate selection portion 1955 sends a presentation-stop signal S1996 to the task candidate presentation portion 1954. Furthermore, the task candidate selection portion 1955 does not send selection information S1962 until it has received the next trigger signal S1993. The task control portion 1952 receives the operation signal S1996, and sends a presentation-stop signal S1992 to the task candidate presentation portion 1954. The task candidate presentation portion 1954 receives the presentation-stop signal S1992, and stops the display of the task candidates S1961 displayed on the touch-panel display 1987. The task control portion 1952 outputs the translation result “Could you give me a ticket bound for Tokyo?” from the speaker 1989 (Step 21-1-4 in FIG. 24).

(3) Case in Which the Translation Result Intended by the User is Not Displayed

[Step ST2057]

The user presses the speak button on the touch-panel display 1987 with a pen in order to make a speech input.

[Step ST2051]

The user enters the speech data [symbol] [symbol] [symbol] (which is Japanese for “Could you give me a ticket bound for Tokyo?”) into the microphone 1981 (Step 21-2-1 in FIG. 24). The entered speech data are sent to the recognition portion 1951. The recognition portion 1951 outputs, as the recognition results, S1960 [symbol] [symbol] [symbol] (Japanese for “Could you give me a ticket bound for Kyoto?”), [symbol] [symbol] [symbol] (Japanese for “Could you give me a ticket bound for Tokyo?”), and [symbol] [symbol] [symbol] (Japanese for “Could you give me a stamp for Tokyo?”), which are the best matches between the information concerning the speech data and the recognition lexicon data 1972, sends the recognition result S1960 [symbol] [symbol] [symbol] to the task control portion 1952, and sends the recognition results S1960 [symbol] [symbol] [symbol] and [symbol] [symbol] [symbol] to the task candidate creation portion 1993. Here, the recognition results S1960 are produced by extracting keywords from the speech data and selecting the sample sentences (which are the recognition lexicon data 1972) that include the most of the keywords extracted from the speech data. Based on the recognition results S1960, the task candidate creation portion 1961 creates “\mathring{1} [symbol] [symbol] [symbol] and “\mathring{2} [symbol] [symbol] [symbol] as task candidates S1961. The task candidate creation portion 1961 sends the task candidates S1961 to the task candidate presentation portion 1954.

[Step ST2052]

Based on the recognition result S1960 [symbol] [symbol] [symbol] the task control portion 1952 displays [symbol] [symbol] [symbol] on the touch-panel display 1987, changes the speak button on the touch-panel display 1987 into a synthetic voice button, lets the control portion 1940 translate the phrase [symbol] [symbol] [symbol] and displays the translation result “Could you give me a ticket bound for Kyoto?” on the touch-panel display 1987 (first task). The task candidate presentation portion 1954 displays the task candidates S1961 “\mathring{1} [symbol] [symbol] [symbol] and “\mathring{2} [symbol] [symbol] [symbol] on the touch-panel display 1987 (Step 21-2-2 in FIG. 24).

[Steps ST2059, ST2053 and ST2054]

If within two seconds (first predetermined) after the task candidate selection portion 1955 has received the trigger signal S1993, the task candidate selection portion 1955 receives an operation signal S1996 (selection of [symbol] [symbol] [symbol] in order to select a task candidate S1961 with the touch-panel display 1987, then the task candidate selection portion 1955 produces the selection information S1962 [symbol] [symbol] [symbol] based on the received operation signal S1996 (Step 21-2-2 in FIG. 24).

[Step ST2056]

Based on the selection information S1962, the task control portion 1952 displays [symbol] [symbol] [symbol] on the touch-panel display 1987, lets the control portion 1940 translate [symbol] [symbol] [symbol] and displays the translation result “Could you give me a ticket bound for Tokyo?” on the touch-panel display 1987. Here, the phrase “Could you give me a ticket bound for Tokyo?” is output from the speaker 1989 when pressing the synthetic voice button on the touch-panel display 1987 (Step 21-2-3 in FIG. 24).

Effects

With the seventh embodiment as explained above, the task candidates S1961 created by the task candidate creation portion 1993 are presented and selected by the user at whichever is the faster timing of a first timing with which the second task is executed, a second timing at which a first predetermined time after presenting the task candidates S1961 has elapsed, and a third timing at which general information reflecting a task that is different from the first task is entered, so that the user does not need to perform again from the beginning the procedure for executing the task intended by the user. Consequently, usage becomes more convenient and less troublesome for the user.

Moreover, the task candidate presentation portion 1954 automatically stops the presentation of the task candidates S1961 if the user shows no intent of selecting a task candidate even after the first predetermined time has passed, so that if the first task that has been executed is the task intended by the user, the user does not need to stop the presentation of the task candidates S1961. Consequently, usage becomes more convenient and less troublesome for the user.

Furthermore, the task control portion 1952 automatically executes the first task based on the recognition result S1960 that has been output by the recognition portion 1951, so that if the executed task is the task that was intended by the user, then the user does not have to select a task candidate. Consequently, usage becomes more convenient and less troublesome for the user.

Furthermore, the task candidate presentation portion 1954 automatically presents the task candidates S1961, so that if the first task that is executed is not the task intended by the user, the user does not have to perform an operation in order to present the task candidates. Consequently, usage becomes more convenient and less troublesome for the user.

Furthermore, the task candidates S1961 created by the task candidate creation portion 1993 include tasks related to the recognition data that are good matches when comparing information reflecting the entered task content to be recognized with the recognition lexicon data 1972, so that even when a misrecognition has occurred, it is possible to include the correctly recognized task among the task candidates S1961 and to correct the misrecognition with the user's selection. Consequently, usage becomes more convenient for the user.

It should be noted that the present embodiment is not limited to the above description, and the various adaptations listed below are also possible, for example.

a) The present invention may be further provided with a cancel function.

b) A task of realizing the cancel function may be included as one of the task candidates S1961.

c) Additions to the recognition lexicon data 1972 may be made as necessary.

d) The general information reflecting a task that is different from the first task may be the information that the cancel function has been performed.

e) The presentation of the task candidates S1961 is not limited to screen display and may also be performed by speech or the like.

f) The recognition portion 1951 is not limited to speech recognition method, and may also perform character recognition or the like.

g) The number of task candidates S1961 that are presented does not have to be fixed.

h) Some of the task candidates S1961 may be displayed even after the first predetermined time has elapsed.

i) The task candidates S1961 may also include tasks having a semantic relation to the task based on the recognition result S1960.

Eighth Embodiment

Configuration of Monitoring System

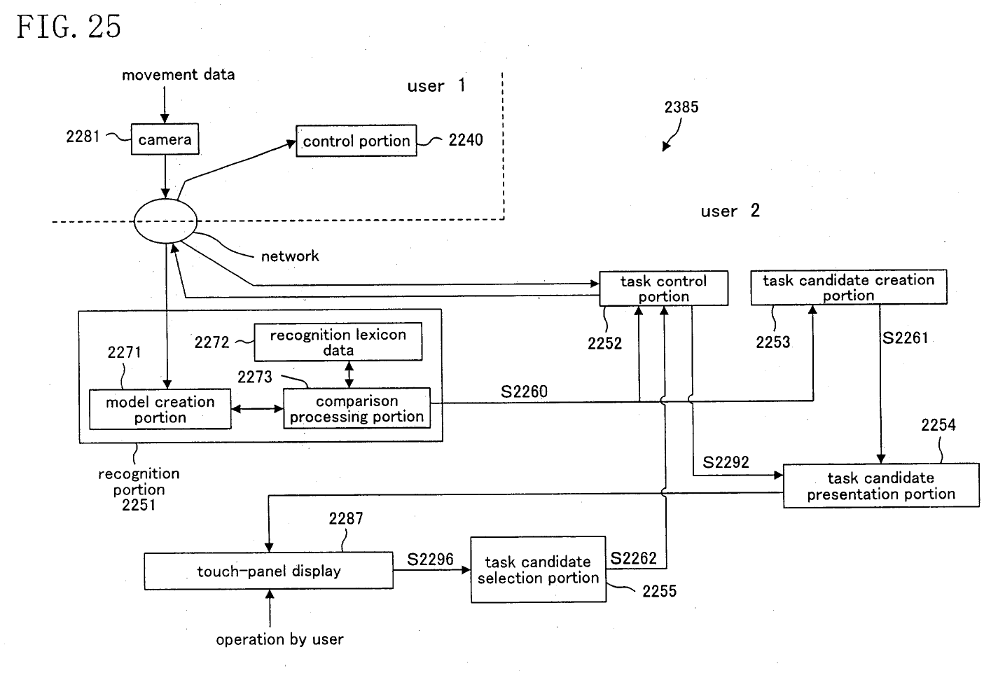

FIG. 25 is a block diagram showing the overall configuration of a translation apparatus in accordance with an eighth embodiment. The monitoring system 2385 shown in FIG. 25 includes, on the side of a user 1, a camera 2281 and a control portion 2240, and connected by a network on the side of a user 2, a recognition portion 2251, a task control portion 2252, a task candidate creation portion 2253, a task candidate presentation portion 2254, a task candidate selection portion 2255, and a touch-panel display 2287. The recognition portion 2251 includes a model creation portion 2271, recognition lexicon data 2272, and a comparison processing portion 2273.

The camera 2281 receives data about the movement of the user 1, and sends those movement data via the network to the model creation portion 2251 and the task control portion 2252.

The task control portion 2252 presents the movement data on the touch-panel display 2287.

The model creation portion 2271 converts the received movement data into characteristic quantities, creates a model and stores that model.

The comparison processing portion 2273 compares the recognition lexicon data 2272 with the model stored by the model creation portion 2271, and creates a recognition result S2260, which it sends to the task control portion 2252 and the task candidate creation portion 2253.

After a second predetermined time has passed after receiving the recognition result S2260, the task control portion 2252 controls the control portion 2240 based on the received recognition result S2260 (first task).

Based on the received recognition result S2260, the task candidate creation portion 2253 creates task candidates S2261 and sends those task candidates S2261 to the task candidate presentation portion 2254.

The task candidate presentation portion 2254 presents the received task candidates S2261 on the touch-panel display 2287.

If the task candidate selection portion 2255 has received an operation signal S2296 produced by an operation of selecting a task candidate S2261 performed by the user 2 while the task candidates S2261 are presented on the touch-panel display 2287, then the task candidate selection portion 2255 produces selection information S2262 and sends the selection information S2262 to the task control portion 2252.

Based on the received selection information S2262, the task control portion 2252 controls the control portion 2240. Moreover, the task control portion 2252 sends a presentation-stop signal S2292 to the task candidate presentation portion 2254. The task candidate presentation portion 2254 receives the presentation-stop signal S2292 and stops the presentation of the task candidates S2261 displayed on the touch-panel display 2287.

If the task candidate selection portion 2255 does not receive an operation signal S2296 produced by an operation of selecting a task candidate S2261 performed by the user 2 while the task candidates S2261 are presented on the touch-panel display 2287 (that is, if the first predetermined time after the task candidate presentation portion 2254 has received the task candidates S2261 has passed), then the task candidate presentation portion 2254 stops the display of the task candidates S2261 that are displayed on the touch-panel display 2287.

Operation of the Monitoring System

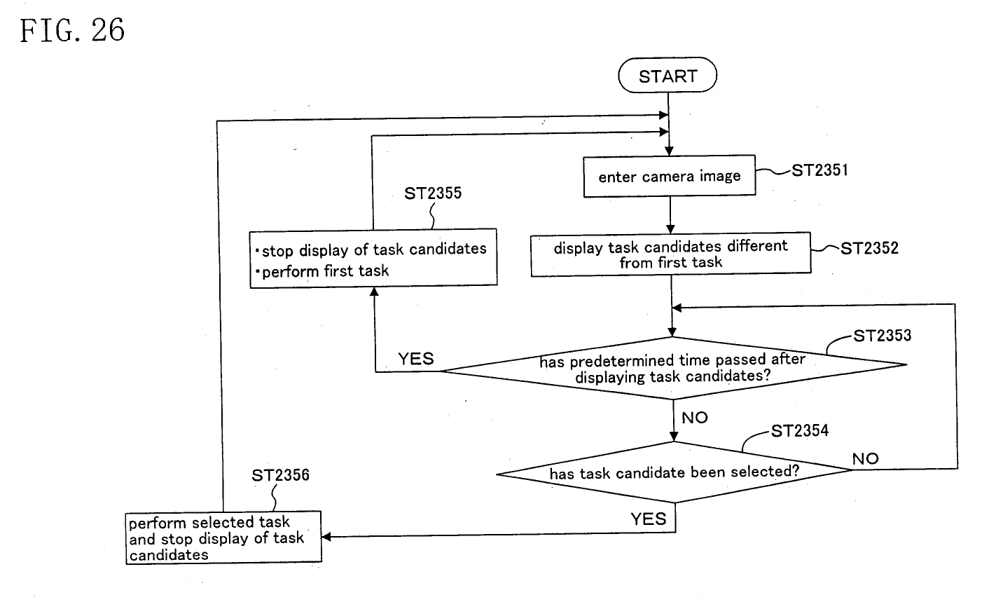

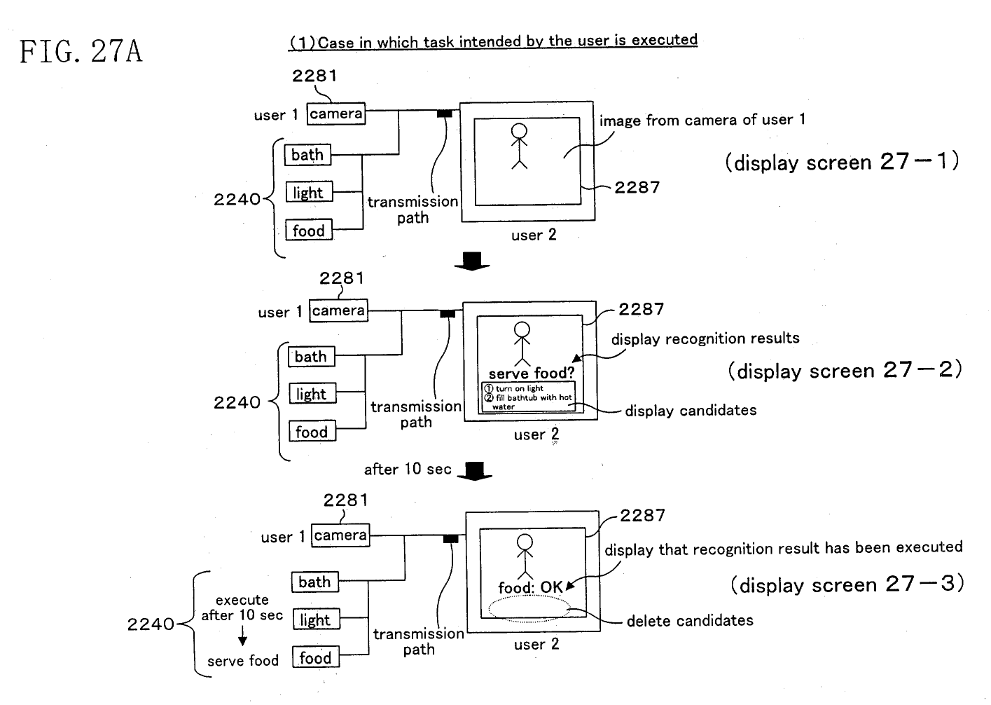

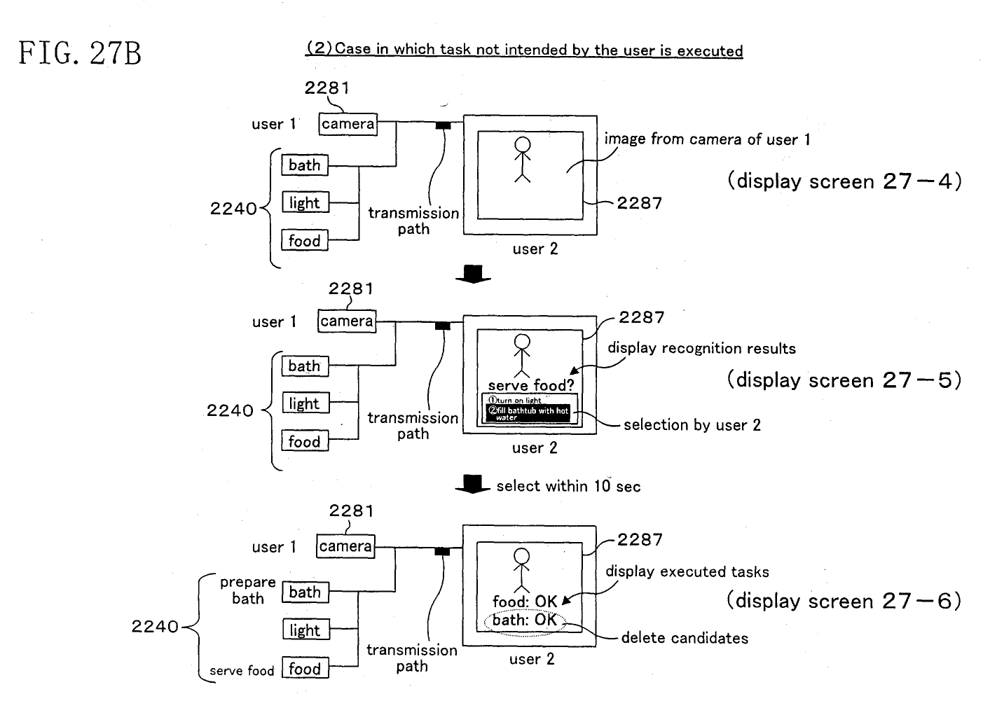

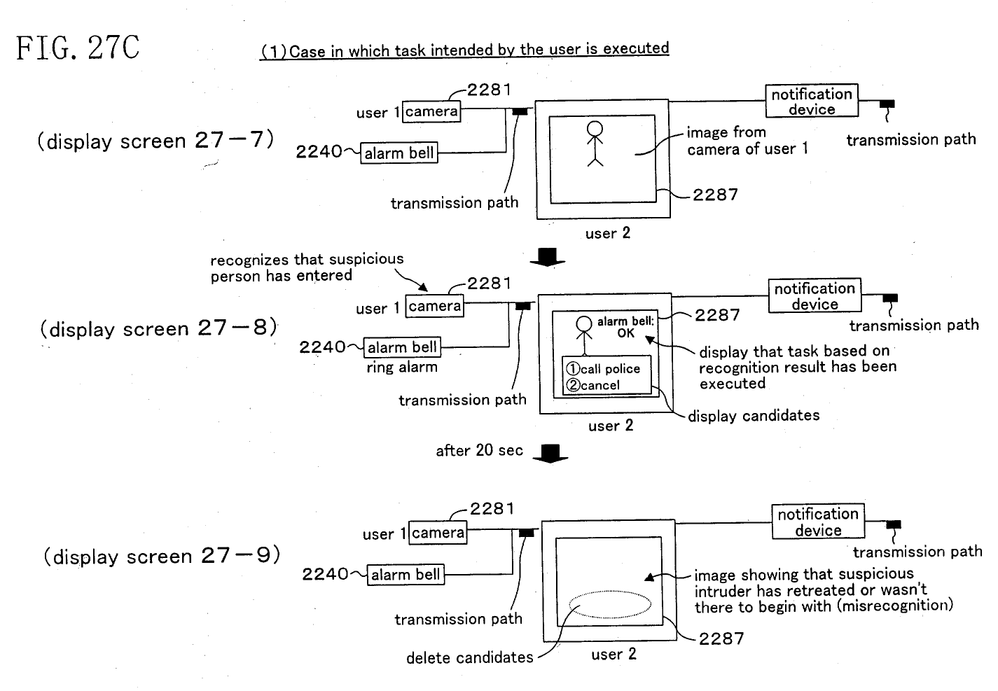

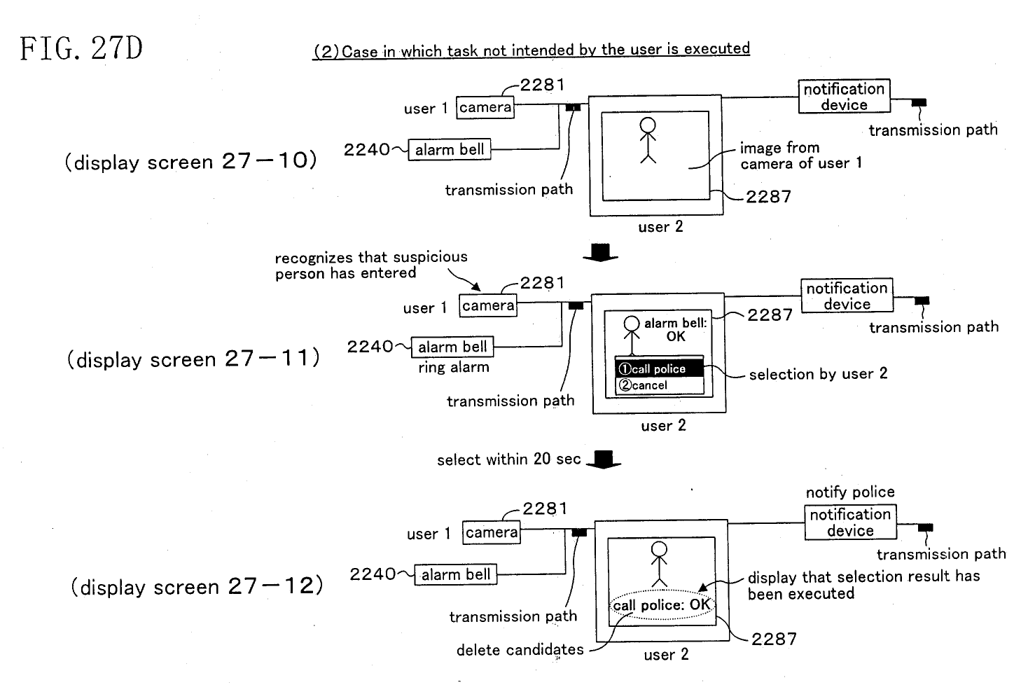

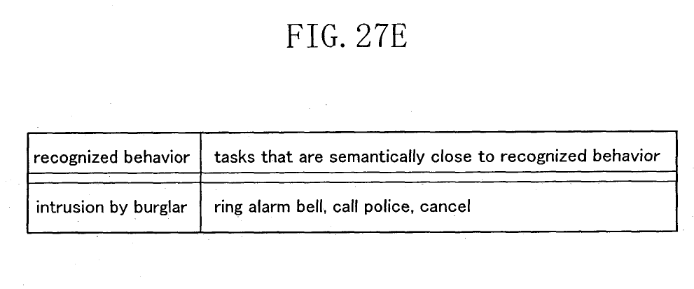

The following is an explanation of the operation of the monitoring system 2385 configured as described above. Here, an example is described with reference to FIG. 26 and FIGS. 27A to 27B, in which a behavior monitoring system is operated remotely via a network.

(1) Case in Which the Task Intended by the User is Executed

[Step ST2351]

The camera 2281 receives movement data of the user 1 and sends those data via a network such as the internet to the recognition portion 2251 and the task control portion 2252. Using the touch-panel display 2287, the task control portion 2252 presents the received movement data to the user 2 (display screen 27-1 in FIG. 27A). The recognition portion 2251 outputs, as recognition results S2260, “behavioral pattern when hungry,” “behavioral pattern when wanting the lights turned on” and “behavioral pattern when wanting to take a bath,” which are the best matches between the information concerning the movement data and the behavioral patterns of the recognition lexicon data 2272. The recognition portion 2251 sends the recognition result S2260 “behavioral pattern when hungry,” which is the best match, to the task control portion 2252, and sends the recognition results S2260 “behavioral pattern when wanting the lights turned on” and “behavioral pattern when wanting to take a bath” to the task candidate creation portion 2253. Based on the received recognition results S2260, the task candidate creation portion 2253 creates the task candidates S2261 “turn on the lights” and “fill bathtub with hot water,” and sends them to the task candidate presentation portion 2254.

[Step ST2352]

The task candidate presentation portion 2254 displays the task candidates S2261 “turn on the lights” and “fill bathtub with hot water” on the touch-panel display 2287. The task control portion 2252 displays on the touch-panel display 2287 the message “serve food?” which is the task based on the recognition result S2260 “behavioral pattern when hungry” (display screen 27-2 in FIG. 27A).

[Steps ST2353 and ST2354]

If the task candidate presentation portion 2254 does not receive a non-presentation signal S2292 from the task control portion 2252 after receiving the task candidates S2261 and before a first predetermined time has passed, then the task candidate presentation portion 2254 stops the display of the task candidates S2261 displayed on the touch panel display 2287. When a second predetermined time has passed after the task candidate presentation portion 2254 has received the recognition result S2260, then the task “serve food,” which is based on the recognition result S2260, is executed with the control portion 2240 (first task) (display screen 27-3 in FIG. 27A).

(2) Case in Which the Task Intended by the User is Not Executed

[Step ST2351]

The camera 2281 receives movement data of the user 1 and sends those data via a network such as the internet to the recognition portion 2251 and the task control portion 2252. Using the touch-panel display 2287, the task control portion 2252 presents the received movement data to the user 2 (display screen 27-4 in FIG. 27B). The recognition portion 2251 outputs, as recognition results S2260, “behavioral pattern when hungry,” “behavioral pattern when wanting the lights turned on” and “behavioral pattern when wanting to take a bath,” which are the best matches between the information concerning the movement data and the behavioral patterns of the recognition lexicon data 2272. The recognition portion 2251 sends the recognition result S2260 “behavioral pattern when hungry,” which is the best match, to the task control portion 2252, and sends the recognition results S2260 “behavioral pattern when wanting the lights turned on” and “behavioral pattern when wanting to take a bath” to the task candidate creation portion 2253. Based on the received recognition results S2260, the task candidate creation portion 2253 creates the task candidates S2261 “turn on the lights” and “fill bathtub with hot water,” and sends them to the task candidate presentation portion 2254.

[Step ST2352]

The task candidate presentation portion 2254 displays the task candidates S2261 “turn on the lights” and “fill bathtub with hot water” on the touch-panel display 2287. The task control portion 2252 displays on the touch-panel display 2287 the message “serve food?” which is the task based on the recognition result S2260 “behavioral pattern when hungry” (display screen 27-5 in FIG. 27B).

[Steps ST2353 and ST2354]

The user 2 observes the behavioral pattern of the user 1 on the touch-panel display 2287, and selects a task that is optimal for the behavioral pattern of the user 1. While the task candidates S2261 are displayed on the touch-panel display 2287, the user 2 selects one of the task candidates S2261. The task candidate selection portion 2255 receives an operation signal S2296, produces the selection information S2262 “fill bathtub with hot water” based on that operation signal S2296, and sends that selection information S2262 to the task control portion 2252. The task control portion 2252 executes with the control portion 2240 the task “serve food” (first task) based on the recognition result S2260, and the task “fill bathtub with hot water” (second task) based on the received selection information S2262. Furthermore, the task control portion 2252 displays “food: OK” and “bath: OK” on the touch-panel display 2287, in order to let the user 2 know that the first task and the second task have been executed. The task control portion 2252 sends a presentation-stop signal S2292 to the task candidate presentation portion 2254. The task candidate presentation portion 2254 receives the presentation-stop signal S2292 and stops the display of the task candidates S2261 that are displayed on the touch-panel display 2287 (display screen 27-6 in FIG. 27B).

Other Example of Operation of the Monitoring System

The following is an explanation of another example of the operation of the monitoring system 2385, with reference to FIGS. 27C to 27E.

(1) Case in Which the Task Intended by the User is Executed

The camera 2281 receives movement data of the user 1 and sends those data via a network such as the internet to the recognition portion 2251 and the task control portion 2252. Using the touch-panel display 2287, the task control portion 2252 presents the received movement data to the user 2 (display screen 27-7 in FIG. 27C). The recognition portion 2251 outputs, as the recognition result S2260, the behavioral pattern that is the best match between the information concerning the received movement data and the behavioral patterns included in the recognition lexicon data 2272. Here, it is assumed that “intruder has entered” is output as the recognition result S2260. This recognition result S2260 is sent to the task control portion 2252 and the task candidate creation portion 2253. The task control portion 2252 references the table shown in FIG. 27E, selects from the tasks “ring alarm bell,” “call police” and “cancel” that are associated with “intruder has entered” the task with the highest priority degree (here, this is assumed to be “ring alarm bell”), and lets the selected task be executed with the control portion 2240. In the table shown in FIG. 27E, association regions based on tasks to be performed have been set (regions of association by task). In the association region corresponding to the recognized behavior “intruder has entered,” the tasks “ring alarm bell,” “call police” and “cancel,” which are the tasks to be performed in response to this recognized behavior, are included. The task control portion 2252 displays “alarm bell: OK” on the touch-panel display 2287, in order to let the user 2 know that “ring alarm bell” has been executed (display screen 27-8 in FIG. 27C). The task candidate creation portion 2253 references the table shown in FIG. 27E, and sends the remaining tasks “call police” and “cancel” that are associated with the recognition result S2260 “intruder has entered” to the task candidate presentation portion 2254 as task candidates S2261. The task candidate presentation portion 2254 displays the task candidates S2261 “call police” and “cancel” on the touch-panel display 2287 (display screen 27-8 in FIG. 27C). When 20 seconds have passed without selecting one of the displayed candidates, the task candidate presentation portion 2254 stops the display of the task candidates S2261 that are displayed on the touch-panel display 2287 (display screen 27-9 in FIG. 27C).

(2) Case in Which the Task Intended by the User is Not Executed

In the same manner as described above, “call police” and “cancel” are displayed on the touch-panel display 2287 (display screens 27-10 and 27-11 in FIG. 27D). Within 20 seconds after displaying the candidates, the user 2 selects “call police” (display screen 27-11 in FIG. 27D). In response to this, an alarm device notifies the police via a communication channel. The task control portion 2252 displays “police notified: OK” on the touch-panel display 2287, in order to let the user 2 know that the police have been notified. Furthermore, the task candidate presentation portion 2254 stops the display of the task candidates S2261 that are displayed on the touch-panel display 2287 (display screen 27-12 in FIG. 27D).

Effects

With the eighth embodiment as explained above, the task candidates S2261 created by the task candidate creation portion 2253 are presented and selected by the user at whichever is the faster timing of a first timing with which the second task is executed, and a second timing at which a first predetermined time after presenting the task candidates S2261 has elapsed, so that the user does not need to perform again from the beginning the procedure for executing the task intended by the user. Consequently, usage becomes more convenient and less troublesome for the user.

Moreover, the task candidate presentation portion 2254 automatically stops the presentation of the task candidates S2261 if the user shows no intent of selecting a task candidate even after the first predetermined time has passed, so that if the first task that has been executed is the task intended by the user, the user does not need to stop the presentation of the task candidates S2261. Consequently, usage becomes more convenient and less troublesome for the user.

Furthermore, the task control portion 2252 automatically executes the first task based on the recognition result S2260 that has been output by the recognition portion 2251, so that if the first task that is executed is the task that was intended by the user, then the user does not have to select a task candidate S2261. Consequently, usage becomes more convenient and less troublesome for the user.

Furthermore, the task candidate presentation portion 2254 automatically presents the task candidates S2261, so that if the first task that is executed is not the task intended by the user, the user does not have to perform an operation in order to present the task candidates S2261. Consequently, usage becomes more convenient and less troublesome for the user.

Furthermore, the first task based on the recognition result S2261 is executed after the second predetermined time, so that it can be prevented that a first task that is not intended by the user is executed. Consequently, usage becomes more convenient for the user.

It should be noted that the present embodiment is not limited to the above description, and the various adaptations listed below are also possible, for example.

a) The number of task candidates S2261 that are presented does not have to be fixed.

b) A plurality of task candidates S2261 may be selected to execute a plurality of second tasks.

c) The network may be a telephone network, the internet, an intranet or a wireless network.

d) Some of the task candidates S2261 may be displayed even after the first predetermined time has elapsed.

Ninth Embodiment

Configuration of Control System

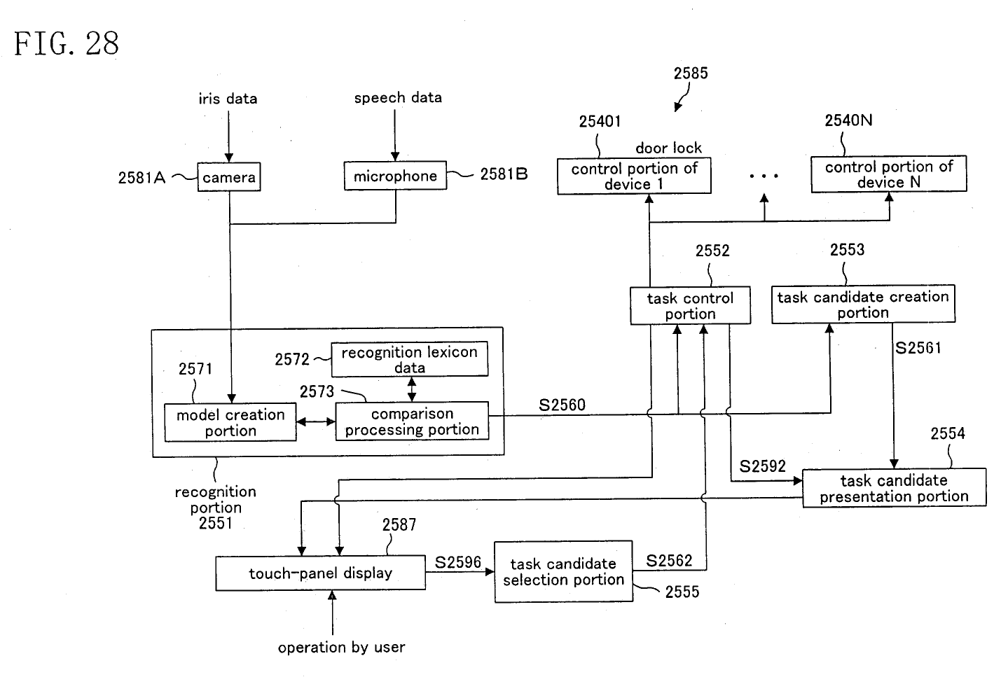

FIG. 28 is a block diagram showing the overall configuration of a control system in accordance with a ninth embodiment. The control system 2585 shown in FIG. 28 is a device control system with authentication function and includes a camera 2581A, a microphone 2581B, a control portion 2540K (wherein K=1, 2, . . . N) for a device K, a recognition portion 2551, a task control portion 2552, a task candidate creation portion 2553, a task candidate presentation portion 2554, a task candidate selection portion 2555, and a touch-panel display 2587. The recognition portion 2551 includes a model creation portion 2571, recognition lexicon data 2572, and a comparison processing portion 2573.

The camera 2581A receives iris data of a user, and sends these iris data are to the model creation portion 2571.

The microphone 2581B receives voice data from the user, and sends these voice data to the model creation portion 2571.

The model creation portion 2571 converts the received iris data and voice data into characteristic quantities, creates a model, and stores that model.

The comparison processing portion 2573 compares the recognition lexicon data 2572 with the model of the user stored by the model creation portion 2571, and creates a recognition result S2560. Here, a plurality personal IDs paired with models for identifying individuals have been prepared as recognition lexicon data, and the personal ID appended to the model that is a good match between a model from the recognition lexicon data and the model stored by the model creation portion 2571 is created as the recognition result S2560.

The comparison processing portion 2573 sends the created recognition result S2560 to the task control portion 2252 and the task candidate creation portion 2553.

Based on the received recognition result S2560, the task control portion 2552 controls the control portion 25401 of the device 1 (first task).

Based on the received recognition result S2560, the task candidate creation portion 2553 creates task candidates S2561 and sends them to the candidate presentation portion 2554.

The task candidate presentation portion 2554 presents the received task candidates S2561 on the touch-panel display 2587.

If the user performs the operation of selecting one of the task candidates S2561 while the task candidates S2561 are being presented on the touch-panel display 2587, then the task candidate selection portion 2555 prepares selection information S2562 based on the received operation signal S2596, and sends this selection information S2562 to the task control portion 2252.

Based on the received selection information S2562, the task control portion 2252 controls the control portion 2540K (wherein K=1, 2, . . . N) and the touch-panel display 2587. Moreover, the task control portion 2252 sends a presentation-stop signal S2592 to the task candidate presentation portion 2554.

The task candidate presentation portion 2554 receives the presentation-stop signal S2592, and stops the presentation of the task candidates S2561 presented on the touch-panel display 2587.

If the user does not perform an operation of selecting one of the task candidates S2561 while the task candidates S2561 are presented on the touch-panel display 2587 (that is, if the first predetermined time after the task candidate presentation portion 2554 has received the task candidates S2561 has passed, but no presentation-stop signal S2592 has been received), then the task candidate presentation portion 2554 stops the display of the task candidates S2561 that are displayed on the touch-panel display 2587.

Operation of the Control System

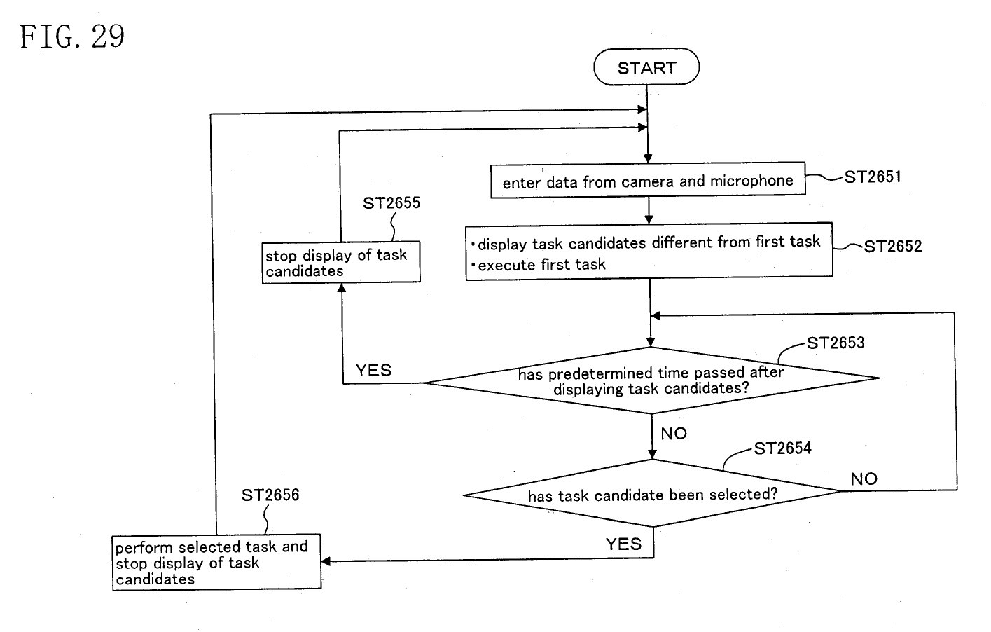

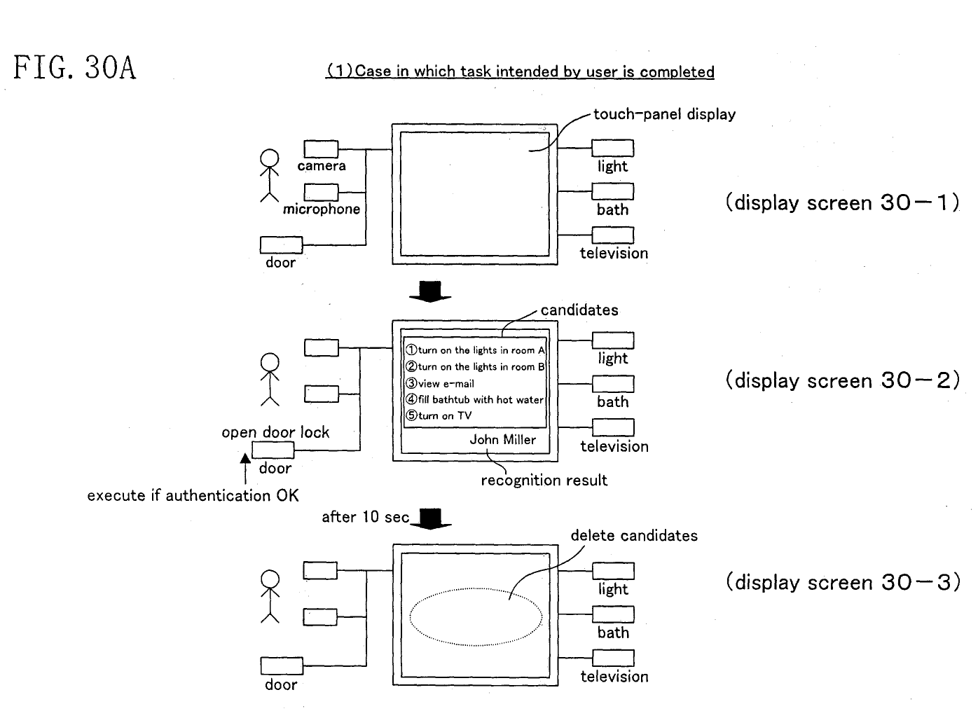

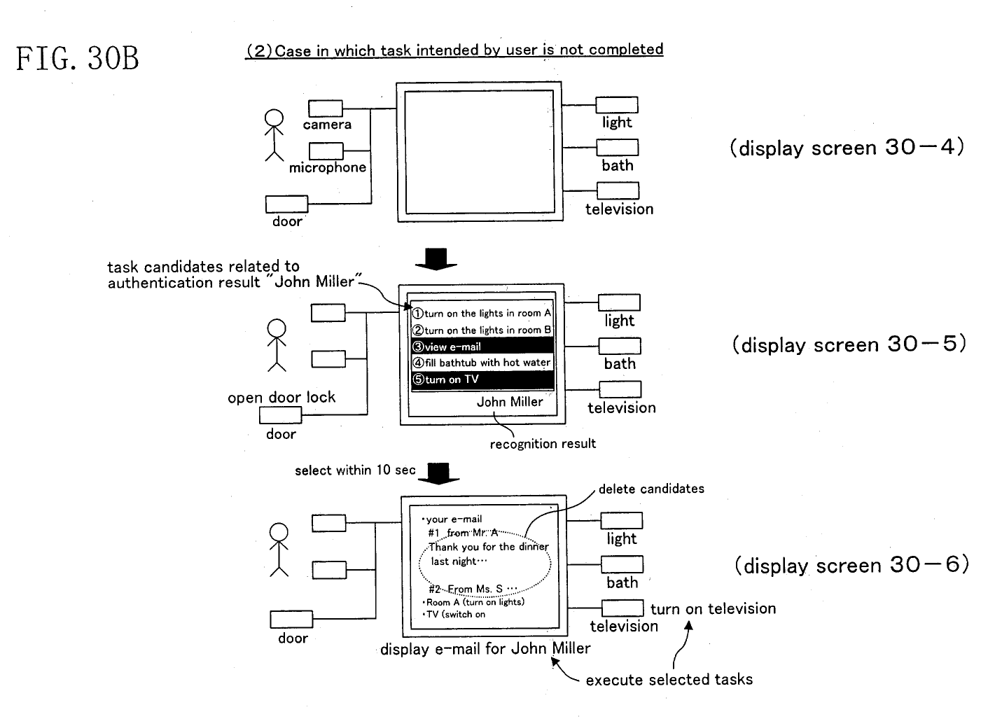

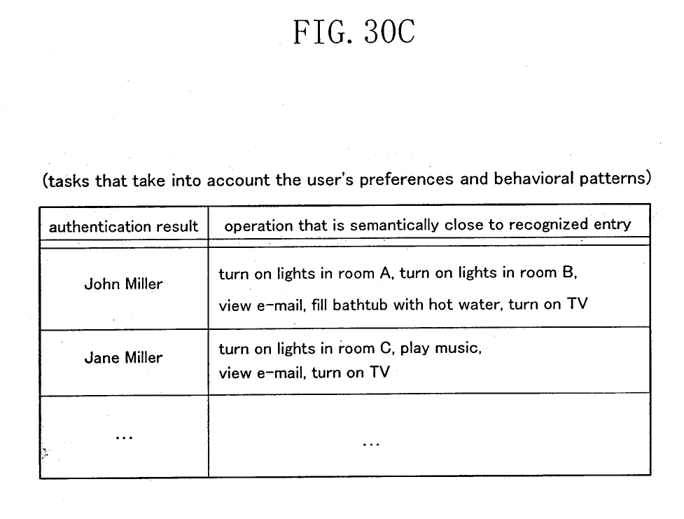

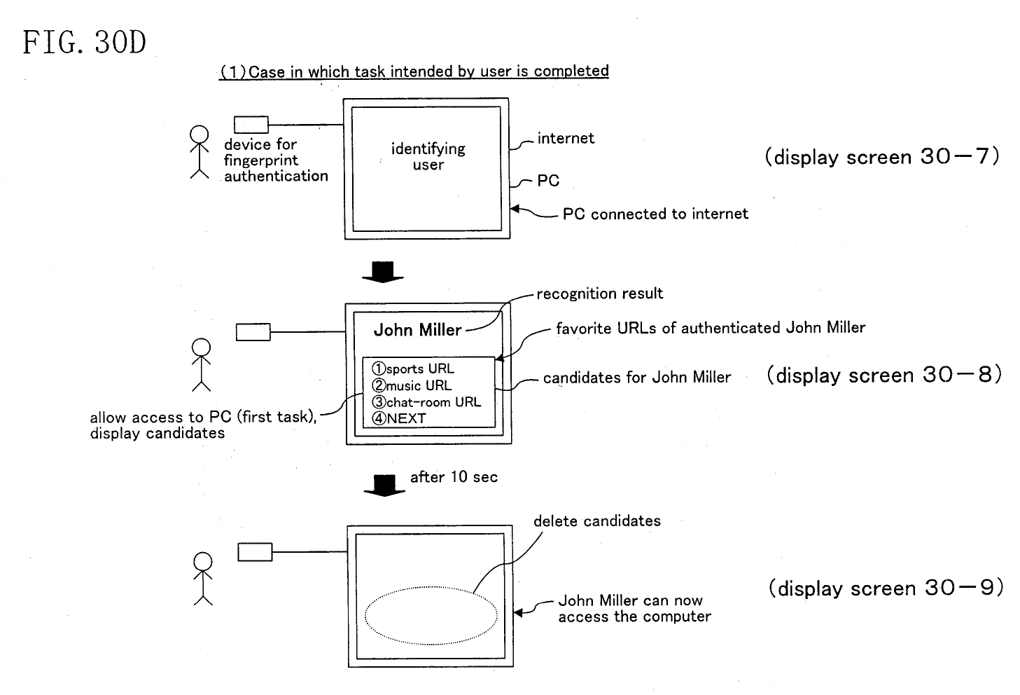

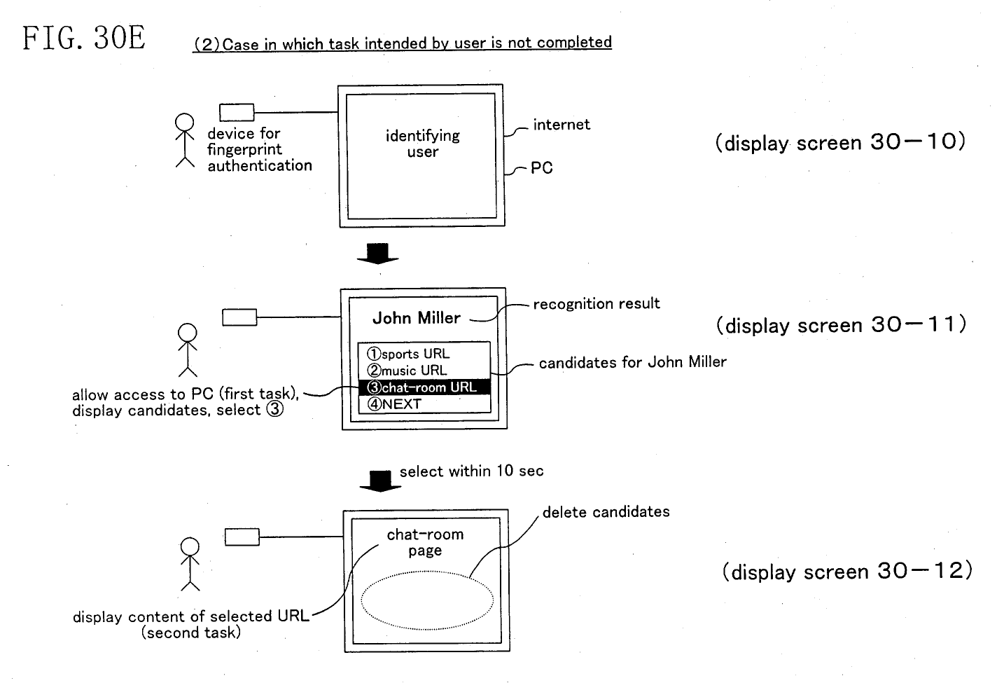

The following is an explanation of the operation of the control system 2585 configured as described above. Here, an example of the operation of a device control system with authentication function is described with reference to FIG. 29 and FIGS. 30A to 30E.

(1) Example 1 of a Case in Which the Task Intended by the User is Completed

[Step ST2651]

The camera 2581A receives iris data of the user and sends those data to the model creation portion 2571. The microphone 2581B receives voice data of the user and sends those data to model creation portion 2571 (display screen 30-1 in FIG. 30A). Based on the received iris data and voice data of the user, the model creation portion 2571 creates an authentication model and stores it. As authentication lexicon data 2572, pairs of personal IDs and authentication models are used, for example “Mr. A: model A,” “Mr. B: model B.” “Mr. C: model C,” or “John Miller: model X.” The authentication models are created from each individual's iris pattern and voice pattern. Here, the names of those persons that may unlock a door, as a control function of the device 1, are registered in the authentication lexicon data 2572. The comparison processing portion 2573 compares the authentication models of the recognition lexicon data 2572 with the model stored by the model creation portion 2571, and analyzes whether “model X,” which is the best matching model, is acceptable as the recognition result. Here, it determines that the match satisfies a predetermined threshold, so that its judgment is “match found” and “John Miller,” which is appended to the “model X” that is the best match is output as the recognition result S2560. The task control portion 2552 and the task candidate creation portion 2553 receive the authentication result S2560 that is output by the recognition portion 2551.

[Step ST2652]

Based on the recognition result S2560, the task control portion 2552 operates the door lock, which is the control portion 25401 of the device 1, and unlocks the door. Moreover, the task control portion 2552 displays the recognition result S2560 on the touch-panel display 2587. The task candidate creation portion 2553 references the table shown in FIG. 30C, and creates, as task candidates S2561, the tasks “\mathring{1} turn on the lights in room A,” “\mathring{2} turn on the lights in room B,” “\mathring{3} view e-mail,” “\mathring{4} fill bathtub with hot water” and “\mathring{5} turn on TV,” which are the tasks that are frequently carried out by “John Miller,” the received recognition result S2560, and sends these task candidates S2561 to the task candidate presentation portion 2554. In the table shown in FIG. 30C, association regions based on the user's preferences and behavioral patterns have been set (regions of association by habit). An association region has been set for each authentication result. In the association region for a certain authentication result, the tasks are included that are preferably or routinely performed by the user indicated by that authentication result. The task candidate presentation portion 2554 displays the task candidates S2561 “\mathring{1} turn on the lights in room A,” “\mathring{2} turn on the lights in room B.” “\mathring{3} view e-mail,” “\mathring{4} fill bathtub with hot water” and “\mathring{5} turn on TV” on the touch-panel display 2587 (display screen 30-2 in FIG. 30A).

[Steps ST2653 and ST2654]

If the task candidate presentation portion 2554 does not receive a presentation-stop signal S2592 from the task control portion 2552 after receiving the task candidates S2561 and before a first predetermined time has passed, then the task candidate presentation portion 2554 stops the display of the task candidates S2561 displayed on the touch panel display 2587 (display screen 30-3 in FIG. 30A).

Example 2 of a Case in Which the Task Intended by the User is Completed

[Step ST2651]

The camera 2581A receives iris data of the user and sends those data to the model creation portion 2571. The microphone 2581B receives voice data of the user and sends those data to model creation portion 2571 (display screen 30-1 in FIG. 30A). Based on the received iris data and voice data of the user, the model creation portion 2571 creates an authentication model and stores it. As authentication lexicon data 2572, pairs of personal IDs and authentication models are used, for example “Mr. A: model A,” “Mr. B: model B.” “Mr. C: model C,” or “John Miller: model X.” The authentication models are created from each individual's iris pattern and voice pattern. The comparison processing portion 2573 compares the authentication models of the recognition lexicon data 2572 with the model stored by the model creation portion 2571, and analyzes whether the best matching model is acceptable as the recognition result. Here, it determines that the match does not satisfy a predetermined threshold, so that its judgment is “no match found,” and “no match found” is output as the recognition result S2560. The task control portion 2552 and the task candidate creation portion 2553 receive the authentication result S2560 that is output by the recognition portion 2551.

[Step ST2652]

Based on the recognition result S2560, the task control portion 2552 controls the door lock, which is the control portion 25401 of the device 1. Here, the recognition result S2560 is “no match found,” so that the task control portion 2552 keeps the door locked by controlling the device 1. Moreover, the task control portion 2552 displays the recognition result S2560 “no match found” on the touch-panel display 2587. Based on the received recognition result S2560, the task candidate creation portion 2553 creates, as task candidates S2561, the tasks “\mathring{1} call,” “\mathring{2} enter password,” “\mathring{3} cancel,” “\mathring{4} try again,” and sends these task candidates S2561 to the task candidate presentation portion 2554. The task candidate presentation portion 2554 displays the task candidates S2561 “\mathring{1} call,” “\mathring{2} enter password,” “\mathring{3} cancel,” “\mathring{4} try again,” on the touch-panel display 2587.

[Steps ST2653 and ST2654]

If the task candidate presentation portion 2554 does not receive a presentation-stop signal S2592 from the task control portion 2552 after receiving the task candidates S2561 and before a first predetermined time has passed, then the task candidate presentation portion 2554 stops the display of the task candidates S2561 displayed on the touch panel display 2587.

(2) Case in Which the Task Intended by the User is Not Completed

[Step ST2651]

The camera 2581A receives iris data of the user and sends those data to the model creation portion 2571. The microphone 2581B receives voice data of the user and sends those data to model creation portion 2571 (display screen 30-4 in FIG. 30B). Based on the received iris data and voice data of the user, the model creation portion 2571 creates an authentication model and stores it. As authentication lexicon data 2572, pairs of personal IDs and authentication models are used, for example “Mr. A: model A,” “Mr. B: model B,” “Mr. C: model C,” or “John Miller: model X.” The authentication models are created from each individual's iris pattern and voice pattern. Here, the names of those persons that may unlock a door, as a control function of the device 1, are registered in the authentication lexicon data 2572. The comparison processing portion 2573 compares the authentication models of the recognition lexicon data 2572 with the model stored by the model creation portion 2571, and analyzes whether “model X,” which is the best matching model, is acceptable as the recognition result. Here, it determines that the match satisfies a predetermined threshold, so that its judgment is “match found,” and “John Miller,” which is appended to the “model X” that is the best match is output as the recognition result S2560. The task control portion 2552 and the task candidate creation portion 2553 receive the authentication result S2560 that is output by the recognition portion 2551.

[Step ST2652]

Based on the recognition result S2560, the task control portion 2552 operates the door lock, which is the control portion 25401 of the device 1, and unlocks the door. Moreover, the task control portion 2552 displays the recognition result S2560 on the touch-panel display 2587. The task candidate creation portion 2553 references the table shown in FIG. 30C, and creates, as task candidates S2561, the tasks “\mathring{1} turn on the lights in room A,” “\mathring{2} turn on the lights in room B,” “\mathring{3} view e-mail,” “\mathring{4} fill bathtub with hot water” and “\mathring{5} turn on TV,” which are the tasks that are frequently carried out by “John Miller,” the received recognition result S2560, and sends these task candidates S2561 to the task candidate presentation portion 2554. The task candidate presentation portion 2554 displays the task candidates S2561 “\mathring{1} turn on the lights in room A,” “\mathring{2} turn on the lights in room B.” “\mathring{3} view e-mail,” “\mathring{4} fill bathtub with hot water” and “\mathring{5} turn on TV” on the touch-panel display 2587 (display screen 30-5 in FIG. 30B).

[Steps ST2653 and ST2654]

Within the first predetermined time, the user selects a task that the user wants to be carried out from the task candidates. While the task candidates S2561 are displayed on the touch-panel display 2587, task candidates S2561 are selected by the user. Here, the user selects “\mathring{3} view e-mail” and “\mathring{5} turn on TV” by pressing those options on the touch-panel display 2587. Examples of selection methods are the method of deciding selection candidates by pressing the enter button after all selection candidates for tasks that the user wants to be performed are listed, and the method of deciding for each task candidate individually if it is to be performed or not (display screen 30-5 in FIG. 30B). The task candidate selection portion 2555 receives an operation signal S2596 from the touch-panel display 2587, produces the selection information S2562 “\mathring{3} view e-mail” and “\mathring{5} turn on TV,” and sends this selection information S2562 to the task control portion 2552.

[Step ST2656]

Based on the received selection information S2562, the task control portion 2552 turns on the television and displays the e-mail for John Miller on the touch-panel display 2587 with the control portion 25402 of the device 2 (second task). The task control portion 2552 sends a presentation-stop signal S2592 to the task candidate presentation portion 2554. The task candidate presentation portion 2554 receives the non-presentation portion S2552 and stops the display of the task candidates that are displayed on the touch-panel display 2587 (display screen 30-6 in FIG. 30B).

Effects

With the ninth embodiment as explained above, the task candidates S2561 created by the task candidate creation portion 2553 are presented and selected by the 15- user at whichever is the faster timing of a first timing with which the second task is executed, and a second timing at which a first predetermined time after presenting the task candidates S2561 has elapsed, so that the user does not need to perform again from the beginning the procedure for executing the task intended by the user. Consequently, usage becomes more convenient and less troublesome for the user.

Moreover, the task candidate presentation portion 2554 automatically stops the presentation of the task candidates S2561 if the user shows no intent of selecting a task candidate even after the first predetermined time has passed, so that if the first task that has been executed is the task intended by the user, the user does not need to stop the presentation of the task candidates S2561. Consequently, usage becomes more convenient and less troublesome for the user.

Furthermore, the task control portion 2552 automatically executes the first task based on the recognition result S2560 that has been output by the recognition portion 2551, so that if the first task that is executed is the task that was intended by the user, then the user does not have to select a task candidate. Consequently, usage becomes more convenient and less troublesome for the user.

Furthermore, the task candidate presentation portion 2554 automatically presents the task candidates S2561, so that if the tasks intended by the user are not completed by the first task that is executed, then the user can easily select task candidates S2561. Consequently, usage becomes more convenient and less troublesome for the user.

Furthermore, the task candidate selection portion 2555 can select a plurality of task candidates S2561, and the task control portion 2552 can control a plurality of tasks. Consequently, usage becomes more convenient and less troublesome for the user.

It should be noted that the present embodiment is not limited to the above description, and the various adaptations listed below are also possible, for example.

a) The number of task candidates S2561 that are presented does not have to be fixed.

b) Some of the task candidates S2561 may be displayed even after the first predetermined time has elapsed.

c) The task candidates S2561 may be presented such that they scroll over the touch-panel display 2587.

d) The recognition portion 2551 is not limited to means for iris and/or voice authentication and may also include means for fingerprint authentication or the like. An operation example of a configuration using fingerprint authentication is shown in FIGS. 30D and 30E. This example shows a system controlling a PC (personal computer) in accordance with the result of a fingerprint authentication. At first, the PC is controlled such that access to it is not possible (display screens 30-7, 30-10). If as a result of the fingerprint authentication it is confirmed that the user is a pre-registered person (person with access rights), then the access to the PC is enabled, and URLs (candidates) of the user's interest are displayed in the screen (display screens 30-8, 30-11). If the user does not select a candidate within 10 sec, then the candidates are deleted from the screen (display screen 30-9). If the user does selects a URL (candidate) within 10 sec. then the content of that URL is displayed on the screen (display screens 30-11, 30-12).

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An interface apparatus comprising:
a recognition portion for obtaining a recognition result based on a degree of similarity between a recognition object and lexicon entries included in a recognition lexicon;
a task control portion for instructing execution of a first task associated with the recognition result; and
a presentation control portion for instructing presentation of one or a plurality of candidates associated with the recognition result and instructing a stop of the presentation of the candidate(s) when a time for which the candidate(s) has/have been presented has reached a predetermined time.

2. The interface apparatus according to claim 1, wherein the presentation control portion displays the candidate(s) on a display, and stops the display of the candidate(s) on the display when a time for which the candidate(s) has/have been displayed on the display has reached the predetermined time.

3. The interface apparatus according to claim 1,
wherein the recognition result indicates lexicon entries for which the degree of similarity with the recognition object exceeds a predetermined reference value;
wherein the first task is associated with one lexicon entry of the lexicon entries that are indicated by the recognition result; and
wherein the one or plurality of candidates are associated with other lexicon entries- of the lexicon entries that are indicated by the recognition result.

4. The interface apparatus according to claim 1,
wherein, when selection information is given that indicates one of the candidates that are presented in response to an instruction by the presentation control portion, then the presentation control portion instructs the stop of the presentation of the presented candidate(s).

5. The interface apparatus according to claim 1,
wherein, when selection information is given that indicates one of the candidates that are presented in response to an instruction by the presentation control portion, then the task control portion instructs execution of a second task that is associated with the candidate indicated by that selection information.

6. The interface apparatus according to claim 5,
wherein the selection information indicates a first candidate and a second candidate; and
wherein the second task includes a task that is associated with the first candidate and a task that is associated with the second candidate.

7. The interface apparatus according to claim 1,
wherein, when an execution instruction for a third task is given while the candidate(s) is/are presented in response to an instruction by the presentation control portion, then the presentation control portion instructs the stop of the presentation of the candidate(s).

8. The interface apparatus according to claim 1,
wherein the task control portion instructs presentation of the time that is left until the execution of the first task is started.

9. The interface apparatus according to claim 1,
wherein the recognition object comprises speech and/or voice data.

10. The interface apparatus according to claim 1,
wherein the recognition object comprises information for authenticating individuals.

11. The interface apparatus according to claim 1,
wherein the first task is to display information related to the recognition result.

12. The interface apparatus according to claim 1,
wherein the first task is to operate a device associated with the recognition result.

13. The interface apparatus according to claim 1,
wherein the first task is to retrieve information related to the recognition result and to present the retrieved results.

14. The interface apparatus according to claim 5,
wherein the second task is to display information related to the candidate indicated by the selection information.

15. The interface apparatus according to claim 5,
wherein the second task is to operate a device associated with the candidate indicated by the selection information.

16. The interface apparatus according to claim 5,
wherein the second task is to retrieve information related to the candidate indicated by the selection information and to present the retrieved results.

17. The interface apparatus according to claim 7,
wherein the third task is to enter a recognition object.

18. The interface apparatus according to claim 7,
wherein the third task is to display a predetermined screen.

19. The interface apparatus according to claim 7,
wherein the third task is to present an execution result of the first task by voice.

20. An interface apparatus comprising:
a recognition portion for obtaining a recognition result based on a degree of similarity between a recognition object and lexicon entries included in a recognition lexicon;
a task control portion for instructing execution of a first task associated with the recognition result;
a candidate creation portion for obtaining one or a plurality of candidates based on semantic closeness to the recognition result; and
a presentation control portion for instructing presentation of the candidate(s) obtained by the candidate creation portion.

21. The interface apparatus according to claim 20,
wherein the one or plurality of candidates belong to a genre that corresponds to the recognition result.

22. The interface apparatus according to claim 20,
wherein the one or plurality of candidates each includes a keyword that is associated with the recognition result.

23. The interface apparatus according to claim 20,
wherein the one or plurality of candidates each includes a keyword that takes into account personal preferences and/or behavioral patterns of a user.

24. The interface apparatus according to claim 20,
wherein the one or plurality of candidates each indicates a task that is related to the first task.

25. An interface apparatus comprising:
a first recognition lexicon including one or a plurality of lexicon entries;
a recognition portion for obtaining a recognition result based on a degree of similarity between a recognition object and the lexicon entry or entries included in the first recognition lexicon; and
a presentation control portion for instructing presentation of one or a plurality of candidates associated with the recognition result, and presentation whether a lexicon entry or entries corresponding to the candidate(s) is/are included in the first recognition lexicon.

26. The interface apparatus according to claim 25, further comprising:
a second recognition lexicon including one or a plurality of lexicon entries; and
a lexicon control portion for exchanging a lexicon entry included in the first recognition lexicon and a lexicon entry included in the second recognition lexicon according to predetermined criteria.

27. The interface apparatus according to claim 25,
further comprising a lexicon control portion for adding a lexicon entry to the first recognition lexicon, and deleting a lexicon entry from the first recognition lexicon.

28. A task control method, comprising:
a step (a) of obtaining a recognition result based on a degree of similarity between a recognition object and lexicon entries included in a recognition lexicon;
a step (b) of executing a first task associated with the recognition result; and
a step (c) of presenting one or a plurality of candidates associated with the recognition result and stopping presentation of the candidate(s) when a time for which the candidate(s) has/have been presented has reached a predetermined time.

29. The task control method according to claim 28,
wherein in step (c), the candidate(s) is/are displayed on a display, and the display of the candidate(s) on the display is stopped when a time for which the candidate(s) has/have been shown on the display has reached the predetermined time.

30. The task control method according to claim 28,
wherein the recognition result indicates lexicon entries for which the degree of similarity with the recognition object exceeds a predetermined reference value;
wherein the first task is associated with one lexicon entry of the lexicon entries that are indicated by the recognition result; and
wherein the one or plurality of candidates are associated with other lexicon entries of the lexicon entries that are indicated by the recognition result.

31. The task control method according to claim 28,
wherein in step (c), when one of the candidates has been selected, then the presentation of the presented candidates is stopped.

32. The task control method according to claim 28,
further comprising a step (d) of executing a second task that is associated with the selected candidate when one of the candidates presented with step (c) has been selected.

33. The task control method according to claim 28,
wherein when an execution instruction for a third task is given while the candidate(s) is/are presented, then the presentation of the presented candidate(s) is stopped.

34. A task control method, comprising:
a step (a) of obtaining a recognition result based on a degree of similarity between a recognition object and lexicon entries included in a recognition lexicon;
a step (b) of executing a first task associated with the recognition result; and
a step (c) of obtaining one or a plurality of candidates based on semantic closeness to the recognition result; and
a step (d) of presenting the candidate(s) obtained in step (c).

35. A task control method, comprising:
a step (a) of obtaining a recognition result based on a degree of similarity between a recognition object and lexicon entries included in a first recognition lexicon;
a step (b) of presenting one or a plurality of candidates associated with the recognition result, and presenting whether lexicon entries corresponding to the candidate(s) are included in the first recognition lexicon.

36. The task control method according to claim 35,
further comprising a step (c) of exchanging lexicon entries between the first recognition lexicon and the second recognition lexicon according to predetermined criteria.

37. The task control method according to claim 35,
further comprising a step (d) of adding a lexicon entry to the first recognition lexicon, or deleting a lexicon entry from the first recognition lexicon.

38. A screen display method comprising:
a step (a) of displaying on a screen one or a plurality of candidates obtained from a recognition result;
a step (b) of deleting the candidate(s) from the screen when a time for which the candidate(s) has/have been displayed on the screen has reached a predetermined time.

39. The screen display method according to claim 38,
wherein in step (a), a description of a first task associated with the recognition result is displayed on the screen together with the candidate(s).

40. The screen display method according to claim 39,
wherein in step (a), the description of the first task is displayed with emphasis.

41. The screen display method according to claim 39,
wherein in step (a), the time that is left until execution of the first task is started is displayed.

42. The screen display method according to claim 39,
wherein in step (a), the candidate(s) is/are displayed in a display region of the screen that is outside a region in which the description of the first task is displayed.

43. The screen display method according to claim 38,
wherein in step (a), a currently selected candidate of the candidate(s) is displayed with emphasis.

44. The screen display method according to claim 38,
wherein in step (a), candidate(s) that can be selected by speech recognition technology is/are displayed, and a portion to be uttered in order to select a displayed candidate is displayed with emphasis.

45. The screen display method according to claim 38,
wherein in step (a), the recognition result is displayed with emphasis.

46. The screen display method according to claim 45,
wherein in step (b), the emphasis of the recognition result is stopped together with the deletion of the candidate(s).

47. The screen display method according to claim 38,
further comprising a step (c) of deleting all candidates displayed on the screen when one of the candidates that are displayed on the screen is selected.

48. The screen display method according to claim 38,
wherein in step (a), candidates obtained based on a semantic closeness to the recognition result are displayed.

49. The screen display method according to claim 38,
wherein in step (a), information indicating whether the candidate(s) can be selected by speech recognition technology is displayed for each of the one or plurality of candidates.
